(19) United States
(12) Patent Application Publication
(10) Pub. No.: US 2010/0281784 A1
(43) Pub. Date: Nov. 11, 2010

(54) PREFABRICATED BUILDING COMPONENTS AND ASSEMBLY EQUIPMENTS

(76) Inventor: Ano Leo, Calgary (CA)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/811,199

(22) PCT Filed: Oct. 17, 2008
(86) PCT No.: PCT/CA08/01809

§ 371 Date: Jun. 29, 2010

(30) Foreign Application Priority Data
Jan. 8, 2008 (US) 11971018
Oct. 9, 2009 (US) 12248051

(51) Int. Cl. E04B 1/00; E04H 1/00; E04B 1/70; E04C 2/20; E04D 13/18; E04C 3/02; E06B 3/66; E04C 2/26; E04C 2/52; E04B 1/343; E04D 13/08

(52) U.S. Cl. 52/16; 52/79.1; 52/302.1; 52/309.4; 52/173.1; 52/173.3; 52/633; 52/745.13; 52/786.1; 52/782.1; 52/220.1; 52/64; 52/741.1

(57) ABSTRACT

A building process that offers better qualities in terms of value, structural integrity, and comfort and energy conservation for industrial, commercial and residential building industries. The present invention starts with a single component which is the vertical composite insulated supporting steel members, then the plates, the beams, the composite insulated wall system, the floor joist system, the temperature regulated roof system and the multiple insulation patterns to create the active thermal force air cavities and inactive cavities. The entire concept of utilizing the invention is that the design of all of the components and parts, the objectives are focused on to facilitate the prefabrication process and conserve energy.

### THE PRIOR ART

There are other building components designed for the same purpose. Typical of these is U.S. Pat. No. 3,161,267 issued to Keller on Dec. 15, 1964.

Another patent was issued to Burges on Nov. 16, 1965 as U.S. Pat. No. 3,217,455. Yet another U.S. Pat. No. 3,258,889 was issued to Butcher on Jul. 5, 1966 and still yet another was issued on Feb. 15, 1972 to Palmer as U.S. Pat. No. 3,641,724.

Another patent was issued to Johnson on Feb. 22, 1972 as U.S. Pat. No. 3,643,394. Yet another U.S. Pat. No. 3,736,715 was issued to Krumwiede on Jun. 5, 1973. Another was issued to Berghuis, et al. on Feb. 25, 1986 as U.S. Pat. No. 4,571,909 and still yet another was issued on Jun. 9, 1987 to Reynolds as U.S. Pat. No. 4,671,032.

Another patent was issued to McCarthy on Jan. 1, 1991 as U.S. Pat. No. 4,981,003. Yet another U.S. Pat. No. 5,265,389 was issued to Mazzone et al. on Nov. 30, 1993. Another was issued to Gular on Dec. 14, 1993 as U.S. Pat. No. 5,269,109 and still yet another was issued on Jun. 16, 1998 to Richard as U.S. Pat. No. 5,765,330.

Another patent was issued to Ojala on Sep. 21, 1999 as U.S. Pat. No. 5,953,883. Yet another U.S. Pat. No. 6,158,190 was issued to Seng on Dec. 12, 2000. Another was issued to Dalphond, et al. on Feb. 22, 2005 as U.S. Pat. No. 6,857,237 and still yet another was issued on Sep. 10, 1997 to Berreth as European Patent Application No. EP0794294. Yet another International Patent Application No. WO 2006/123005 was issued to Casan Celda on Nov. 23, 2006.

### U.S. Pat. No. 3,161,267

### Inventor: Robert R. Keller

### Issued: Dec. 15, 1964

A prefabricated building panel comprising a grid formed of a multiplicity of rigid grid members mechanically connected together, each of said grid members having a web and flanges at each edge thereof extending at an angle to said web, the outer surfaces of each of said flanges being substantially flat and parallel to each other, the grid members extending in two directions and defining a multiplicity of open spaces surrounded by said grid members, said flanges at one edge of said webs defining a first set of bonding surfaces, said bonding surfaces being aligned in a single plane, a first outer sheet member extending in said plane over said grid, said first sheet member having an outer wear-resistant surface and an inner bonding surface, said inner bonding surface bonded with a layer of adhesive face-to-face to said first set of bonding surfaces, said layer of adhesive lying directly between the cooperating bonding surfaces of said first sheet member and said first set of bonding surfaces, said first sheet member extending continuously over all of said open spaces, a multiplicity of stiff, pre-formed backing sheet members one fitted in each of said open spaces in said grid, each backing sheet member having an area substantially corresponding to the area of said first sheet member lying over said open space, each backing sheet member having a planar bonding surface bonded by a layer of flexible adhesive face-to-face to said first sheet member substantially throughout said area, said backing sheet members each being thicker than said first sheet member and structurally of lesser density than said first sheet member and said grid members, the outer surfaces of said flanges on the other edge of said webs defining a second set of bonding surfaces, said second set of bonding surfaces being aligned in a single plane, a second outer sheet member adhesively secured to said second set of bonding surfaces, said second set of bonding surfaces locating said second sheet member in a spaced apart relationship to said backing sheet members, the smallest dimension of each of said open spaces parallel to said planes being substantially greater than the spacing between said planes.

### U.S. Pat. No. 3,217,455

### Inventor: Joseph H. Burges

### Issued: Nov. 16, 1965

In a modular panel including a pair of opposed, laterally spaced face plates and a closed border around the periphery of the face plates establishing a closed chamber between the face plates, the border having laterally spaced opposite sides, a plurality of joined border sections establishing the border, each of said border sections comprising:

an outer covering of insulating material having inner and outer surfaces and a U-shaped lateral cross section with opposite legs of the U-shape projecting inwardly from the periphery and terminating at innermost ends corresponding with the innermost end of the U-shaped cross-section, each leg including an enlarged portion extending toward one another;

first and second longitudinal reinforcing strips each embedded in one of said enlarged portions and each fused to the inner surface of one leg of the U-shaped border section;

a third longitudinal reinforcing strip having a U-shaped lateral cross-section and being disposed in the outer covering at the end of said U-shaped cross-section opposite said innermost end and fused to the inner surface of the outer covering; and

a longitudinal slot in each leg of the U-shaped border section extending outwardly from said innermost ends;

said face plates being received within said slots such that insulating material lies between the outer covering and each face plate, between each face plate and each of said first and second longitudinal reinforcing strips, and between each said first and second longitudinal reinforcing strips and the third longitudinal reinforcing strip so that the outer covering interrupts any direct contact between the opposed face plates and among the longitudinal reinforcing strips and the lateral path from one side to the other side of the peripheral border is of low transmission.

### U.S. Pat. No. 3,258,889

### Inventor: Richard A. Butcher

### Issued Jul. 5, 1966

A prefabricated structural section comprising:

(1) a frame comprising, transversely, a wooden ceiling plate and a wooden floor plate longitudinally spaced from said ceiling plate and, longitudinally, wooden studs transversely spaced from one another, extending from said ceiling plate to said floor plate and fastened to said plates by fasteners extending through said plates into said studs;

(2) a panel on one side of said frame, extending longitudinally from said ceiling plate to said floor plate with one side of said panel being disposed adjacent said studs; and

(3) means fastening said panel to said frame, said means consisting of rigid, cellular, polyurethane material tenaciously adhering to said ceiling plate, floor plate, studs and said side of said panel, extending from one stud to the next and from said ceiling plate to said face plate, and extending from said side of said-panel toward the other side of said frame sufficiently to substantially rigidify said section, but only part way to said other side of said frame, whereby between each pair of studs a substantial space extending from said ceiling plate to said face plate is provided for piping and wiring.

### U.S. Pat. No. 3,641,724

### Inventor: James Palmer

### Issued: Feb. 15, 1972

A wall construction for homes and the like developed for the construction of wall sections at locations removed from the building into which includes an integral box beam construction at the upper portions thereof with insulating and reflective material being provided as integral elements within the wall section. The box beam construction is built directly into the wall section and provides a strengthening factor to permit the placement of doors and windows at any point and permits the placement of truss rafters at any point and permits the placement of truss rafters at any point along the wall.

### U.S. Pat. No. 3,643,394

### Inventor: Bobby G. Johnson

### Issued: Feb. 22, 1972

A building structure module in the form of a wall panel capable of load bearing constructed of glass fiber reinforced plastic resin, semicylindrical structural members for load bearing and reinforcement and foam plastic for insulation purposes with the module having fire-retardant properties and a peripheral edge channel member to enable adjacent modules to be readily interconnected. The module is constructed by employing a procedural method so that the sequential steps are performed in a production line technique to facilitate construction of the modules. CL U.S. Pat. No. 3,736,715

### Inventor: Leland J. Krumwiede

### Issued: Jun. 5, 1973

A prefabricated load-supporting building panel is disclosed. The panel consists of a metal stud frame to which a sheet of moisture proof gypsum board is affixed. A thickness of molded polystyrene, supported by a peripheral casing attached to the frame, is bonded to the gypsum board. Exterior finish for the panel consists of synthetic plastic which is troweled onto a glass fiber fabric bonded to the polystyrene. CL U.S. Pat. No. 4,571,909

### Inventor: Thomas G. Berghuls

### Issued: Feb. 25, 1986

An insulated building has an inner structure forming the interior walls and roof of the building. Elongated wood spacer members are mounted on the exterior of the inner structure preferably with insulated fasteners. The spacer members are spaced from the exterior of the inner structure. Foam insulation covers the exterior of the inner structure to a depth generally flush with the spacer members. Sheeting is applied over the foam to cover the exterior of the building. The building is characterized by an absence of panel joints typically found in buildings of this type. Such joints permit detrimental heat transfer through the insulation. CL U.S. Pat. No. 4,671,032

### Inventor: William A. Reynolds

### Issued: Jun. 9, 1987

A stressed-skin building panel including structural strengthening members located alternately adjacent the two opposite skin members of the building panel, each of the structural strengthening members being spaced apart from the opposite skin member by a block of high-density rigid foam material, and the remainder of the space between the skin members being occupied by a foamed-in-place foam insulating material adhering to the skin members and structural strengthening members and providing a significant amount of strength and resistance to compressive stresses. The opposite skin members are spaced apart from one another and held together at the proper spacing during and after construction by a plurality of bridge members which form the only direct connection between the skin members by other than insulating foam material, so that the insulating quality of the panels is maximized. CL U.S. Pat. No. 4,981,003

### Inventor: Grant McCarthy

### Issued: Jan. 1, 1991

A unique wall panel is constructed from expanded polystyrene beads in an expanded polystyrene mold with structural members embedded in it during the molding process. The structural members are in the form of two by four studs placed at sixteen inch centers. Adjacent panels have interlocking grooves and ridges which fit together. The advantage of the present invention is that a total insulated wall is created with no cracks or spaces in the insulation. These lightweight panels can be carried to the building site, where base and top plates are applied and the panels interlocked to form a perfectly insulated wall. CL U.S. Pat. No. 5,265,389

### Inventor: Mark C. Mazzone, et al.

### Issued: Nov. 30, 1993

A composite building panel includes a core of a foamed polymeric insulating material, such as expanded polystyrene, having a plurality of uniformly spaced open box tubes retained in vertical grooves formed in the rear surface of the core by a two-part epoxy adhesive, the tubes being mechanically connected at their ends to one leg of continuous horizontal channels having their other leg adhesively secured to the core at horizontal slots. The front surface of the core is continuous without seams and may be coated with a variety of exterior insulation finishing system coatings. CL U.S. Pat. No. 5,269,109

### Inventor: V. Rao Gular

### Issued: Dec. 14, 1993

An insulated load bearing wall (10, 10′) comprising panels of extruded polymer foam (20, 22, 50, 52, 54, 56) into which tubular, load carrying frame members (12, 14, 48) have been incorporated. A tongue is formed at one vertical edge of each panel (10, 10′) and a groove is formed at the opposite vertical edge. The tubular frame members (12, 14, 48) are bonded to the extruded polymer foam. CL U.S. Pat. No. 5,765,330

### Inventor: Michel V. Richard

### Issued: Jun. 16, 1998

A pre-insulated prefab wall panel comprising of a rectangular wall frame having top and bottom rail members and a plurality of spaced apart stud members aligned between the top and bottom rail members. A polystyrene boardstock is affixed to a first side of the rectangular wall frame, thereby defining with the top and bottom rail members and the plurality of stud members a plurality of rectangular cavities, wherein each cavity has a depth of the thickness of a stud member. The prefab wall panel further has a layer of foamed-in-place polyurethane covering a portion of each cavity adjoining the boardstock, and bonding the structural wall frame to the polystyrene boardstock. The layer of polyurethane foam has a thickness which is substantially less than the depth of each cavity, whereby each cavity has available space for accommodating sub-trade installations. CL U.S. Pat. No. 5,953,883

### Inventor: Leo V. Ojala

### Issued: Sep. 21, 1999

An insulated wall panel comprising a bottom, a plurality of inner members, a plurality of outer members, spacers between the inner members and the outer members, an insulation layer, an exterior sheathing, a vapor barrier, a top member and a planar interior wall. The insulated wall panel has a dead air space located just inside of a cavity filled with insulation. The wall panel is adapted to be secured to the frame of a timber frame home without fasteners passing through the entire depth of the panel. Fasteners secure the inner members of the panel only to the frame without destroying the integrity of the insulated wall panel. CL U.S. Pat. No. 6,158,190

### Inventor: Stephen Seng

### Issued: Dec. 12, 2000

This composite building stud combines two metal shapes, inner and outer, with an insulating material to form a composite structural member having an insulating valve (R-value) greater than a similar metal member normally used as a stud in a residential structure. The composite also has a strength comparable to that of a similar steel member normally used as a stud in a residential structure. One shape encompasses the other shape. The composite structural member eliminates any direct metal connections and thus eliminates any thermal shorts that reduce the overall insulating value (R-value) of the composite member. The shapes, inner and outer, with an insulating material form a composite structural member that has an interlocking shape which holds the insulating material in compression and mechanically couples the inner and outer members. CL U.S. Pat. No. 6,857,237

### Inventor: Raymond F. Dalphond, et al.

### Issued: Feb. 22, 2005

A modular wall component with an insulative thermal break for preventing the creation of a continuous thermal path across the modular wall component. The modular wall component may be formed with an insulated frame structure that is fixed to an open frame structure with an insulative thermal break interposed therebetween. The insulated frame structure may be formed with a plurality of vertical track members coupled to an upper track member and a lower track member. At least one sheet of insulative material is interposed into the insulated frame structure. The open frame structure may have a plurality of vertical framing studs coupled to an upper framing track and a lower framing track.

### European Patent Application Number EP0794294

### Inventor: Rainer Berreth

### Published: Sep. 10, 1997

The wall (10) has individual bonded multi-layer elements (1), each with an insulating panel, especially a foam panel (2), with a coated surface (3) of bonded wood-wool on one or both sides. Each element has one or more grooves (4), which run parallel to the coated surface on at least one end wall. At least one supporting strip (5) is pushed or glued into the groove, which may be arranged inside the panel, and may also run around its perimeter. There may also be a groove near the upper edge of the panel, and a further groove near its lower edge.

### International Patent Application Number WO 2006/123005

### Inventor: Alfredo Casan Celda

### Published: Nov. 23, 2006

The invention relates to a prefabricated element for construction, which is intended to be used as a wall covering or to form vaults between rafters in false ceilings. The inventive element is formed by a body (1, 11, 21, 31) comprising a base (5) of polymer material which supports an assembly of thin bricks (6, 12, 12a, 22). According to the invention, cavities (3) are provided between the aforementioned bricks and cavities (4) are provided between each of the bodies (1, 11, 21, 31), said cavities being covered with a filler material. The invention also relates to a method of producing the prefabricated element for construction, which is performed using a mould and which comprises the following steps consisting in: cutting the bricks to the required size and thickness, arranging the bricks in the corresponding cavities of the mould, placing filler material in the cavities between the bricks, injecting base polymer material, and stripping the part from the mould.

While these building components may be suitable for the purposes for which they were designed, they would not be as suitable for the purposes of the present invention, as hereinafter described. The present invention provides a building process that offers better qualities in terms of value, structural integrity, and comfort and energy conservation for industrial, commercial and residential building industries. The present invention starts with a single component which is the vertical composite supporting steel member (stud), then the plate, the beam, the floor joist, the roof truss system and the multiple insulation patterns to create the cavities. The entire concept of utilizing the invention is that the design of all of the components and parts, the objective is focused on; to facilitate the prefabrication process and conserve energy.

### SUMMARY OF THE PRESENT INVENTION

A primary object of the present invention is to provide prefabricated building components with energy efficient saving means to facilitate the building process of industrial, commercial and residential building industries.

Another object of the present invention is to provide several composite insulated members (studs) presented in their different configurations, having bonded foam as the media with rigid foam insulation and OSB strip members to in-forced the structure and air tight cavities, but they serve the same function as the vertical supporting members for exterior and interior walls.

Yet another object of the present invention is to provide multiple insulation patterns to form various components to be inserted between the 2×6″ studs spaced at 16″ or 24″ O.C., one component consists of various pieces of rigid Styrofoam members stacked together spaced apart to facilitate the formation of other insulation components.

Yet another object of the present invention is to provide the composite insulated members (stud) with multiple configurations having bonded foam as the media with rigid foam insulation and OSB strip members to in-forced the structure and air tight cavities.

Yet another object of the present invention is to provide vacuum insulation for use in insulation if formed is the most effective way of insulation and can yield an insulation value approximately 5-7 times that of fiber glass batts. The present invention uses two or three pieces of glass sheets depending on application, sandwiched together with thin glass strips to form the supporting edges and the seal, and glass pellets to form supporting points within the panel. A heating device is used going around four edges by applying appropriate temperature. Thus the entire unit as a whole will be sealed seamlessly with the SME glass material and all melted together as one piece, which is the glass Vacuum Insulated Panel (VIP).

Yet another object of the present invention, the said glass VIP in its double and triple pane configurations are “obscured” glass panels in vacuum condition which are used as part of the wall insulation members as composite insulated wall panel and also used as “obscured” insulated glass features wall panels to bring in lights; hereinafter, part of this present invention is to implement the non-factory “repeat at will” built-in on and off vacuum system incorporated for window and wall load-bearing structures by using active forced thermal fluids, for the purpose of achieving various high level insulation values along with advancing the “obscured” to “un-obscured” and co-exist in the system for a building structure.

Yet another object of the present invention is to create active thermal cavities and inactive cavities implemented strategically in between walls, in ceilings and as well in floors to improve R-value. There are 2 types of active thermal cavities depicted in the present invention, in order to avoid confusion thereinafter it is necessary to describe and distinct the differences between the two; first one is described as the “independent” active thermal cavity created in a thin hollow space minimum half of an inch in between all walls, in ceilings and in floors (also in concrete floors) depending on structural requirements, said “independent” cavities all connected together as a thorough thermal blanket covering the entire structure with forced air traveling in the cavities at a higher temperature then the air in the room, vise versa for the cool air system. The source of said thermal forced air is from the auxiliary furnace or auxiliary air conditioning unit with relatively small capacity. The second active thermal forced air cavity is described thereinafter as “in-floor” active thermal cavity which is the void space created in between and along floor joists underneath the flooring, this source of thermal forced air is generated from the main climate control unit in the present invention, the main function of this “in-floor” active thermal cavity is to regulate the floor temperature and extends it's forced air route to facilitate other two functions in the present invention; 1). in-wall forced ambient air emits into rooms eliminates existing floor mount air registers and 2). creates forced air window cavity defroster. The volume of forced air for the first “independent” active thermal cavities from the auxiliary furnace is relatively very small compares with the volume of the in-floor forced air which is from the main climate control system and it is massive volume in comparison. The concept to achieve ultimate effective R-value is that the law of physic dictates; warm air always moves to the colder side, therefore the created “independent” active thermal forced air blanket insulated to the exterior cold temperature and with higher temperature forced air in it's own path traveling “independently” than the lower temperature air in the rooms, therefore resulting the lower room temperature air would not be able to escape to the colder exterior due to the room temperature air being blocked by the higher temperature “independent” forced air blanket in the walls. Further explaining the functions of the “independent” active thermal forced air cavities; having galvanized metal sheets that inserted in between the created “independent” thermal forced air cavities, resulting the said galvanized metal sheets would be also heated by the active thermal forced air at a higher temperature, therefore the said metal sheet also forms a barrier with a higher temperature (along with the active forced air) then the air in the rooms. Room temperature air can not passes the multi-thermal barriers which are higher temperature.

Yet another object is to utilizing the active forced air to created a temperature regulated roof system comprises of plural sandwiched foam panels each with an active forced air cavity collecting hot air underneath the roof sheathing, all active forced air from the passages of all said foam panels flow into a central channel, then to be redirected or be blown to the outside.

Still yet another object is to utilize the combined benefits of the active and inactive air passages; in the walls, in the ceilings, in the floors to rearrange the placements of the traditional mechanical system; such as furnace, water heater, sheet metal air ducting and plumbing to create an un-obstructed basement by hiding the said mechanical system to yield more enjoyable space.

Additional objects of the present invention will appear as the description proceeds.

The present invention overcomes the shortcomings of the prior art by providing a building process that offers better qualities in terms of value, structural integrity, and comfort and energy conservation for industrial, commercial and residential building industries. The present invention starts with a single component which is the vertical composite supporting steel member (stud), then the plate, the beam, the floor joist, the wall system, the temperate regulated roof system and the multiple insulation patterns to create the cavities. The entire concept of utilizing the invention is that the design of all of the components and parts, the objective is focused on; to facilitate the prefabrication process and conserve energy.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is a top view of prior art.

FIG. 2 is an illustrated view of the present invention in use.

FIG. 2A is a top view of different configurations of the 2×6 vertical composite insulated members (studs).

FIG. 2B is a top view of different configurations of the 2×6 vertical composite insulated members (studs) with glass vacuum insulation panel (VIP) and active thermal cavities applied with the studs to increase R-value of the studs.

FIG. 2C is a view of the stud number 1 configuration.

FIG. 3 is a top and side view of other composite reinforced insulated members for the wall structure.

FIG. 3A are sectional views of composite insulated bottom and top sill plates.

FIG. 3B are sectional views of composite insulated members (nail board).

FIG. 3C is a side-end view of a horizontal window sill plate.

FIG. 4 is a side view of the present invention (multi-insulation components).

FIG. 4A is a side view of the present invention (multi-insulation components).

FIG. 4B is a side view of the present invention (multi-insulation components).

FIG. 4C is a side view of the present invention (multi-insulation components).

FIG. 5 is a sectional view of composite stud and wall assembly.

FIG. 5A is another top sectional view of composite stud and wall assembly.

FIG. 5B is another top sectional view of composite stud and wall assembly.

FIG. 5C is another top sectional view of composite stud and wall assembly.

FIG. 5D is another sectional top sectional view of composite stud and wall assembly.

FIG. 5E is another sectional top sectional view of composite stud and wall assembly.

FIG. 5F is another top sectional view of composite stud and wall assembly.

FIG. 5G is another top sectional view of composite stud and wall assembly.

FIG. 5H is another top sectional view of composite stud and wall assembly.

FIG. 5I is another top sectional view of composite stud and wall assembly.

FIG. 6 is top views of glass vacuum insulation panel (VIP) assemblies.

FIG. 6A is sectional views of glass vacuum insulation panel (VIP) wrapped around with rigid foam members.

FIG. 6B is sectional views of the present invention (VIP, rigid foam and studs).

FIG. 6C is VIP sandwiched with rigid foam and with created cavities.

FIG. 6D is a sectional view of VIP sandwiched with rigid foam.

FIG. 6E is a top view of the added glass pane on interior side of the VIP created cavity.

FIG. 6F is a top view of the added glass panes on both sides of the VIP created cavities.

FIG. 6G side & front view of the un-obscure double pane glass VIP with no vacuum condition in the cavity.

FIG. 6H side & front view of the un-obscure double pane glass VIP prefilled with light color fluid in the cavity.

FIG. 6I sectional view of the mechanical apparatus; (a programmable pumping & controlling devices & reservoirs filled with fluids), shows the relationship with the double pane glass VIP.

FIG. 6J side & front view of the un-obscure double pane glass VIP prefilled with light color fluid in the cavity which interacted & connected with the programmable pumping & controlling system & reservoirs.

FIG. 6K side & front view of the un-obscure double pane glass VIP shows the light color fluid has been pumped out of the cavity to create the pressurized vacuum condition.

FIG. 6L side & front view of the un-obscure double pane glass VIP shows the cavity is filled with darker color fluid.

FIG. 6M side & front view of the double pane glass VIP, the “darker” color fluid is pumped out & a pressurized vacuum condition is created in the cavity.

FIG. 6N side view, front & back view of the un-obscure triple pane glass VIP with dual cavities, one of the cavity is pre-treated in permanent pressurized vacuum condition by forced fluid & the other cavity is for the repeatable vacuum process to be prefilled with color fluids.

FIG. 6O side view, front & back view of the un-obscure triple pane glass VIP, one of the cavity is pre-filled with light color fluid, and the other cavity is pre-treated in permanent vacuum condition with forced fluid.

FIG. 6P side view, front & back view of the un-obscure triple pane glass VIP with dual cavities interacted & connected with the programmable pumping & controlling system & reservoirs; one prefilled with light color fluid & the other is pre-treated in permanent vacuum condition by forced fluid.

FIG. 6Q side view, front & back view of the un-obscure triple pane glass VIP with dual cavities, the light color fluid is pumped out from the cavity which is also turned into a pressurized vacuum cavity, & the other is pre-treated in permanent vacuum condition by forced fluid.

FIG. 6R side view, front & back view of the un-obscure triple pane glass VIP with dual cavities, one of the cavities is filled with darker color fluid & the other is pre-treated in permanent vacuum condition by forced fluid.

FIG. 6S side view, front & back view of the un-obscure triple pane glass VIP with dual cavities, the darker color fluid is pumped out from the cavity which is also turned into a pressurized vacuum cavity & the other is pre-treated in permanent vacuum condition by forced fluid.

FIG. 6T sectional view of the entire system of the un-obscure triple pane glass VIP; fluids are pumped out retained in the reservoirs which are connected with a temperature gauged self-activated heater.

FIG. 6U shows a side view & front view of a double pane glass VIP which can be used as door insulation members.

FIG. 7 is a side view of the master work frame equipment assembly.

FIG. 7A is side-view of the master work frame equipment assembly.

FIG. 7B is side-view of the master work frame equipment assembly relates to top part mechanism.

FIG. 7C is side-view of the master work frame equipment assembly relates to bottom part mechanism.

FIG. 7D is side-view of further explaining the master work frame equipment assembly.

FIG. 7E is a sectional view of the vertical wall supporting member (VWSM) mounted on one side of the main wall assembling frame, one end of the (VWSM) is mounted to the frame side “A” body.

FIG. 7F is a side view of the master work wall frame equipment assembly mounted on pivoting mechanism in horizontal position receiving studs.

FIG. 8 is a side view of the composite wall frame equipment assembly and the coordinate position of the conveying/transporting frame.

FIG. 8A is a side view of the master work wall frame equipment assembly with studs laid in place.

FIG. 8B is a vertical side view of the wall frame production assembly with wall frame skeleton on.

FIG. 8C is a vertical side view of the wall frame production assembly with insulation components and wiring installed.

FIG. 8D is a vertical interior side view of the wall frame production assembly with drywall installed.

FIG. 8E is a vertical exterior side view of the finished composite wall with wall sheathing installed.

FIG. 8F shows the protective finishing process of the finished wall.

FIG. 8G is a view showing the coordination and the process of the conveying & transporting mechanism the conveying fork is moving in to the finished composite wall from the production assembly.

FIG. 8H is a view showing the conveying fork is engaged with the finished composite wall from the production assembly.

FIG. 8I shows the conveying fork retrieving with safety strap in place.

FIG. 8J is an exploded sectional view of finished composite wall and conveying fork.

FIG. 9 shows the roof truss galvanized steel members.

FIG. 9A is a sectional and side view of the ceiling joist.

FIG. 9B is an applying example of the ceiling joist with vertical studs.

FIG. 9C is an applying example of the ceiling joist with vertical studs and ceiling insulation components.

FIG. 9D is an applying example of the ceiling truss system with insulations relative to the attic space.

FIG. 9E is a sectional view of multiple insulation patterns applied with the ceiling joist.

FIG. 9F is an applying example of multiple insulation patterns to the ceiling, the wall frame and ceiling joist.

FIG. 10 shows the half and half gable roof prefab assembly.

FIG. 10A is a front and side view of the equipment for the gable roof truss assembly the mobile truss anchor station.

FIG. 10B is a side view of the coordinate positions of the other equipments for the gable roof truss assembly.

FIG. 10C is a top applying example view of the equipment for the gable roof truss assembly mobile truss stations and the anchor station.

FIG. 10D is a side view of applying example of the roof truss system has been installed on the equipment for the gable roof truss assembly mobile truss stations and the anchor station.

FIG. 10E is a side view of the completed gable roof on it's vertical position.

FIG. 11 shows the hip roof to be defined in sections for production process.

FIG. 11A shows the sectional hip roof to be assembled separately.

FIG. 11B shows the hip roof equipment assemblies.

FIG. 11C is a side view of the hip roof truss assembly stations in their coordinated positions.

FIG. 11D is a top view of the hip roof truss assemblies with the mobile truss anchor station and other mobile stations system.

FIG. 11E is a front view of the hip roof truss system and the assembling process.

FIG. 11F is a top view of the hip roof truss system and the assembling process.

FIG. 11G is a finished section of a finished half hip roof truss laid on the hip roof truss equipment assembly.

FIG. 11H is a side view of a finished sectional half hip roof truss in vertical position.

FIG. 12 shows the forced air path of the independent active thermal air cavity.

FIG. 12A shows the forced air path of the independent active thermal cavity air blanket associates with the inactive cavity, glass VIP within the walls.

FIG. 12B shows a version of independent active thermal air insulation associated with metal sheets for building that sought for higher energy saving requirements.

FIG. 12C is an applying example of the insulation component comprising multiple active thermal cavities with sheet metals and rigid foams incorporated with studs, sheathing boards and studs.

FIG. 12D is an applying example of the independent active thermal forced air path for multi-level building.

FIG. 13 is an orthographic view of the independent active thermal forced air blanket movement in walls travels up and across the ceiling.

FIG. 13A is an applying example of the independent active thermal forced air blanket movement in ceiling travels down the opposite side walls.

FIG. 13B is an applying example of the independent active thermal cavity air blanket forced air upward movement in one of the other two sets of walls.

FIG. 13C is an applying example of the independent active thermal cavity air blanket forced air downward movement in one of the other two sets of walls.

FIG. 13D is the top sectional view of the basement concrete wall structure with a boxed-out space for housing the climate control unit.

FIG. 13E is the top sectional view of the main floor wall frame structure with a boxed-out space for housing forced air ducting system from the climate control unit.

FIG. 13F is the top sectional view of the upper floor wall frame structure with a boxed-out space for housing forced air ducting system from the climate control unit.

FIG. 13G is the side view shown the created boxed-out spaces for housing the climate control unit to allow the basement floor free of obstruction for more desirable development & the aligned multi-level vertical column boxed-out spaces for accommodating forced air ducting system reaching up & returning from all 3 levels.

FIG. 13H is the side view shown an outward ducting body is installed & connected with the climate control unit depicting the main outward active forced air path and various multi-level extending outward active forced air paths.

FIG. 13I is the side view shown an inward ducting body is installed & connected with the climate control unit depicting the main inward active forced air path and various multi-level extending inward active forced air paths.

FIG. 13J is the orthographic side view shown the interacted combined functions of the basement boxed-out space, the multi-level vertical column boxed-out spaces; the climate control unit; the outward & inward active forced air ducting system associated & networked with the entire multi-level active thermal forced air passages & paths.

FIG. 13K is the side & cut-off view focused on depicting an elongated horizontal boxed-out structure installed & attached to exterior multi-level flooring structures and capable of embracing pluming pipes & electrical wirings in horizontal positions.

FIG. 13L is another side view 90 degrees of FIG. 13K, shown the main plumbing pipes positioned vertically within the boxed-out spaces of the multi-level vertical column, and horizontally extends their routes to other floor levels via the elongate horizontal boxed-out structure, also illustrates the electrical wirings & water lines adapting along the extension route of the main plumbing pipes.

FIG. 13M is a top view of FIG. L further depicts the formation & relationships with the boxed-out space from the basement wall, the vertical column boxed-out spaces, the elongate horizontal boxed-out structure, main plumbing pipes and their extensions extended into the void space between floor joist.

FIG. 13N is an applying example of another independent active thermal forced air blanket movement rising up in basement from the created boxed-out space

FIG. 13O is a cut-off horizontal view of an existing prior art piece of a corrugated metal ceiling component showing the corrugated pattern creates the “void” spaces on both sides.

FIG. 13P is a cut-off horizontal view of an existing prior art typical ceiling structure illustrates the creation of the “void” spaces to be utilized as another active thermal forced air path in the present invention.

FIG. 13Q is the cut off view of a residential house comprises of a roof structure having active forced air passages system running underneath the roof sheathing above the attic.

FIG. 14 is a sectional and side view of a composite floor joist.

FIG. 14A is a sectional and side view of a composite interior joist side plate (OSB) for additional floor to anchor on.

FIG. 14B is a sectional and side view of an exterior composite insulated side plate (OSB) for additional floor to anchor on.

FIG. 14C is a sectional and cut off side view of the relationships and applying example of various floor members; exterior composite insulated side plate, interior joist side plate and floor joist forming the principal and sectional floor.

FIG. 14D is a front view of the non-movable station “A” of floor equipment assemblies.

FIG. 14E is a front view of station “B”, “C” and “D” all movable on tracks of the floor equipment assemblies.

FIG. 14F is a side view of the principal floor assemblies relative to the floor equipment.

FIG. 14G is a side view of a assembled principle floor laid on the floor equipment assemblies.

FIG. 14H is a side view of an applying example of assembling the principal floor and two additional floors on each side on the floor equipment assemblies.

FIG. 14I is a top view without the OSB floor sheathing installed, the relationships of the four platforms (ABCD) which can assemble all sizes of principle floors and additional floors.

FIG. 15 shows the top view and sectional view of the bottom plate with openings for forced air passage and also showing the composite multiple insulation patterns applied between the 2 composite insulated studs.

FIG. 15A is a sectional and side view of the floor joist explaining the function of the floor joist creating forced air channels underneath the floor.

FIG. 15B is a top view of the exposed main floor structure without the floor sheathing board, shows the in-floor forced air circulating route and openings in the bottom plates. Also shows side view of the configured in-floor cavities.

FIG. 15C is a view an applying example of the in-floor forced air circulation extends it's path to the blocked inactive cavity created the in-wall forced air for room ambient air and the relationship with the glass VIP and the studs.

FIG. 15D is a view of the composite floor joist with openings.

FIG. 15E is a top view shown, forced air circulating areas that can be controlled and be selected; as required due to the flexibility, such as bathrooms which may have cold ceramic tile flooring. individual space between joists can be connected through strategic openings in floor joists.

FIG. 15F shows applying examples for materials being used to created in-floor cavities for forced air circulation on the composite floor joist, many types of material can be used such as rigid foam sheet, OSB members, sheet metal and corrugated materials.

FIG. 15G shown are examples for the created in-floor forced air system being applied on the existing floor joist systems such as; engineered floor joist system, galvanized steel single or double joist system and timber floor joists system.

FIG. 15H is a side view of a window forced air deforester system with the forced air deflector, snapped onto the top surface of the window frame, also showing the forced air path of the window deforester.

FIG. 15I shows a window defroster with deflector related to the in-floor forced air system, shows independent active thermal cavity air blanket, not extending to window. Also shows glass VIP vacuum insulated panel.

FIG. 15J refers to FIG. 15I shows the interacting relationships of adding a single pane glass to the window defroster system, independent active thermal cavity air blanket extending to window surface and glass VIP. And magnifying the benefits.

FIG. 15K refers to FIG. 15J further shows the combined relationships and benefits of in-floor forced air, adding a single glass pane to cavity window defroster, independent active thermal force air blanket travels up the window and the wall and the glass VIP, all to achieve the ultimate insulation effectiveness.

FIG. 15L shows a side sectional view of composite insulated wall panel further explaining the interact relations and functions of the in-floor forced air circulation extending to window defroster and in-wall forced air ambient to room.

FIG. 16 is a top view of a composite wall panel structure with hidden rain water drainage system.

FIG. 16A is a sectional view of the in-wall hidden rain drainage system.

FIG. 16B is a vertical sectional view of the hidden rain water drainage system with rectangular wall passages for 2 levels.

FIG. 16C is a top view of the hidden rain water drainage system.

### THE REFERENCED NUMERALS

Turning now descriptively to the drawings, in which similar reference characters denote similar elements throughout the several views, the figures illustrate the Prefabricated Insulated Building Components and Assembly Equipment of the present invention. With regard to the reference numerals used, the following numbering is used throughout the various drawing figures.
1 the double pane un-obscure glass VIP body.
1a the cavity of the double pane un-obscure glass VIP body with no vacuum condition at this stage.
1b the protruding fluid drain outlet for the double pane un-obscure glass VIP
1c pre-filled light color forced fluid
1d the rigid foam supporting members
1e the pressurized vacuumed cavity is created by drawing out the light color fluid
1f the pressurized vacuumed cavity is created by drawing out the darker color fluid
2 the programmable split flow guide
3 the tubing system used to transport the fluids
4 the programmable fluid pumps that facilitates the movements of the forced fluids.
5 the reservoir for the light color thermal forced fluid.
5a the light color thermal forced fluid.
6 the reservoir for the darker color thermal forced fluid
6a the darker color thermal forced fluid.
7 the entire body of the triple pane un-obscure glass VIP in its side view
7a the “repeat at will” vacuum panel being one of the two attached bodies of the triple pane un-obscure glass VIP
7b the “permanent” vacuum panel being two of the two attached bodies of the triple pane un-obscure glass
7c the “cavity” of body 13a at the stage where no vacuum condition has been created
7d the pre-treated permanent vacuumed “cavity” of body 13b
7e the protruding nipple for vacuum process of the “permanent” triple pane un-obscure glass VIP.
7f the protruding fluid drain outlet for the “repeat at will” triple pane un-obscure glass VIP.
7g the “pressurized vacuumed” cavity created by withdrawing the light colour fluid
7h the “pressurized vacuumed” cavity created by withdrawing the darker colour fluid
8 the thermal exchanger facilitated for the forced thermal fluids 5a & 6a
8a the thermal transfer line for forced fluid 10a travels to & from between the reservoir 6 & the thermal exchanger 8
8b the thermal transfer line for forced fluid 5a travels to & from between the reservoir 5 & the thermal exchanger 8
9 the double pane glass VIP body to be incorporated as an insulation member for door
9a the vacuumed cavity of the glass VIP body 9
9b the opening for door knob.
9c the nipple to facilitate the vacuum process.
10 Prefabricated insulated Building Components and Assembly Equipment of the present invention
12 composite insulated vertical member (stud)
14 galvanized steel
16 oriented strand board (OSB)
18 rigid foam insulation
22 wood stud
24 prior art studs
26 fiberglass insulation
28 drywall
30 OSB floor sheathing
32 opening for plumbing and electrical
34 glass vacuum insulated panel (VIP)
36 independent active thermal cavity
38 inactive cavity
40 top sill plate
42 bottom sill plate
44 nail board
46 exterior OSB wall sheathing
48 nail
50 baseboard
52 window reinforcement sill plate/header
54 flange
56 screw recess
58 spacer
60 protective wrap
62 Composite insulated wall panel assembly
64 VIP support pellet
66 VIP strip edge
68 VIP glass nipple
70 interior feature glass
72 exterior feature glass
74 master work frame assembly
76 vertical wall supporting member
77 conveying/transporting frame
78 motorized mechanism
80 first frame side
82 second frame side
84 top release bar
86 frame bottom plate
88 timber plate
90 openings for conveying fork lifts
92 bottom release bar
94 weight support
96 station bolt
98 elevating mechanism
100 guiding track of station bolt
102 tightening knob
104 top portion of main frame
106 bottom portion of main frame
108 guiding rods
110 top mounting member
112 metal member
114 base
116 track support rail
118 track support leg
120 motorized track
122 conveying fork
124 video camera
126 electric motor
128 window header beam
130 electrical wire
132 receptacle box
134 light switch
136 window glass pane
138 protective foam pads
140 safety strap
142 roof truss
144 center supporting member
146 web supporting member
148 rafter beam
150 drop down ceiling joist
152 main joist section
154 drop down joist section
156 main joist flange
158 drop down flange
160 attic space
162 nut
164 bolt
166 gable roof system
168 mobile truss anchor station
172 station body structure
174 wheel
176 anchor bar
178 elevating mechanism
180 spacer
182 half truss frame
184 first ceiling frame support “A”
186 second ceiling frame support “B”
188 anchor mechanism
190 bracing member
192 side plate
194 fastening bracket
196 conveyance device
198 roof sheathing and shingles
200 hip roof
204 hip end
206 third ceiling frame support “C”
208 fourth ceiling frame support “B”
210 tracks of 168
212 pivot mechanism
214 double adjoining plate
216 bridging member
218 hip truss section
220 independent thermal forced air
222 auxiliary furnace
224 concrete floor
226 solar panel
228 solar powered regulated fan
230 galvanized metal sheet
232 casing
234 concrete ceiling
236 interior wall
238 glass wall
240 added single pane glass
242 return air to furnace
246 duct
248 studs with no openings
250 studs with openings
252 composite floor joist
254 interior composite floor joist
256 exterior composite joist side plate
258 safety railing
260 station “A”
262 station “BCD”
264 composite insulated reinforcement member
266 platform
268 joist frame supporting member
270 sectional floor
272 principal floor
274 bottom plate
276 rigid foam in-floor air channel
278 horizontal foam strip
280 recess/opening in bottom plate
282 recess/opening in floor joist
284 in-floor active cavity/channel
286 rigid foam cavity/channel
288 OSB cavity/channel
290 corrugated sheet cavity/channel
292 sheet metal cavity/channel
294 engineered floor joist cavity/channel
296 galvanized “C” steel single or double floor joist cavity/channel
298 timber floor joist cavity/channel
300 window forced air deflector
302 supporting point
304 snap-on device
308 window frame
310 window forced hot air
312 openings for plumbing & electrical in Studs, top & bottom sill plates, nail board, and in reinforcement members.
314 window double pane glass
316 on-wall air register
318 glass single pane
320 in-floor forced air
322 rainwater drainage system
324 in wall hidden drain pipe
326 steel reinforcing member
328 rain gutter and eve through system
330 down spout
332 ground grading
334 foundation cement wall
336 roof line
338 upper floor
340 drain opening
342 drain channel
344 soffit space
346 openings for in-wall forced air in composite member 264
348 openings for active forced air in composite member 264
350 openings for in-wall forced air in composite member 40 & 42
352 openings for active forced air in composite member 40 & 42
354 openings for in-wall forced air in composite member 44
356 openings for active forced air in composite member 44.
358 boxed out upper level wall for accommodating the forced air ducting
360 space for accommodating the going-out & return forced air ducting
362 floor member for supporting the boxed out wall for upper level
364 boxed out main level wall for accommodating the forced air ducting
368 floor member for supporting the boxed out wall for main level
370 boxed-out concrete wall for housing the (furnace)
372 boxed-out space in basement
374 climate control unite (furnace)
376 in-ceiling active thermal forced air in it's outward path
378 out-going active thermal forced air travels in duct
380 air duct for out-going active thermal forced air
382 upper floor active thermal forced air in it's path
384 main floor active thermal forced air in it's path
386 basement active thermal forced air in it's path
388 in-ceiling return active thermal forced air in it's path
390 upper floor return active thermal forced air in it's path
392 air duct for return active thermal forced air
394 return active thermal forced air travels in duct
396 main floor return active thermal forced air in it's path
398 basement return active thermal forced air in it's path
400 foam strip to divide the wall panel to create outward & return forced air path
402 basement concrete wall
404 main floor exterior wall
406 upper floor exterior wall
408 upper floor in-floor outward active thermal forced air path
410 upper floor in-floor return active thermal forced air path
412 main floor in-floor outward active thermal forced air path
414 main floor in-floor return active thermal forced air path
416 basement floor in-slab outward active thermal forced air path
418 basement floor in-slab return active thermal forced air path
420 elongated horizontal boxed out space
422 cut out view of a section of a plumbing pipe installed inside the horizontal boxed out space
424 an vertical section of a main plumbing pipe inside the vertical column boxed-out space raised from the ground
426 cut out horizontal sectional view of a plumbing pipe 90 degrees to pipe 422 extends out to the void space underneath the sub-floor
428 foam insulation fills up the hollow space in the horizontal boxed-out space
430 cut out section view of a piece of electrical wire installed inside the horizontal boxed out space
432 a piece of electrical wire installed vertically within the vertical column boxed-out space
434 a cavity for active thermal forced air horizontally installed inside the horizontal boxed-out space
436 a cut out section view of a piece of water pipe installed inside the horizontal boxed out space
438 a piece of water pipe installed vertically within the vertical column boxed-out space
440 a piece of electrical wire an extension of electrical wire 430 installed 90 degrees to the horizontal boxed-out space extends out to the void space underneath the sub-floor
442 another active thermal forced air path rising in the basement within wall panels outward from the basement boxed-out unit
444 an existing prior art piece of a corrugated metal ceiling component forming part of a ceiling & roofing structure
446 Interior “void” spaces created by the corrugated pattern itself
448 Exterior “void” spaces created by the corrugated pattern itself
450 a strategic piece of insulation sheet material in place to create the interior “void” spaces for active thermal forced air path
452 conventional roofing material
454 conventional roofing insulation material
456 upper rigid foam member in sheet form
456a lower rigid foam member in sheet form
458 forced air cavity within the insulated panel sandwiched by 2 pieces of foam member
460 forced air running within the cavity of the sandwiched foam members
462 the elongated square forced air central channel made of rigid foam
464 the cavity of the central channel to be used as forced air passage
466 forced air entering from the cavity of the rigid foam panel
468 the ceiling line

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

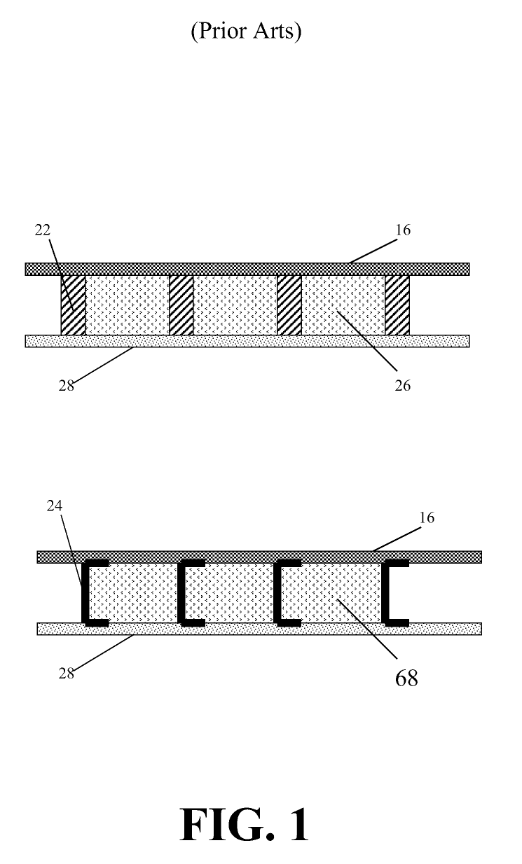

FIG. 1 is a top view of prior art. 20 Shown are two top views of prior art 20, first depicting the existing wood frame structure with 2×6 wood studs 22, the second depicting the existing steel frame structure with 2×6 “C” studs 24 with fiberglass insulation 26 disposed between the drywall 28 and the oriented strand board 16. The present invention is intended to improve the building process and offers better qualities in terms of value, structural integrity, comfort and energy conservation for industrial, commercial and residential building industries. The present invention starts with a single component which is the composite vertical insulated supporting steel member (stud), then the plate, the beam, floor joist, the roof truss and the multiple insulation patterns to create the cavities. The entire concept of utilizing the invention is that the design of all of the components and parts, the objective is focused on one, which is to facilitate the prefabrication process.

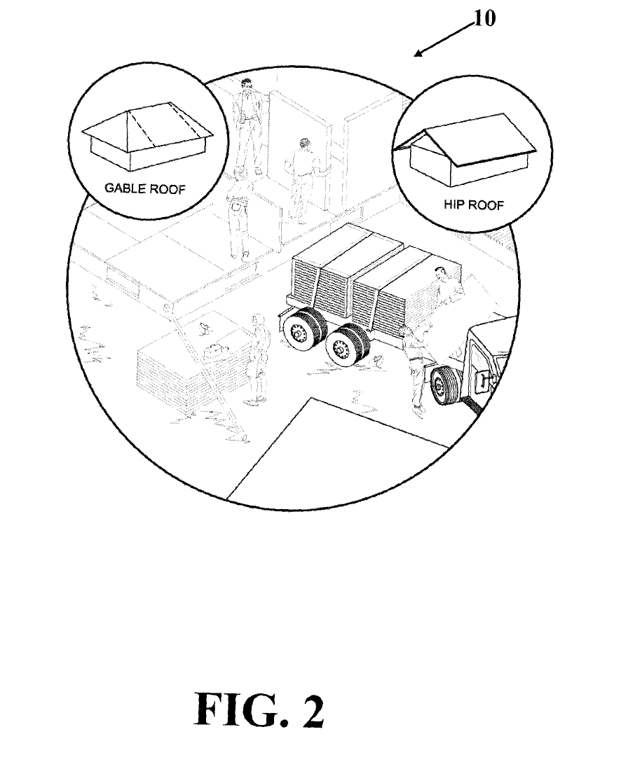

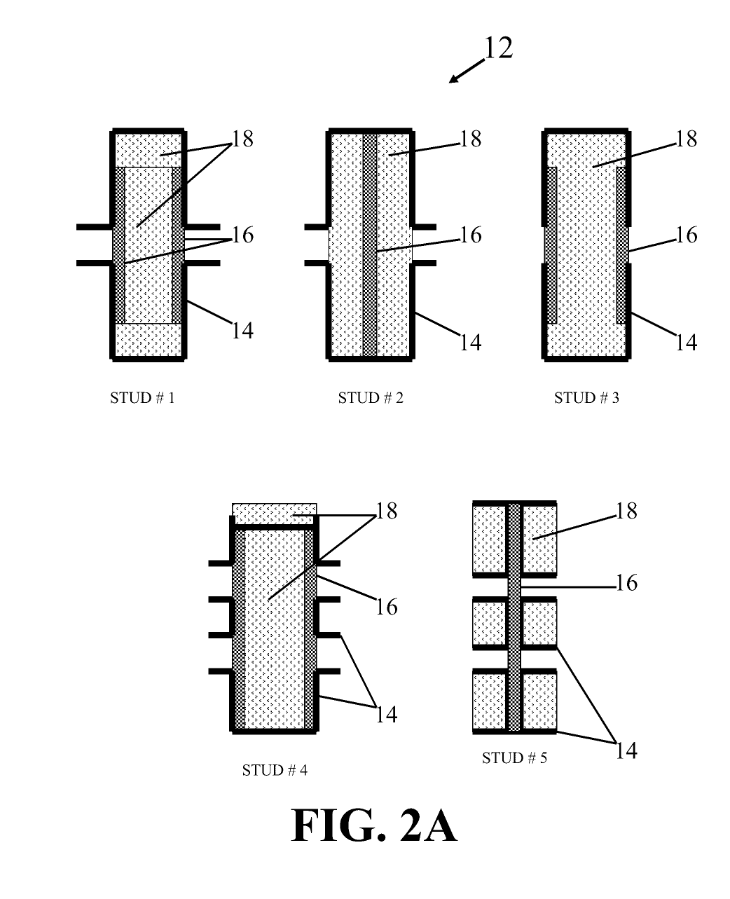

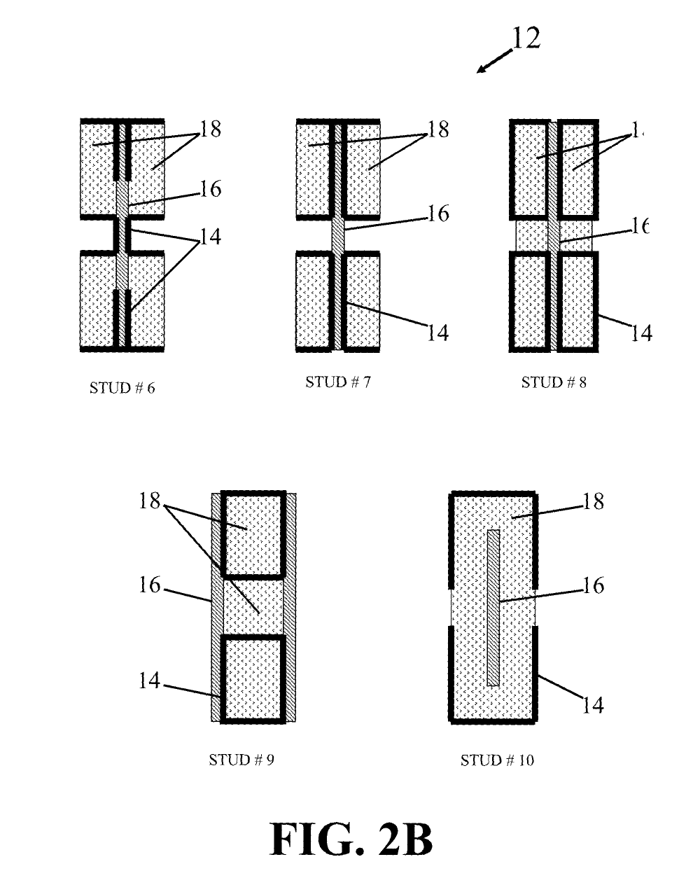

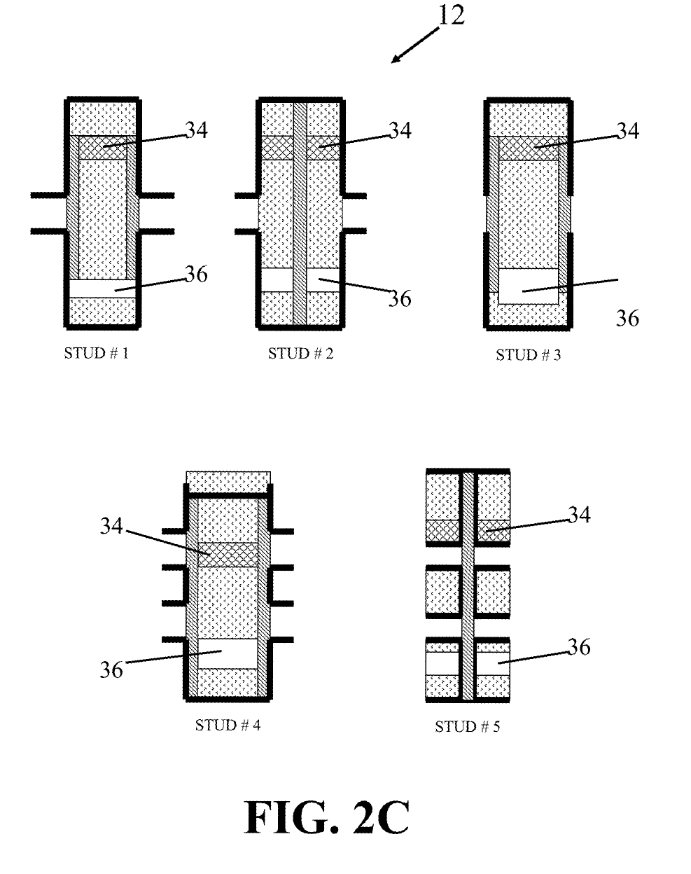

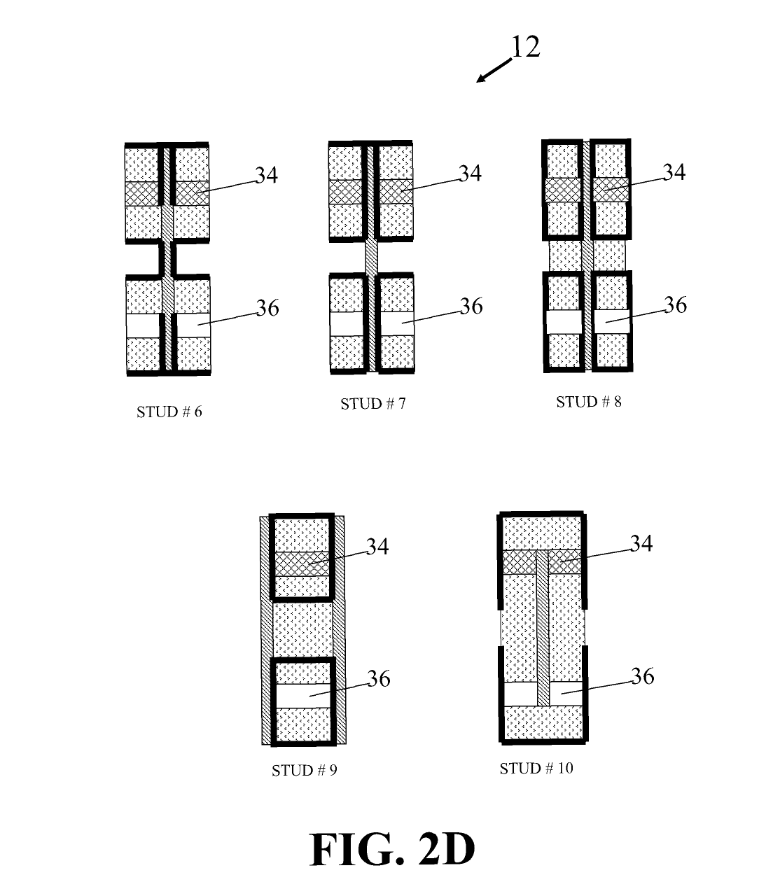

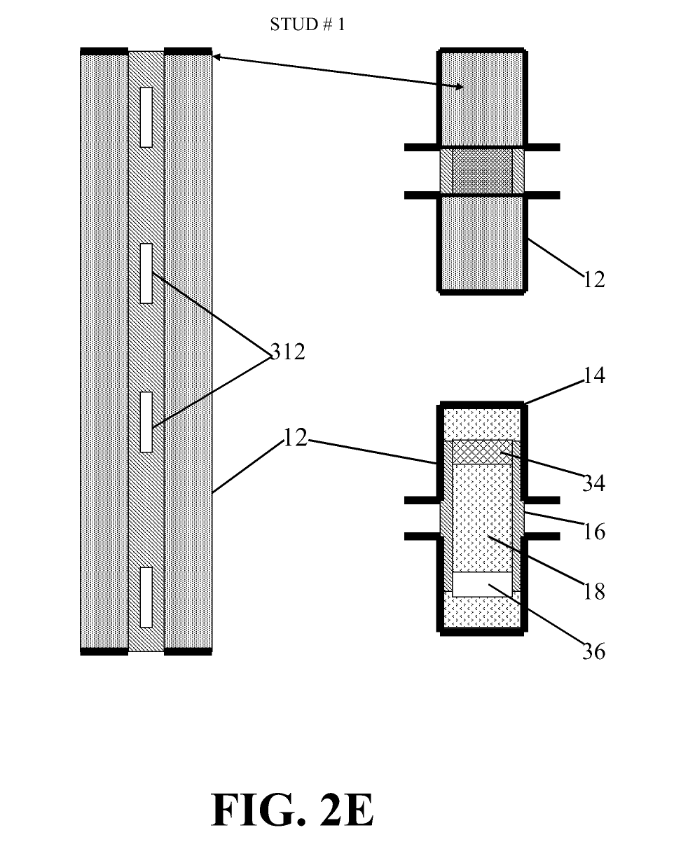

FIG. 2 is an illustrated view of the present invention 10 in use. The prime purpose of the present invention 10 is to offer an alternative process to build residential homes in a more effective way with improved energy value factor utilizing the existing materials and the existing manufacturing facilities readily available on the market.

FIG. 2A is a top view of different configurations of the 2×6 composite insulated vertical members (studs) 12 comprising oriented strand board (OSB) members 16, galvanized steel 14 and rigid foam insulation 18.

FIG. 2B is a top view of different configurations of the 2×6 composite insulated vertical members (studs) 12 with glass vacuum insulation panel (VIP) 34 and independent active thermal cavities 36 applied with the studs to increase R-value of the studs.

FIG. 2C is a top view and side view of the stud number 1 configuration 12 comprising oriented strand board (OSB) members 16, galvanized steel 14 and rigid foam insulation 18 with glass vacuum insulation panel (VIP) 34 to form independent active thermal cavities 36 for forced air passage. Also side view shows openings 32 on the stud body for plumbing and electrical.

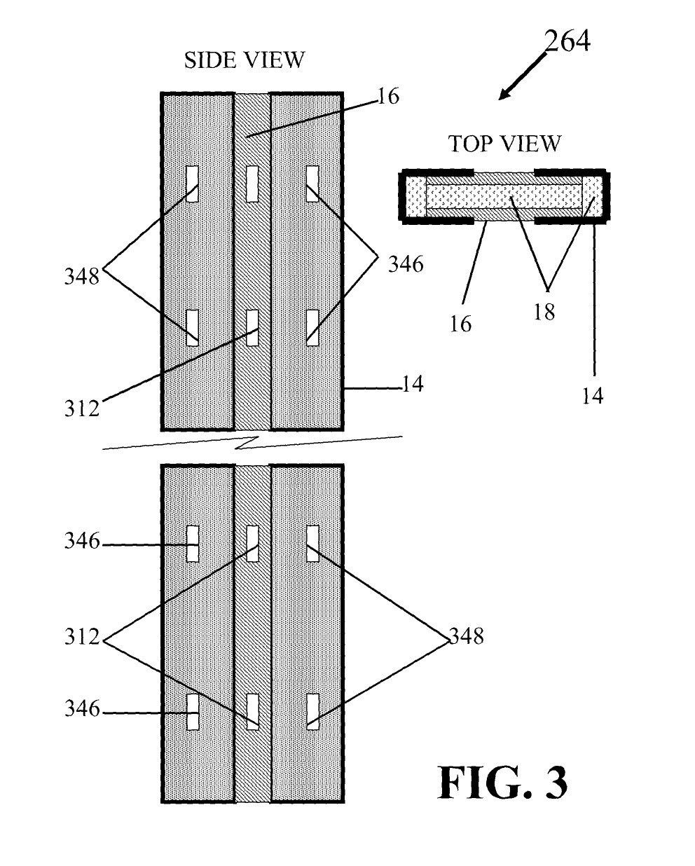

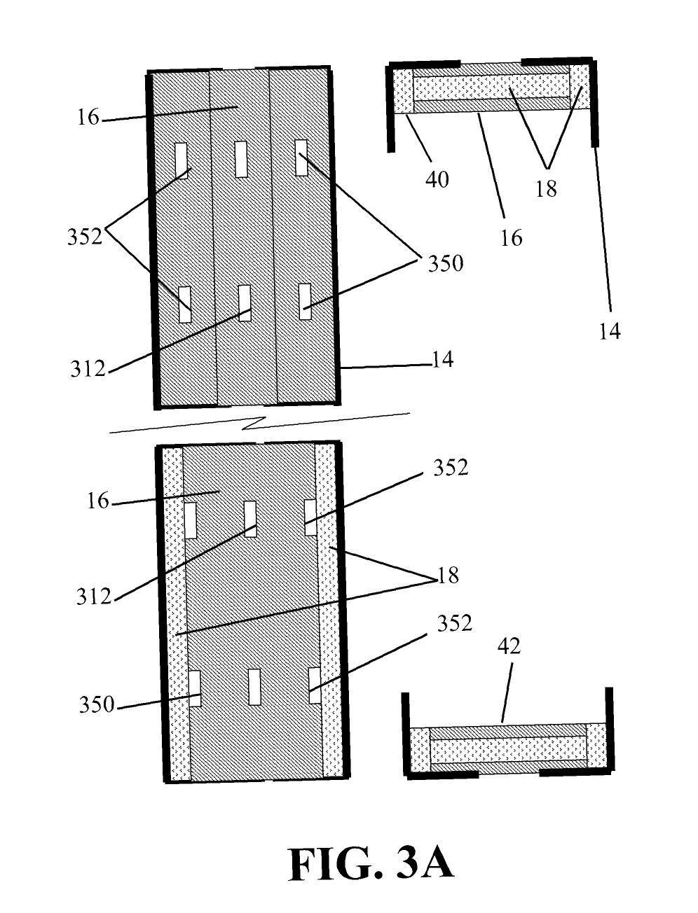

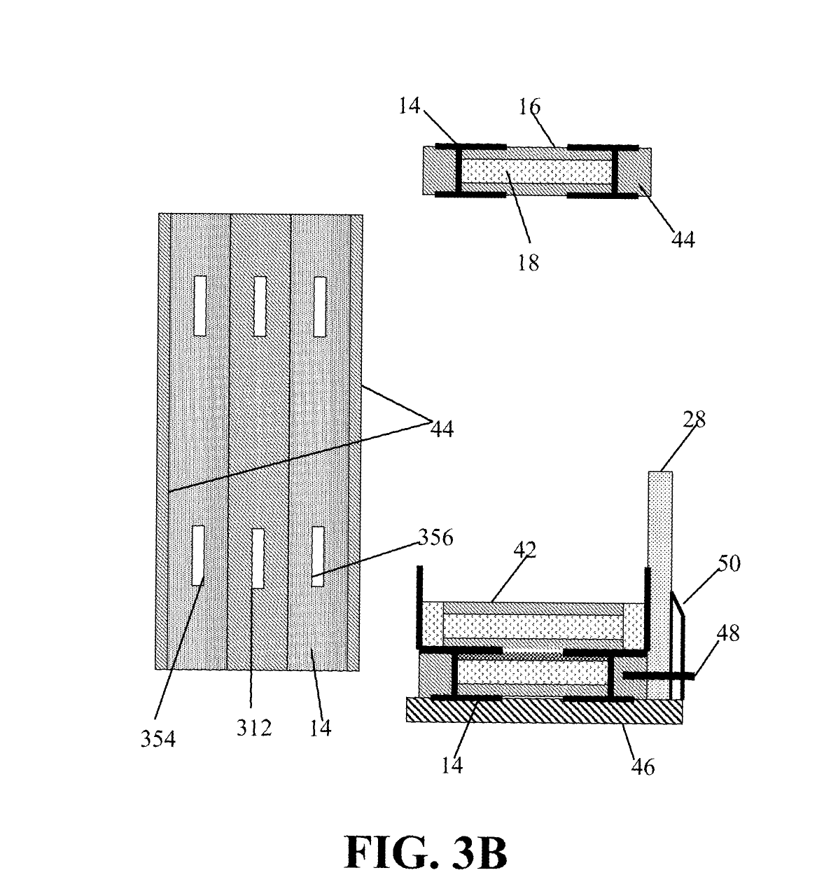

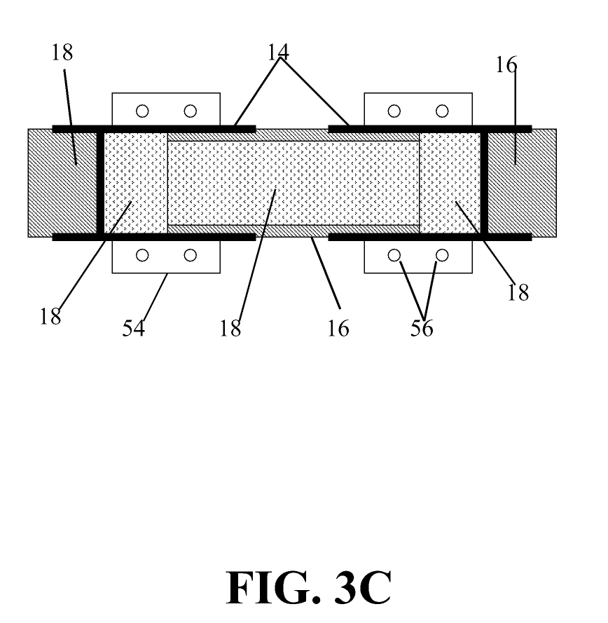

FIG. 3 shown both the side views and the sectional view of a 2×6 composite insulated reinforcement member 264. The reinforcement member 264 configured with OSB members 16, rigid foam members 18 and galvanized steel member 14; can be used vertically or horizontally for reinforcement along top and bottom plates for door jams and window sill plates. Also shown various openings on it's body; 346 for in-wall forced air, 348 for independent active thermal forced air, 312 for plumbing & electrical.

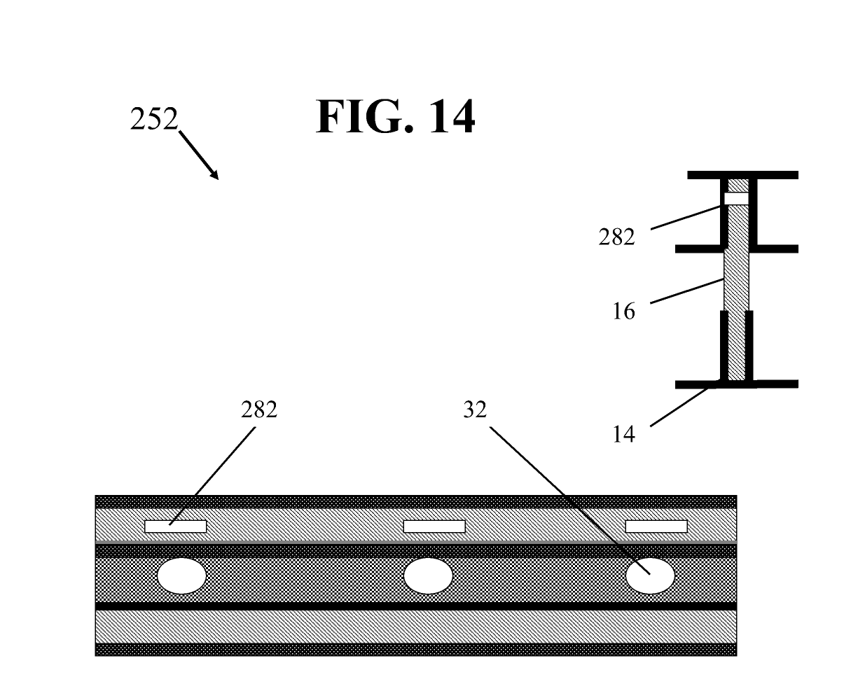

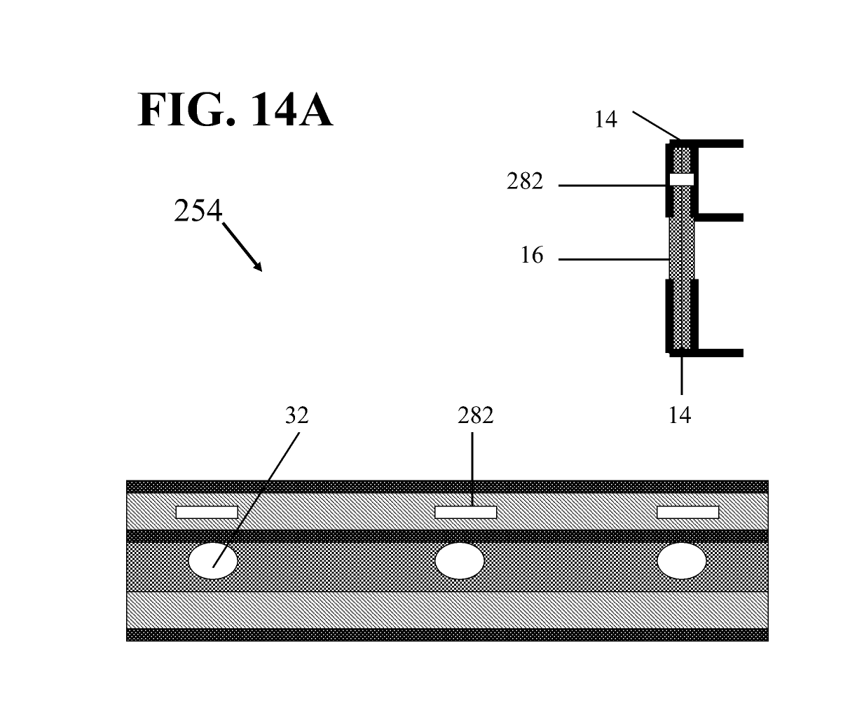

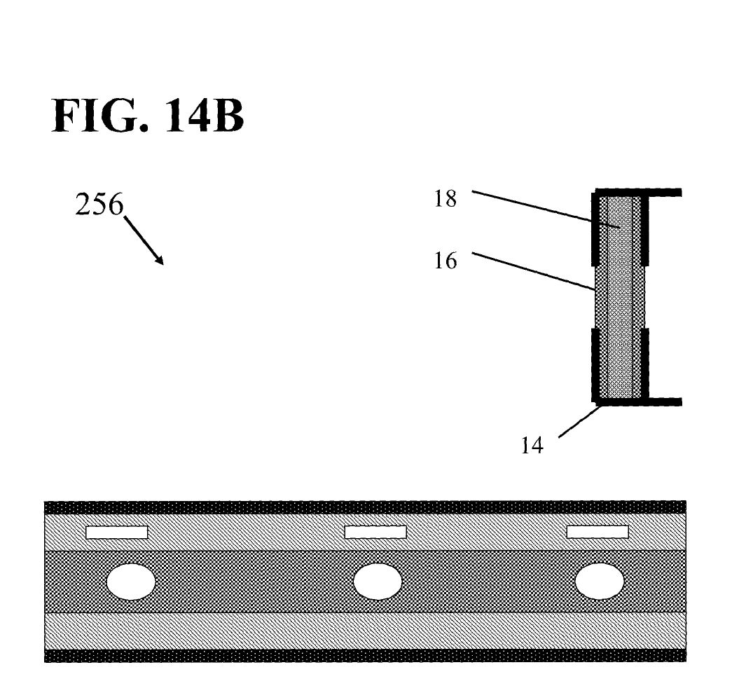

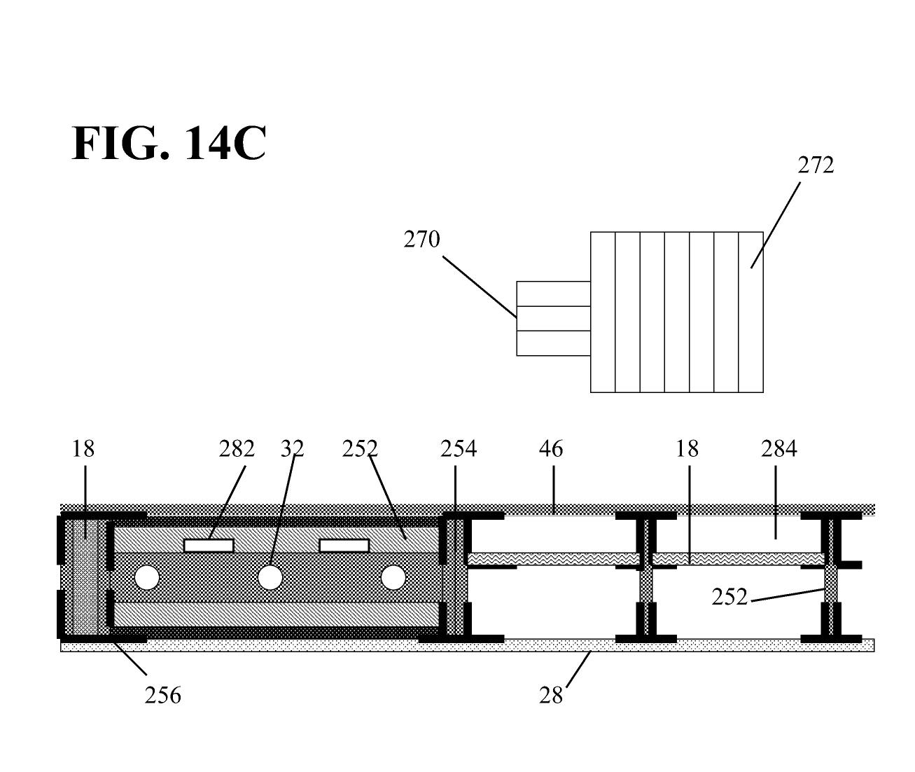

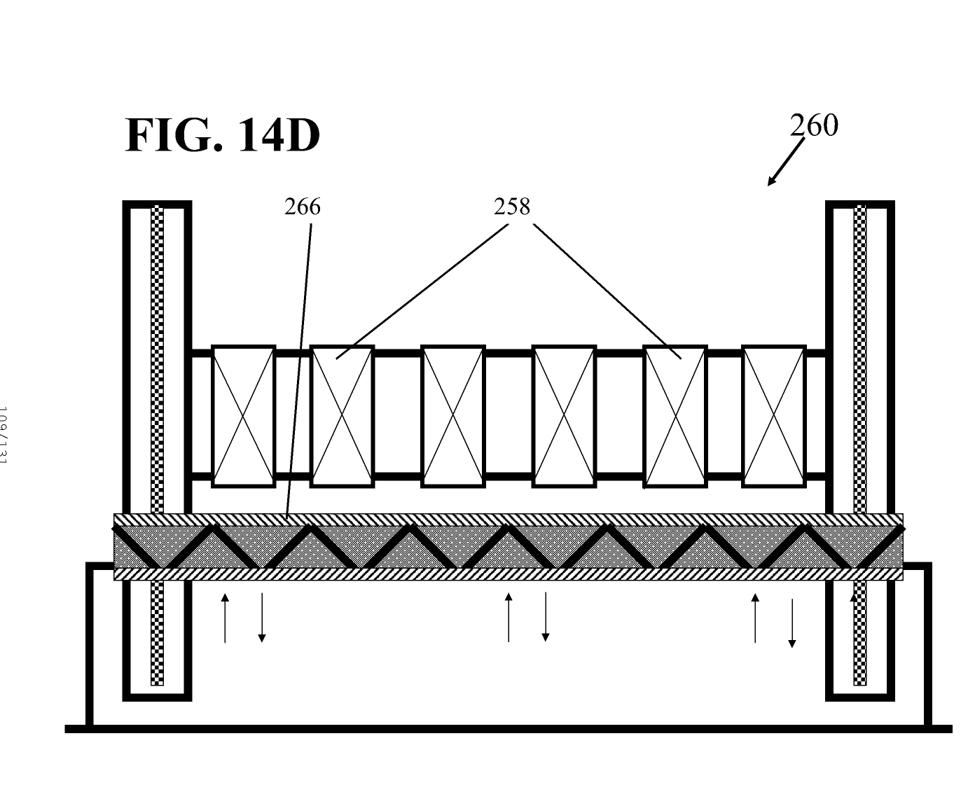

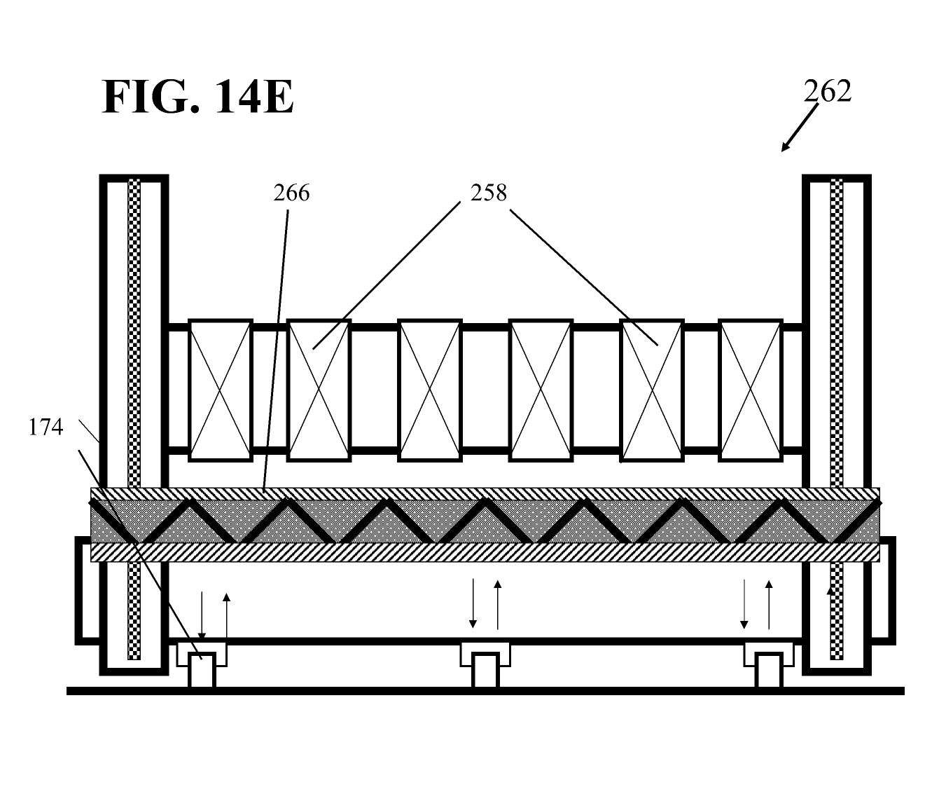

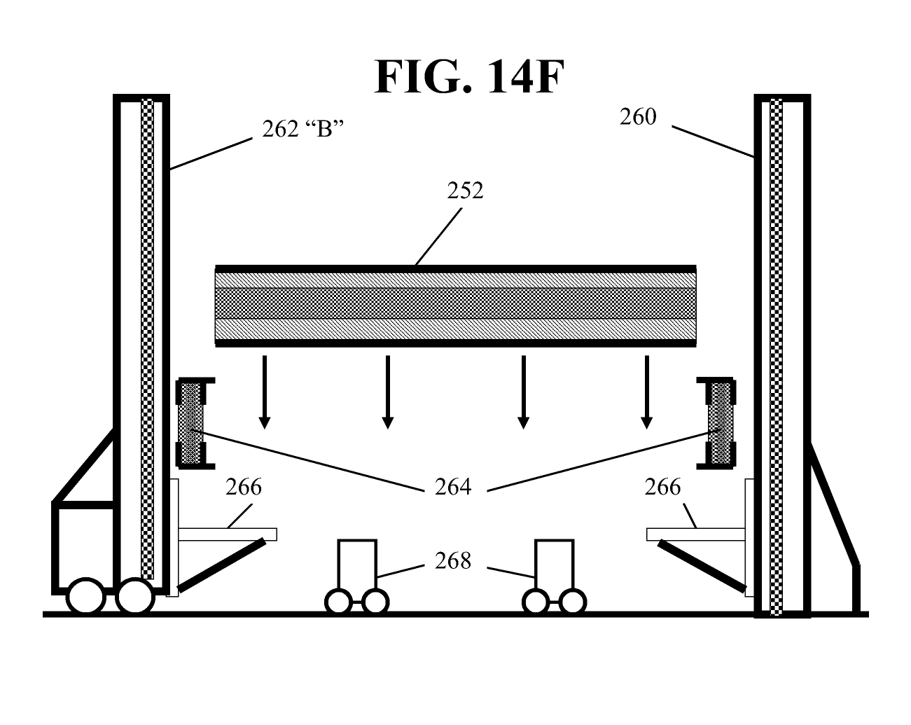

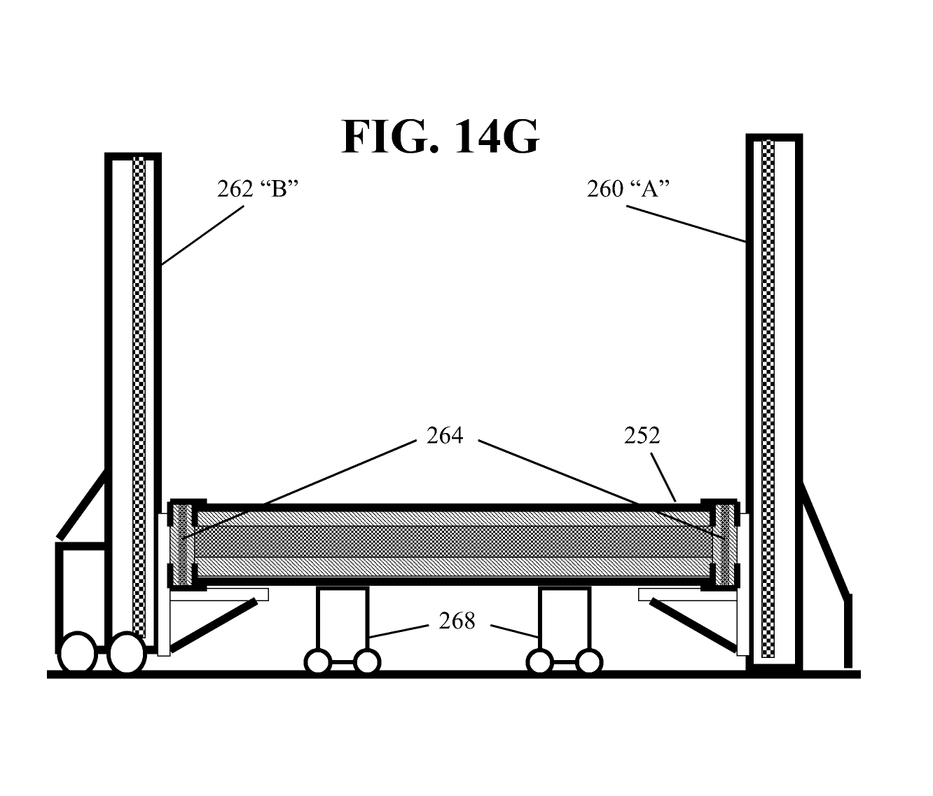

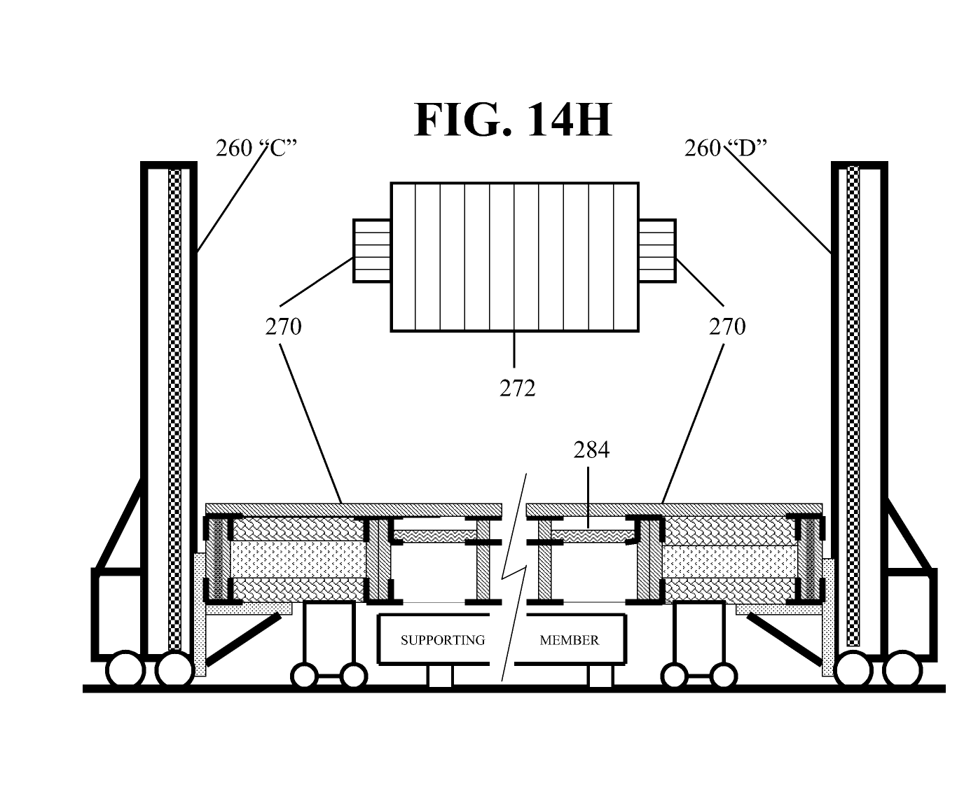

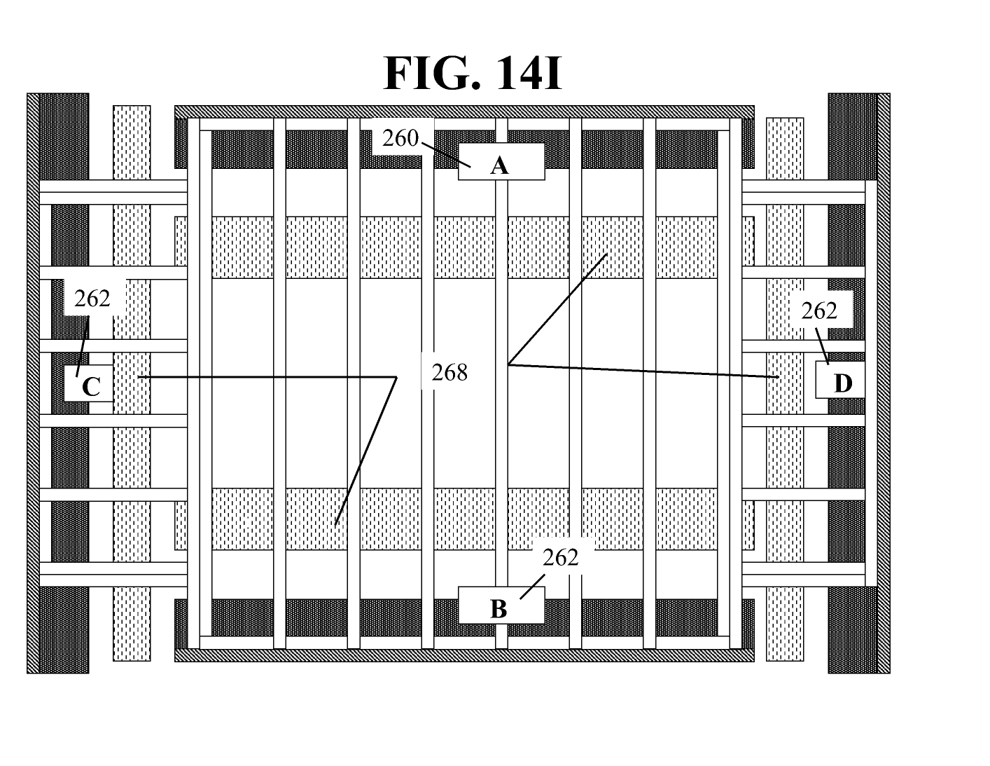

FIG. 3A are sectional views of the top sill plate 40 and bottom sill plate 42. Shown are two OSB members 16 sandwiched a piece of rigid foam 18 extended to both ends as insulation 18 between metal 14 and OSB members 16 to short circuit the thermal bridging effect. It can also be used as an exterior side plate for the floor joist system by increase its size 2″×10″ or 2′×12″ refers to FIG. 14b. Openings 350 are provided for facilitate forced air passages of heated forced air 352 for in-wall forced air and 312 for plumbing and electrical therethrough.

FIG. 3B are views of composite insulated members “nail-board” 44. Its main use serves as a nail board for installing the baseboard with a fastener such as a screw or a nail 48, due to the composite insulated vertical members (studs) 12 and the bottom plates 42 are wrapped with galvanized steel 14. It is also used as enforcement member. Shown, two OSB members 16 sandwiched a piece or rigid foam 18 with two pieces of H-shape galvanized steel 14 at both ends which inset with the two OSB strips members 16 to short circuit the thermal bridging effect. Also shown is an applying example for installing the baseboard 50 in conjunction with bottom sill plate 42, floor sheathing 46 and drywall 28. Also shown various openings on it's body; 356 for in-wall forced air, 354 for independent active thermal forced air, and 312 for plumbing & electrical.

FIG. 3C is a side-end view of a horizontal window reinforcement sill plate 52. This composite member can be used for both the top and bottom window sill plates, configuring 2 pieces of “H” shape galvanized steel 14 which contain rigid foam 18 & OSB strips 16, steel bracket flanges 54 with screw recesses 56 at both ends can be used to secure this member to other vertical members. There is no contact point between the 2 pieces of the “H”-shaped steel 14.

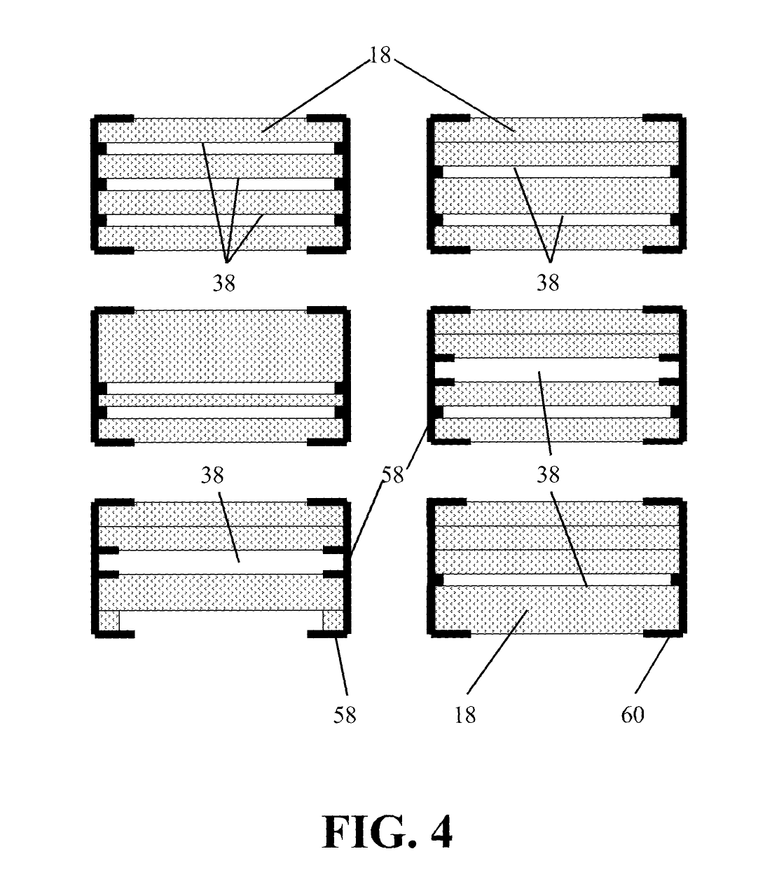

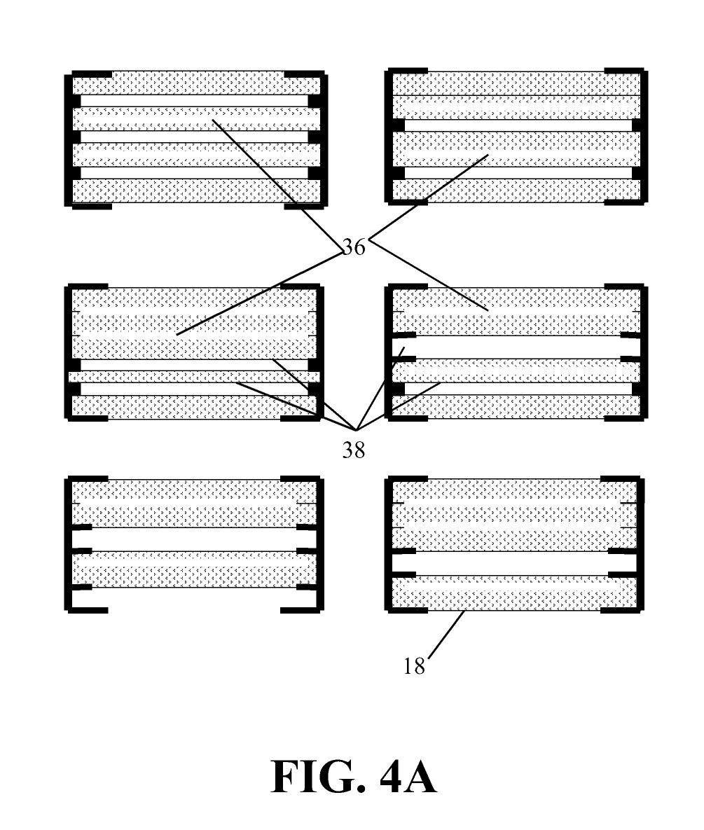

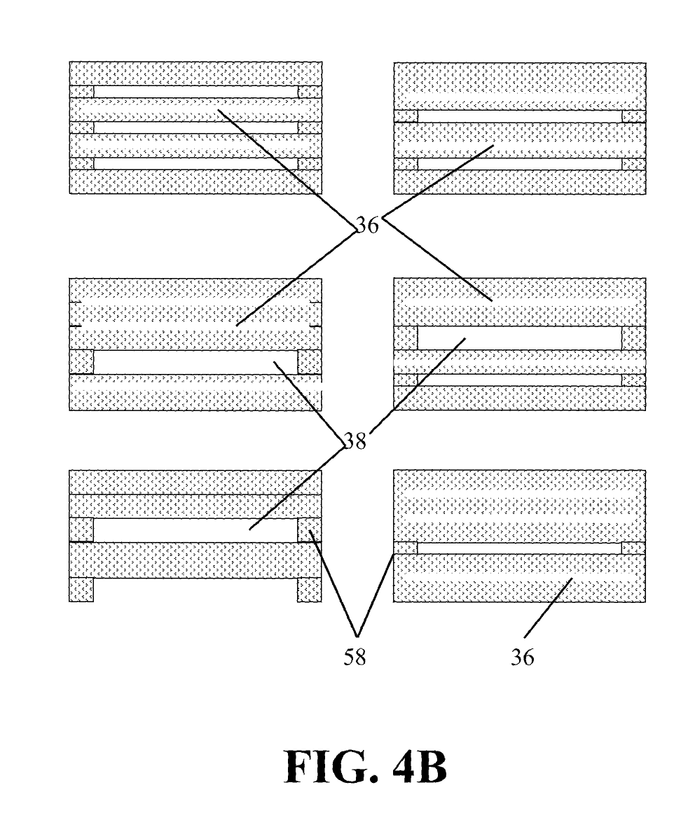

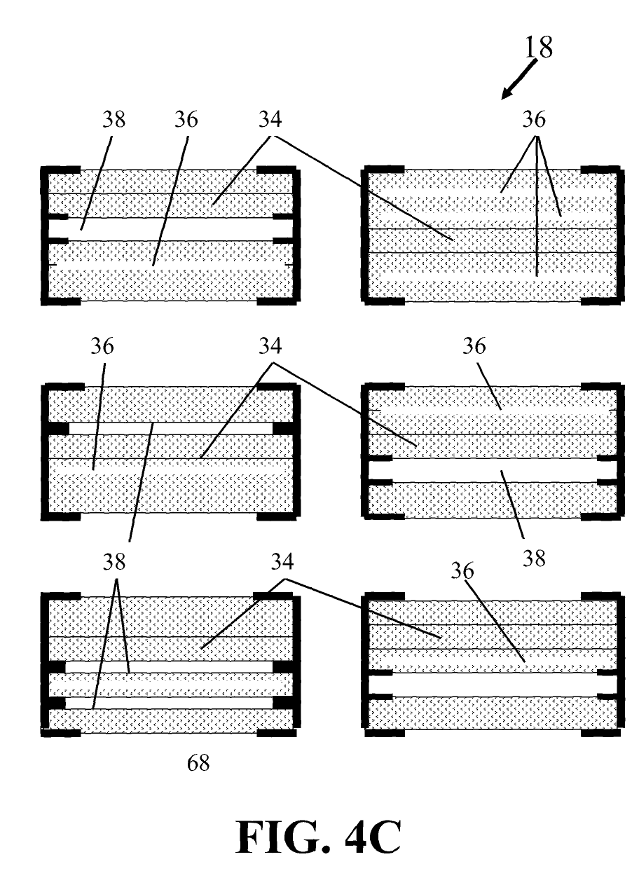

FIG. 4 is a side view of the present invention. Shown are side views of multiple “inactive cavities” 38 and spacers 58 which are created by stacking various thickness of sheets of rigid foam 18 and wrapped around four edges with plastic or membrane materials for durability. The larger cavities 38 shown are for accommodating in-wall electrical wiring and plumbing piping installations in conjunction align with the openings on the body of the vertical studs. Also shown is a protective wrap 60 around the casing.

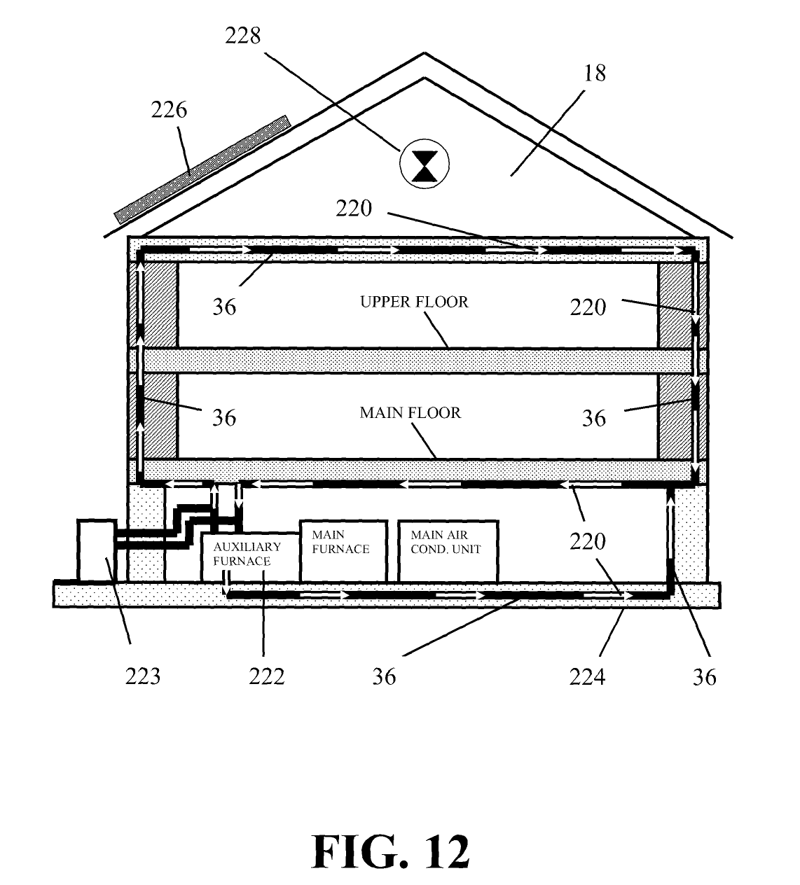

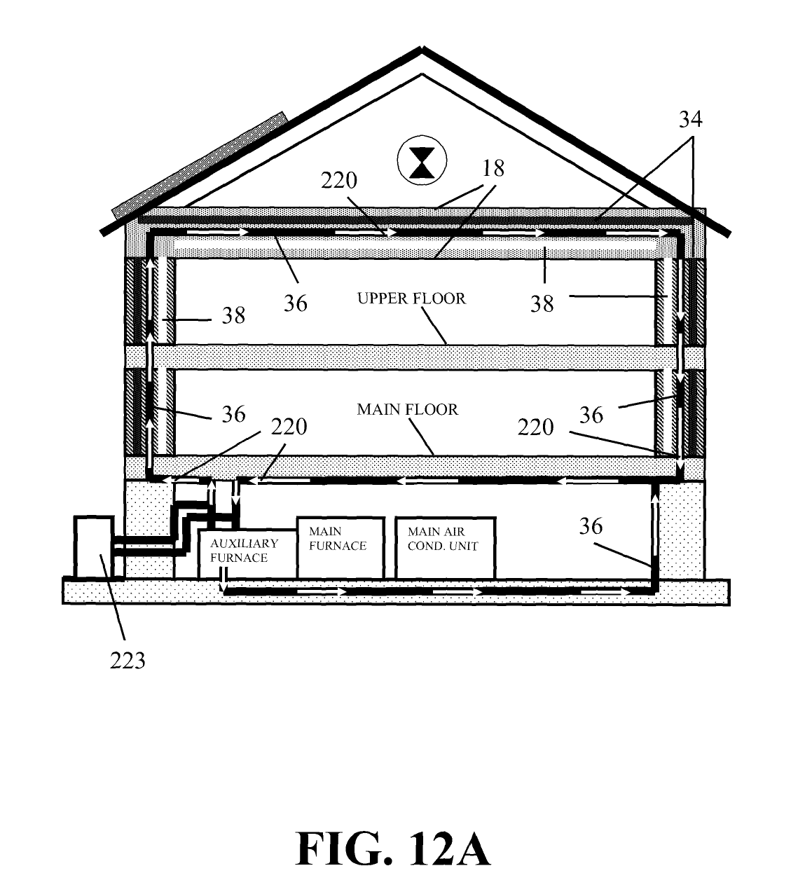

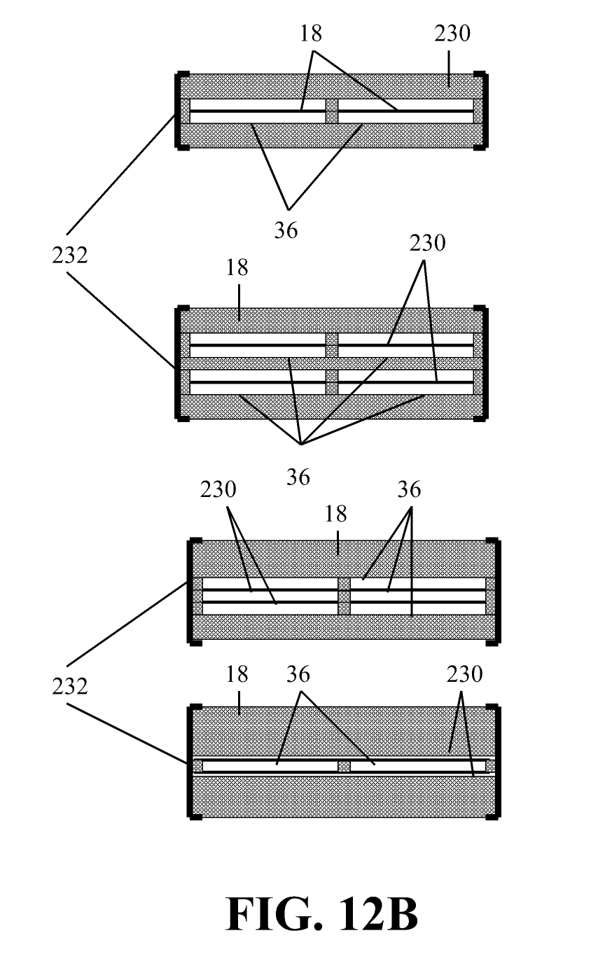

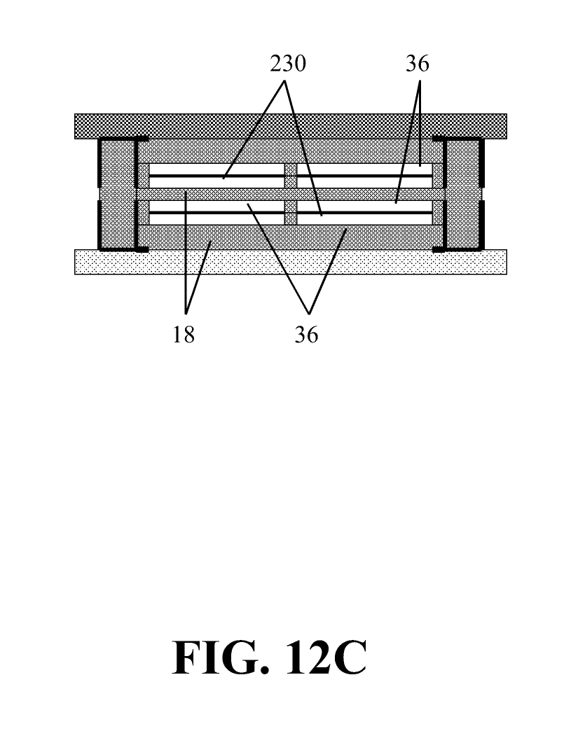

FIG. 4A is a side view of the present invention. Shown are the same configurations and arrangements of FIG. 4 with inactive cavities 38. But multiple smaller cavities 36 are also created and incorporated in the layers of rigid foam 18, they are the independent active thermal cavities 36 which will be explained in the following FIG. 12.

FIG. 4B is a side view of the present invention. Shown are the same configurations and arrangements of FIG. 4 but without the protective casing and with both active 36 and inactive cavities 38. Sheets of foam stacked together by bonding strips of foam as spacers 58 on four edges. The following versions are for “lay and glue” and “cut to fit” awe sizes and spaces on site.

FIG. 4C is a side view of the present invention. Shown are the glass vacuum insulated panels (VIP) 34 added into the rigid foam components 18. Three insulation patterns are incorporated into the following rigid foam components 18: VIP 34, independent active thermal cavities 36, and inactive cavities 37 and together there are four insulation patterns including the rigid foam 18 itself.

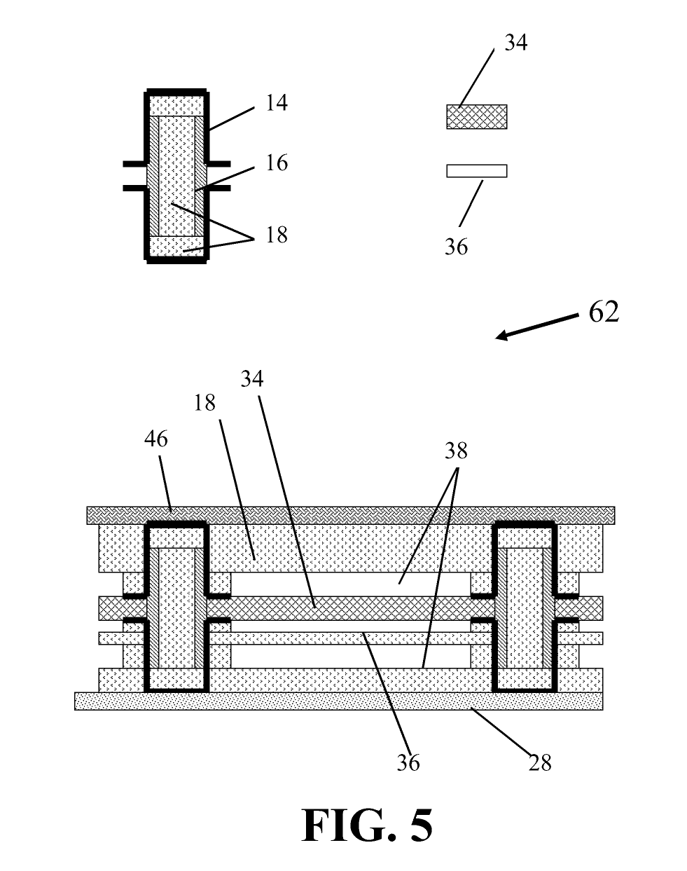

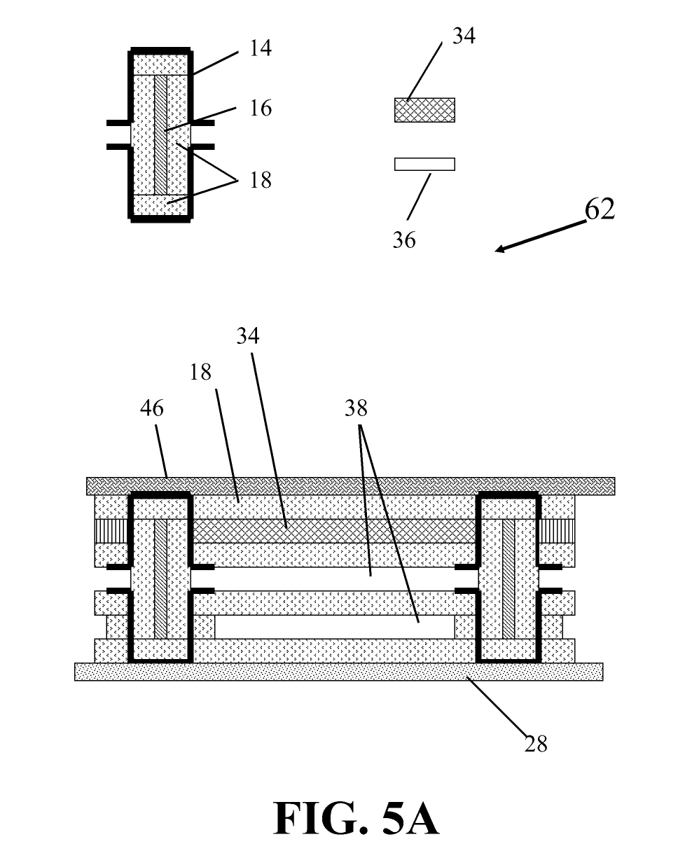

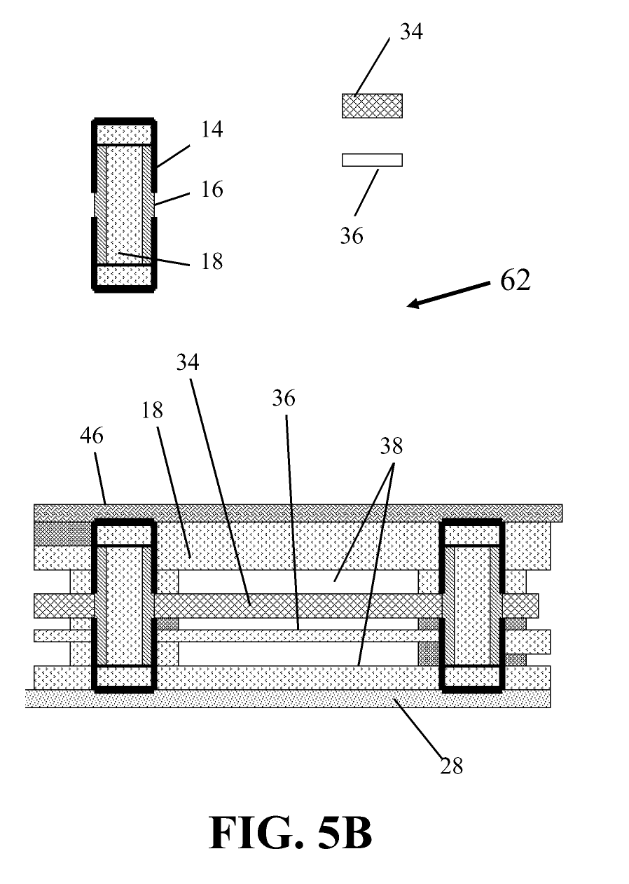

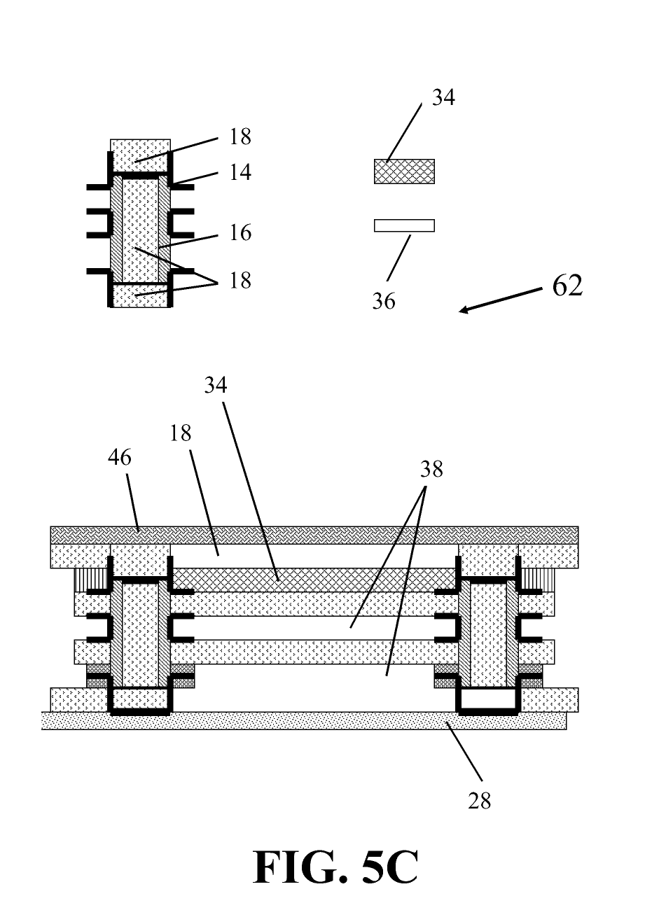

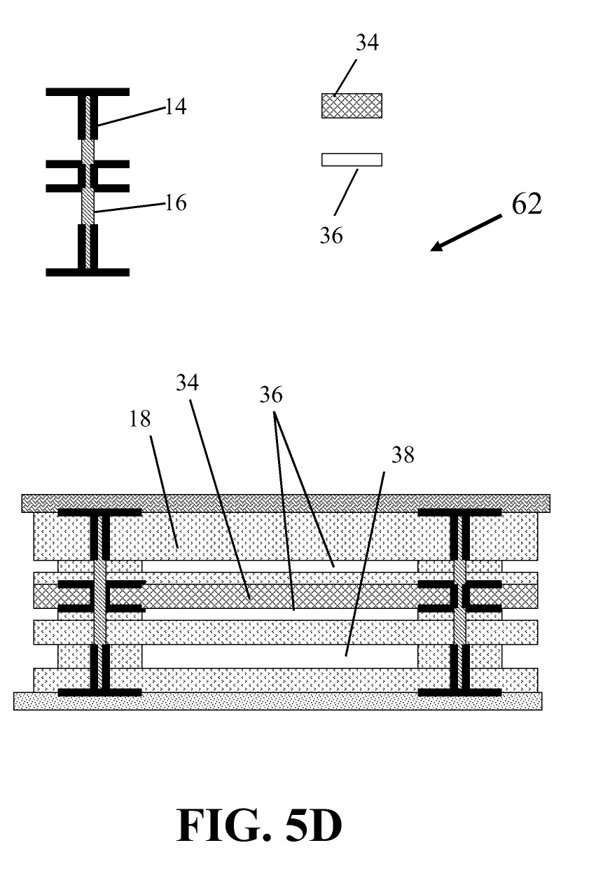

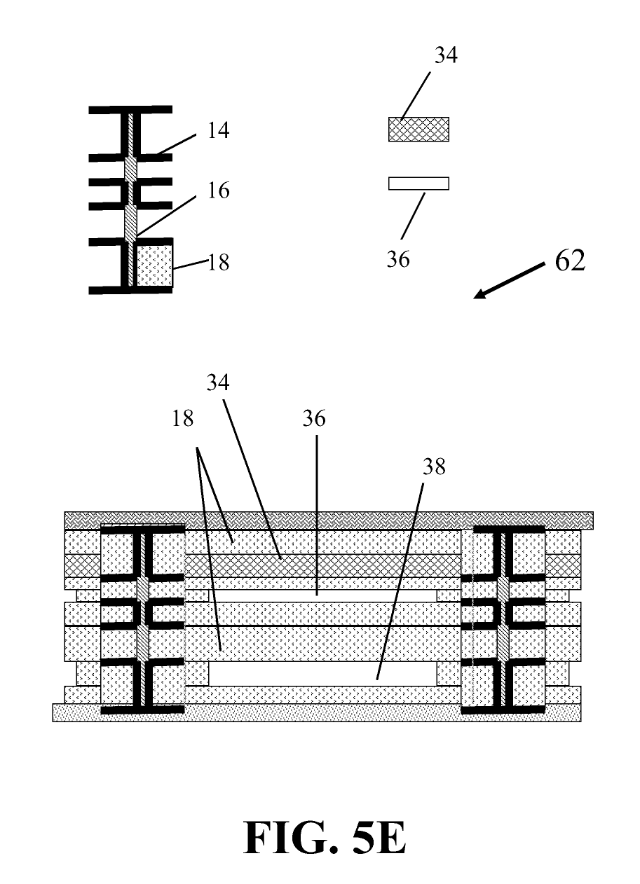

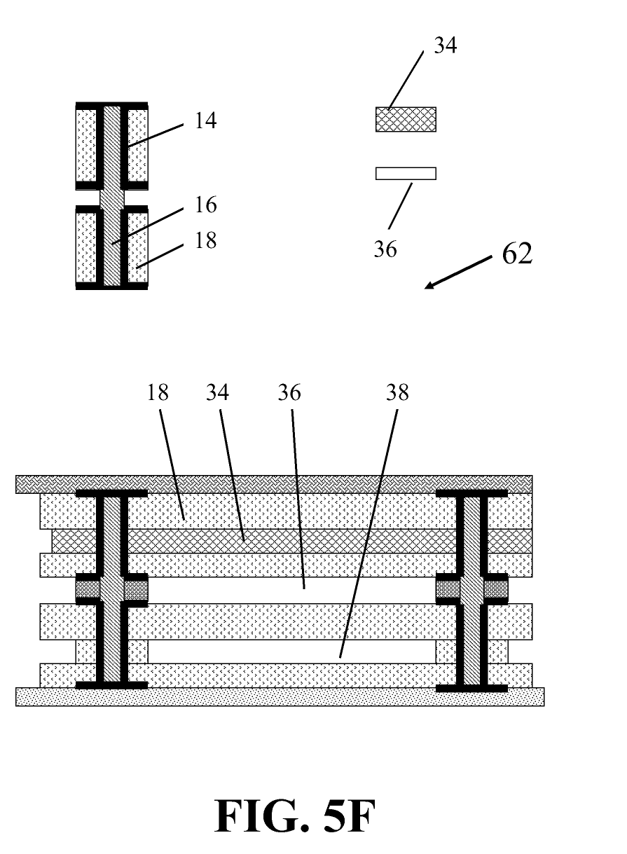

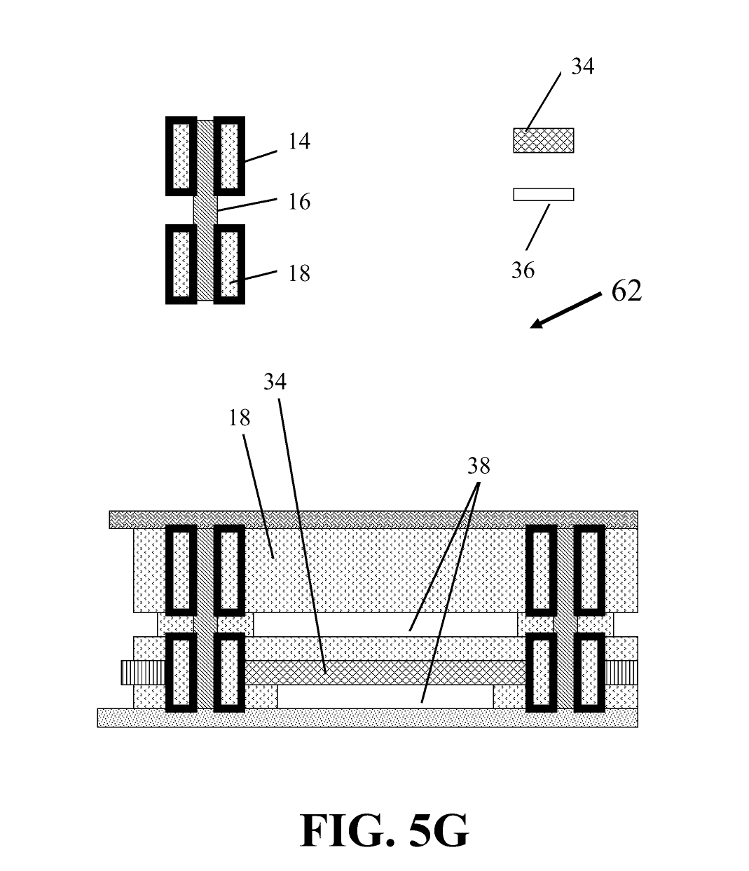

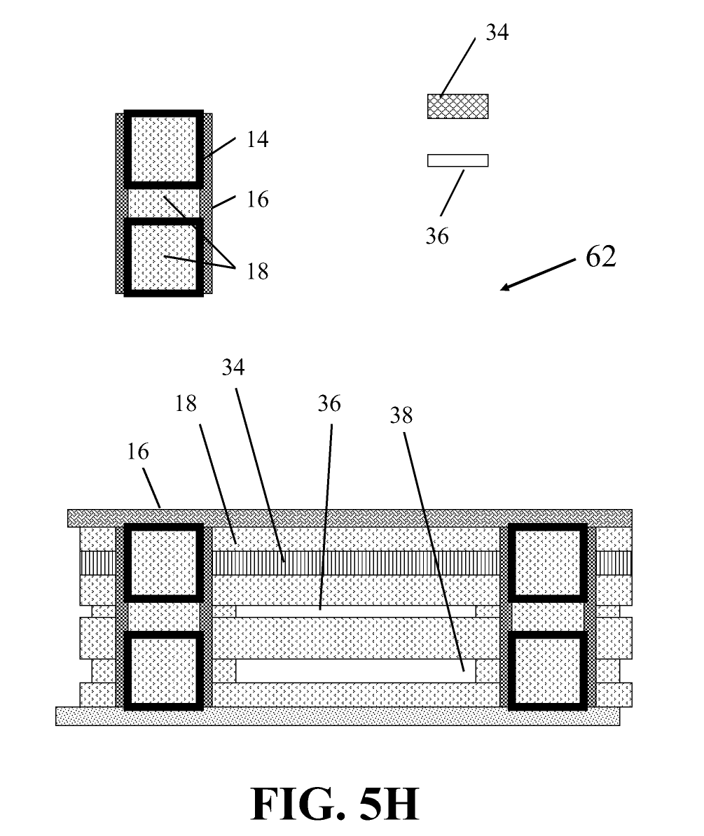

FIG. 5 is a sectional view of composite stud and wall assembly 62. Composite member (stud 1) rigid foam members 18, glass vacuum insulated panel (VIP) 34. Independent active thermal cavity 36 and inactive 38 cavities. Glass vacuum insulated panel (VIP) 34 & independent active thermal cavity 36 can be applied within the studs as application requires (shown also in FIG. 2b). Drywall 28 and sheathing 46 are installed on opposing sides thereof.

FIG. 5A is another top sectional view of wall assembly 62. Composite member (stud 2) rigid foam members 18, glass vacuum insulated panel (VIP) 34, independent active thermal cavity 36 and inactive cavities 38. Glass vacuum insulated panel (VIP) 34 & independent active thermal cavity 36 can be applied within the studs as application requires (shown also in FIG. 2b). Drywall 28 and sheathing 46 are installed on opposing sides thereof.

FIG. 5B is another top sectional view of wall assembly 62. Composite member (stud 3) rigid foam members 18, glass vacuum insulated panel (VIP) 34, independent active thermal cavity 36 and inactive 38 cavities. Glass vacuum insulated panel (VIP) 34 & independent active thermal cavity 36 can be applied within the studs as application requires (shown also in FIG. 2b). Drywall 28 and sheathing 46 are installed on opposing sides thereof.

FIG. 5C is another sectional top view of composite stud and wall assembly 62. Composite member (stud 4) rigid foam members 18, glass vacuum insulated panel (VIP) 34, independent active thermal cavity 36 and inactive 38 cavities. Glass vacuum insulated panel (VIP) 34 & independent active thermal cavity 36 can be applied within the studs as application requires (shown also in FIG. 2b). Drywall 28 and sheathing 46 are installed on opposing sides thereof.

FIG. 5D is another sectional top view of composite stud and wall assembly 62. Composite member (stud 5) rigid foam members 18, glass vacuum insulated panel (VIP) 34, independent active thermal cavity 36 and inactive 38 cavities. Glass vacuum insulated panel (VIP) 34 & independent active thermal cavity 36 can be applied within the studs as application requires (shown also in FIG. 2b).

FIG. 5E is another sectional top view of composite stud and wall assembly 62. Composite member (stud 6) rigid foam members 18, glass vacuum insulated panel (VIP) 34, independent active thermal cavity 36 and inactive 38 cavities. Glass vacuum insulated panel (VIP) 34 & independent active thermal cavity 36 can be applied within the studs as application requires (shown also in FIG. 2b).

FIG. 5F is another sectional top view of composite stud and wall assembly 62. Composite member (stud 7) rigid foam members 18, glass vacuum insulated panel (VIP) 34, independent active thermal cavity 36 and inactive 38 cavities. Glass vacuum insulated panel (VIP) 34 & independent active thermal cavity 36 can be applied within the studs as application requires (shown also in FIG. 2b).

FIG. 5G is another sectional top view of composite stud and wall assembly 62. Composite member (stud 8) rigid foam members 18, glass vacuum insulated panel (VIP) 34, independent active thermal cavity 36 and inactive 38 cavities. Glass vacuum insulated panel (VIP) 34 & independent active thermal cavity 36 can be applied within the studs as application requires (shown also in FIG. 2b).

FIG. 5H is another sectional top view of composite stud and wall assembly 62. Composite member (stud 9) rigid foam members 18, glass vacuum insulated panel (VIP) 34, independent active thermal cavity 36 and inactive 38 cavities. Glass vacuum insulated panel (VIP) 34 & independent active thermal cavity 36 can be applied within the studs as application requires (shown also in FIG. 2b).

FIG. 5I is another sectional top view of composite stud and wall assembly 62. Composite member (stud 10) rigid foam members 18, glass vacuum insulated panel (VIP) 34, independent active thermal cavity 36 and inactive 38 cavities. Glass vacuum insulated panel (VIP) 34 & independent active thermal cavity 36 can be applied within the studs as application requires (shown also in FIG. 2b).

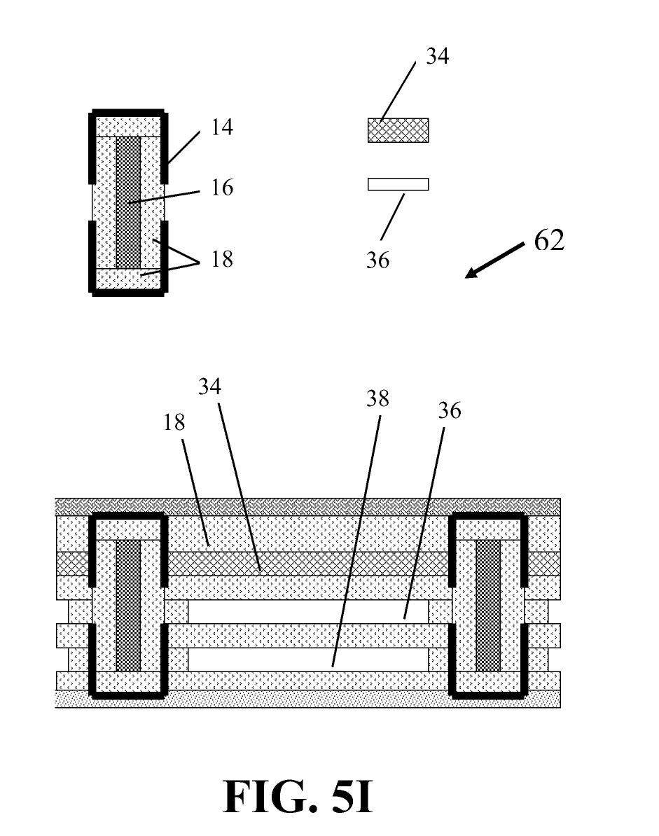

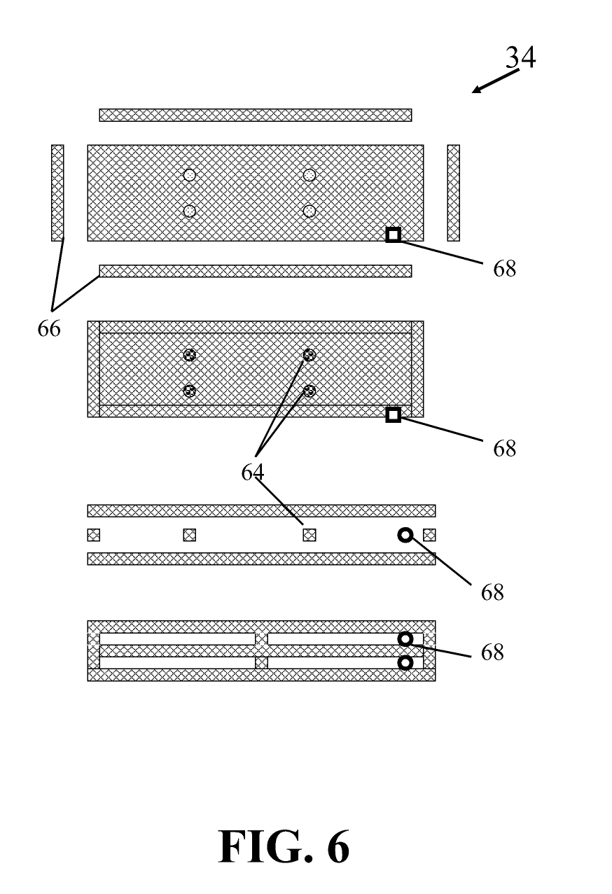

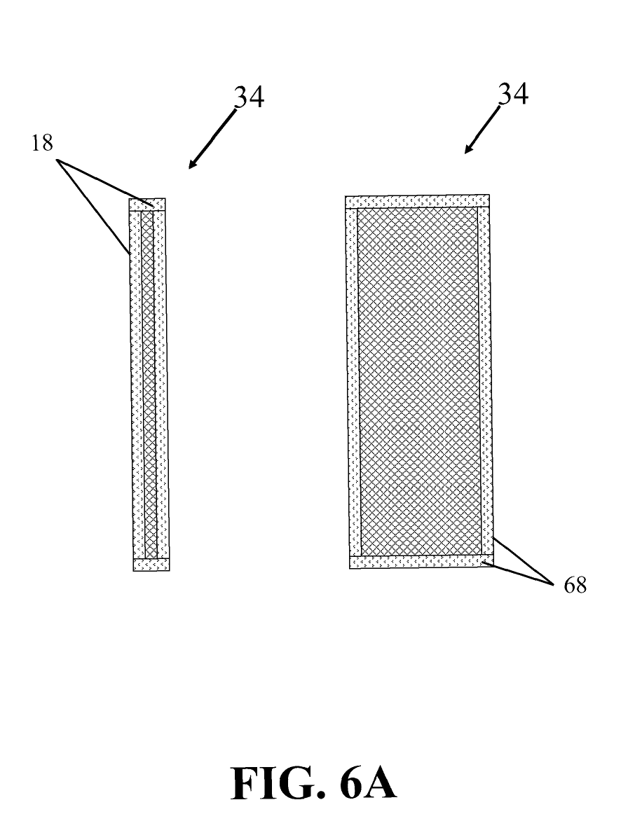

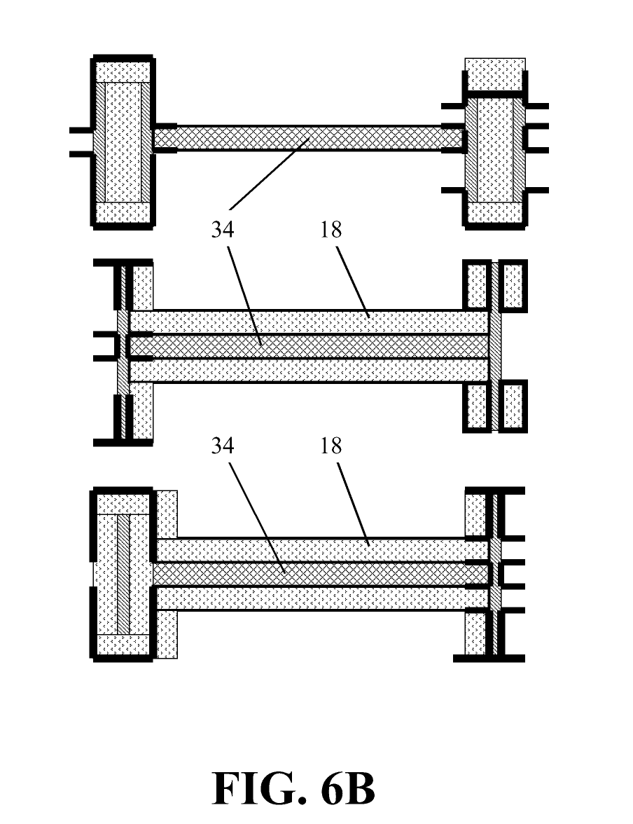

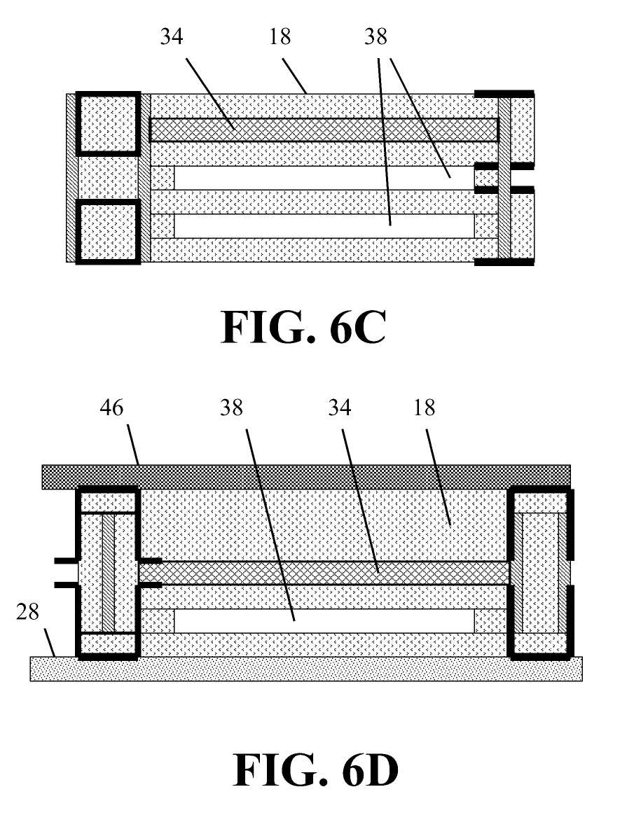

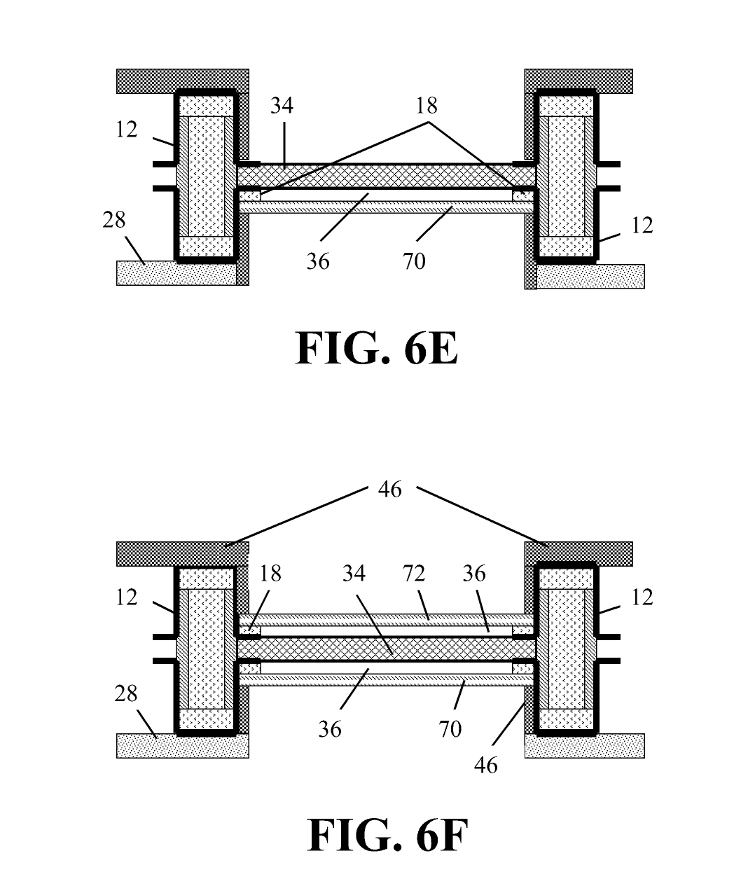

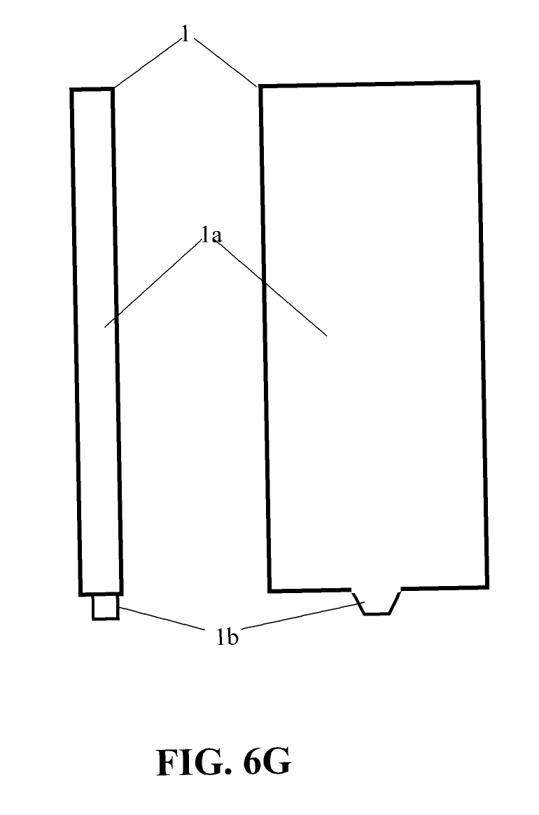

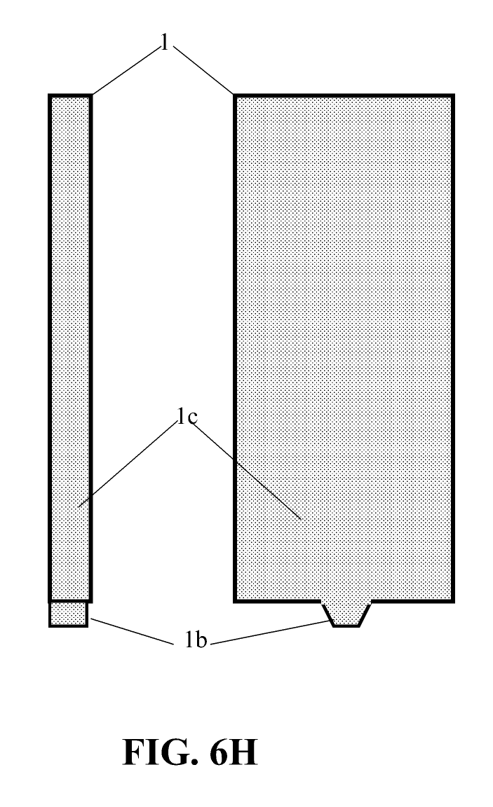

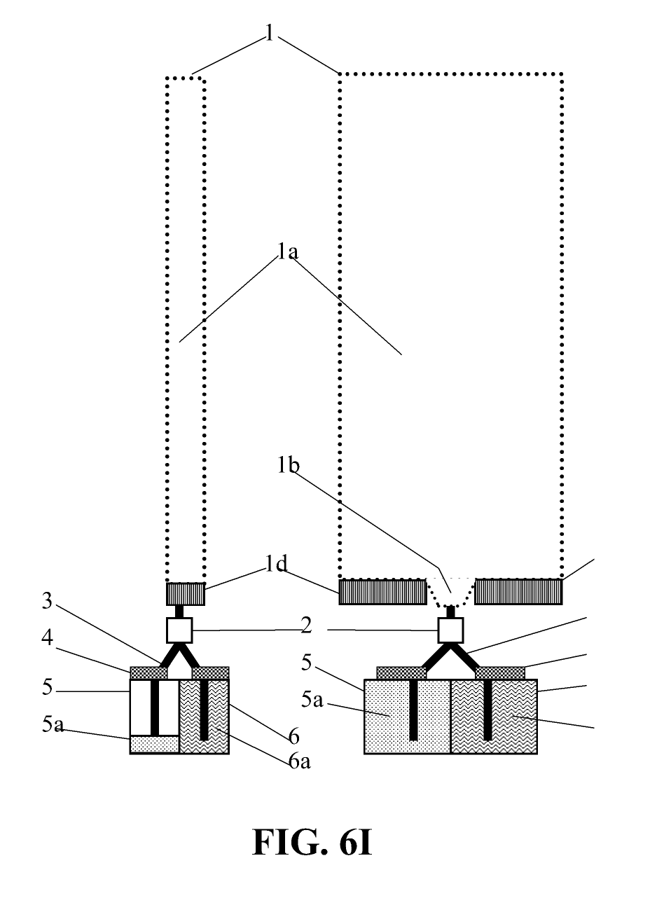

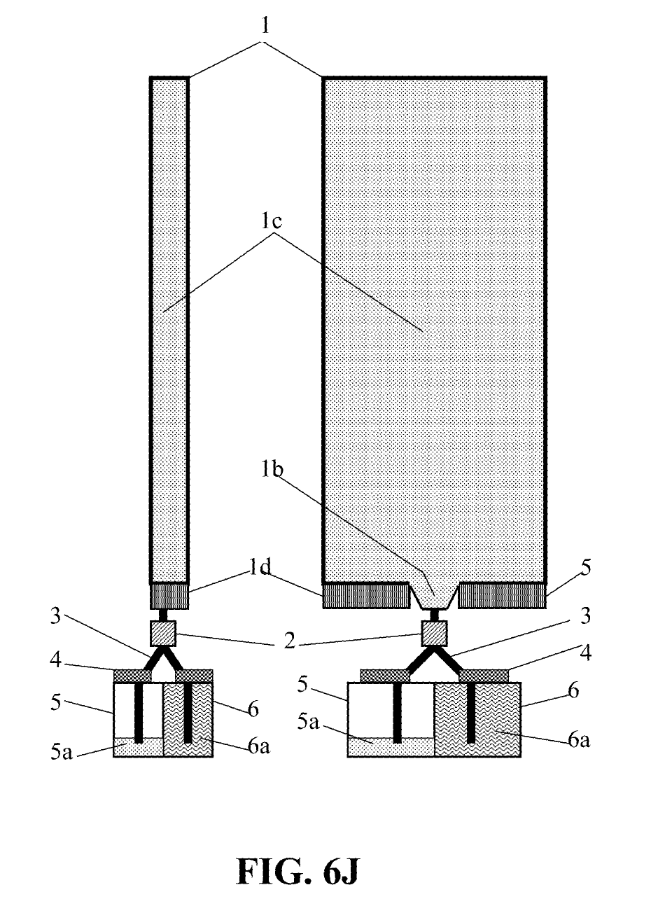

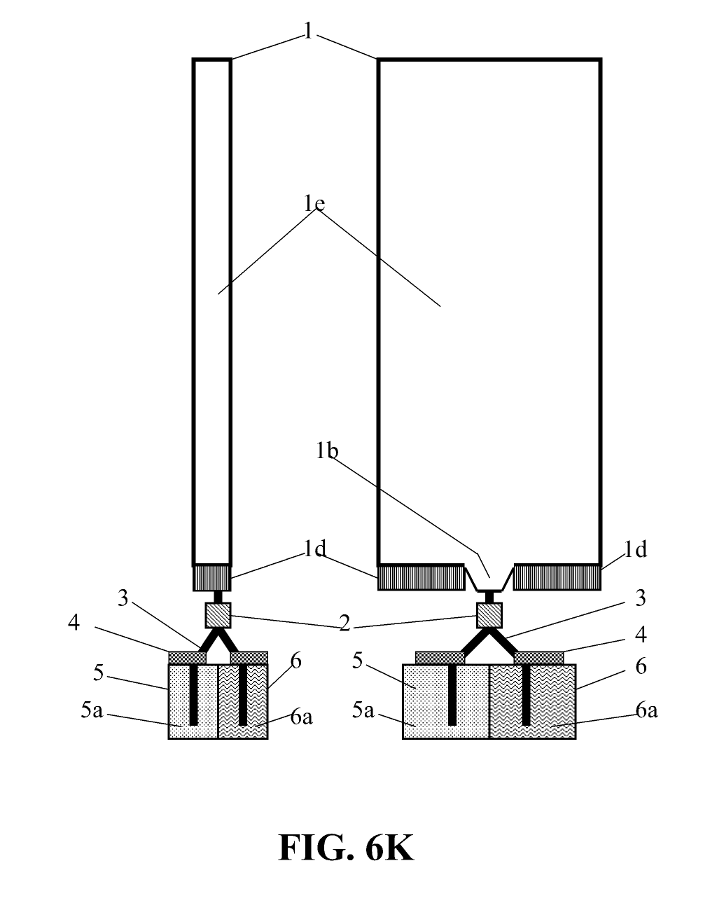

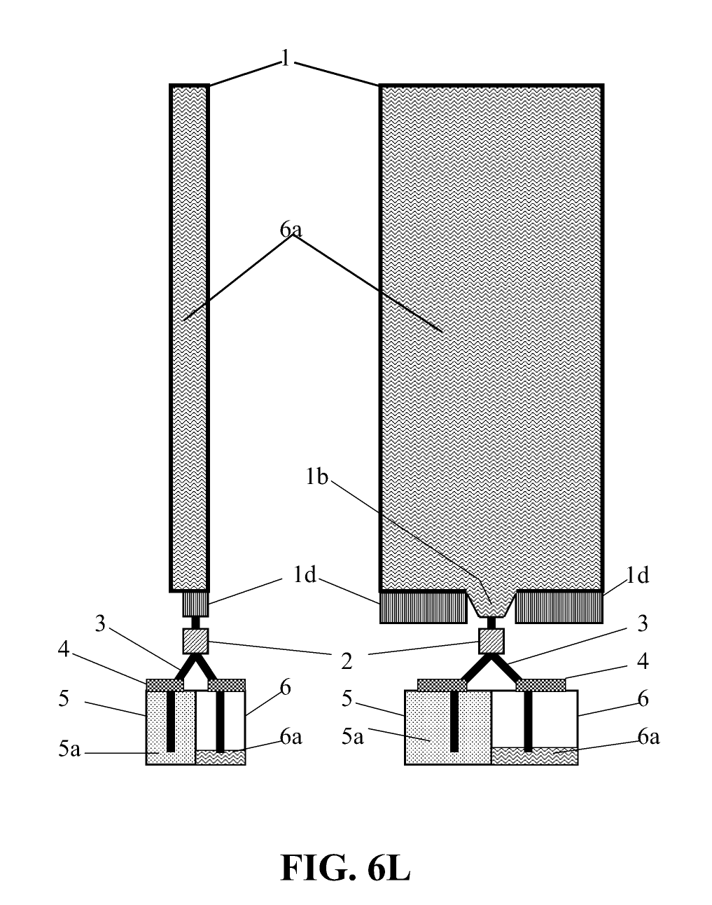

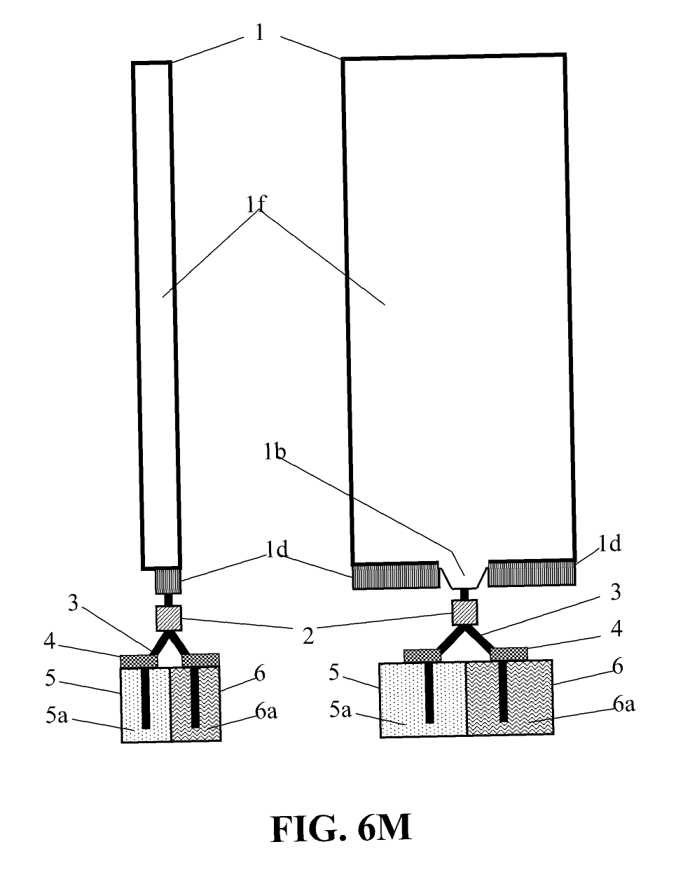

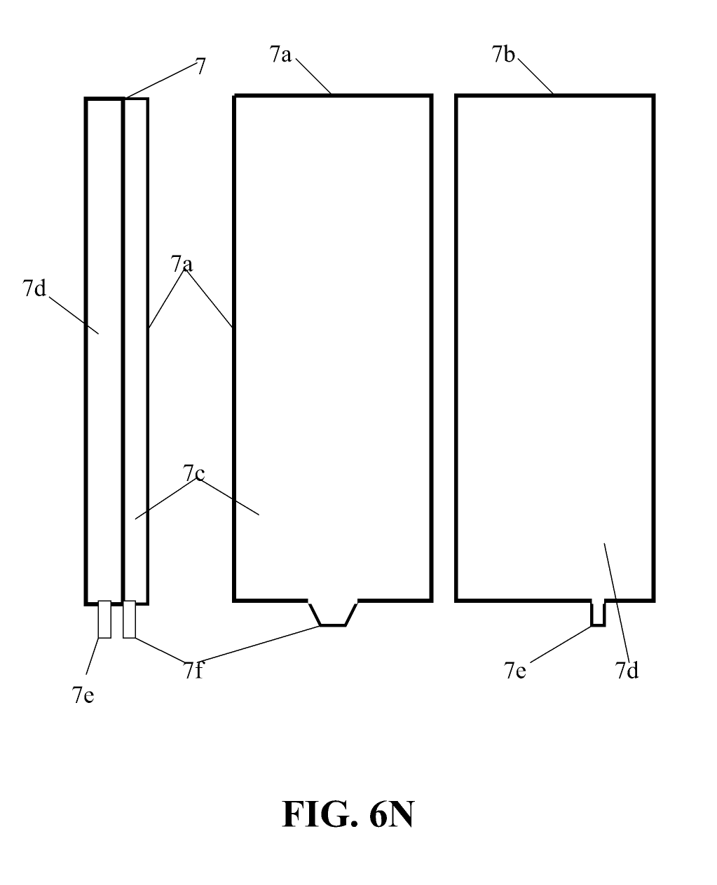

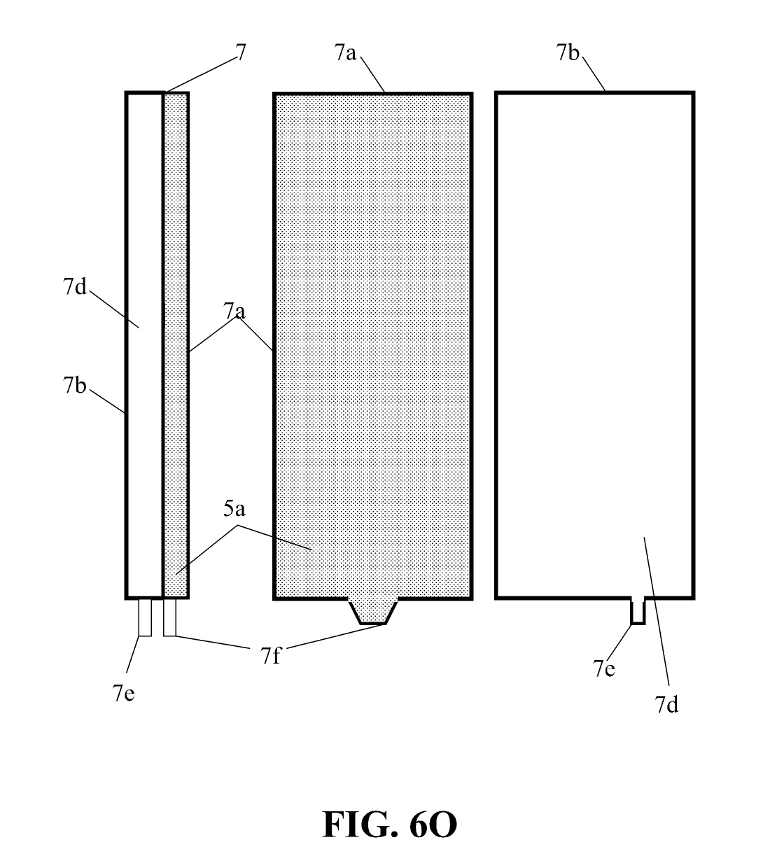

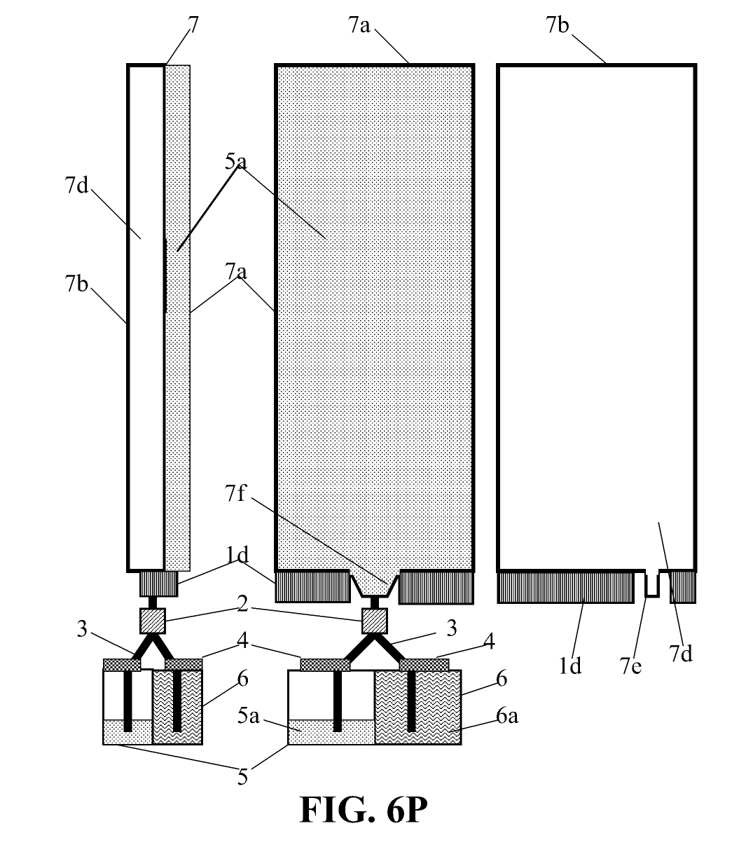

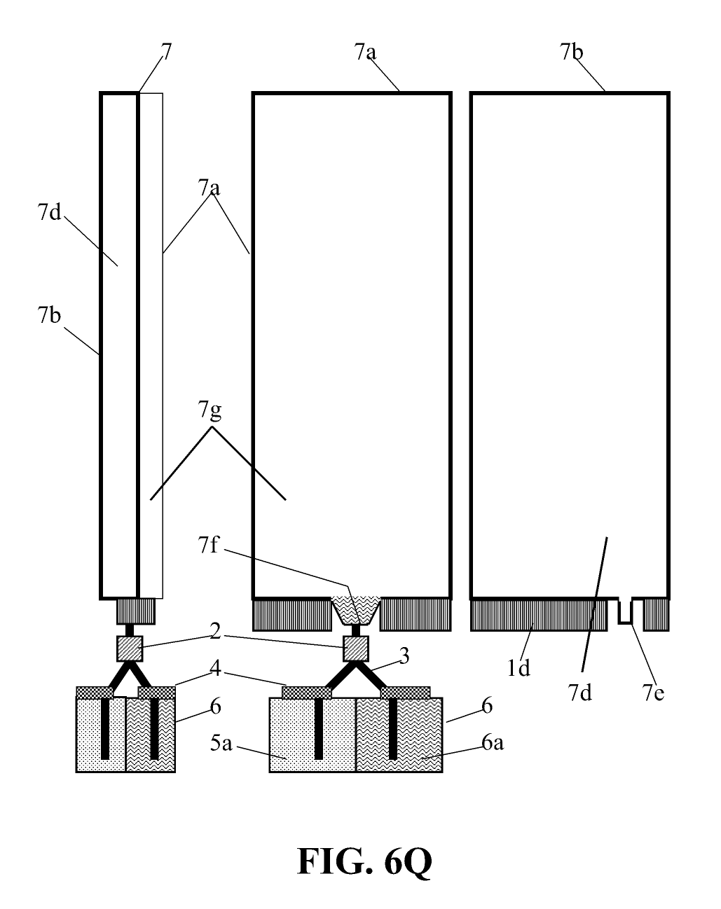

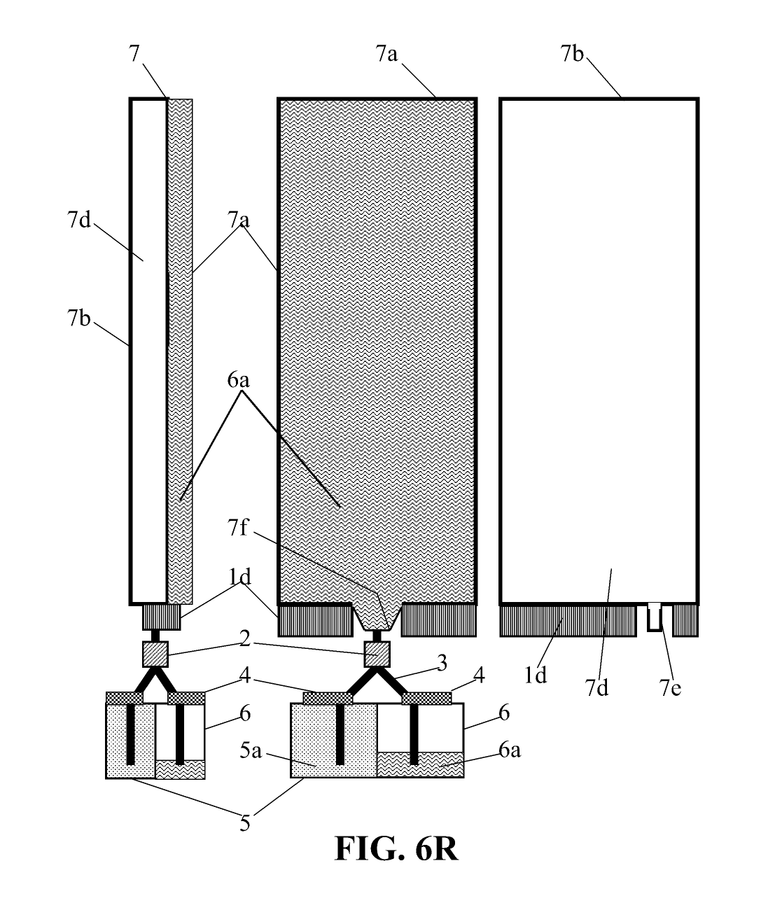

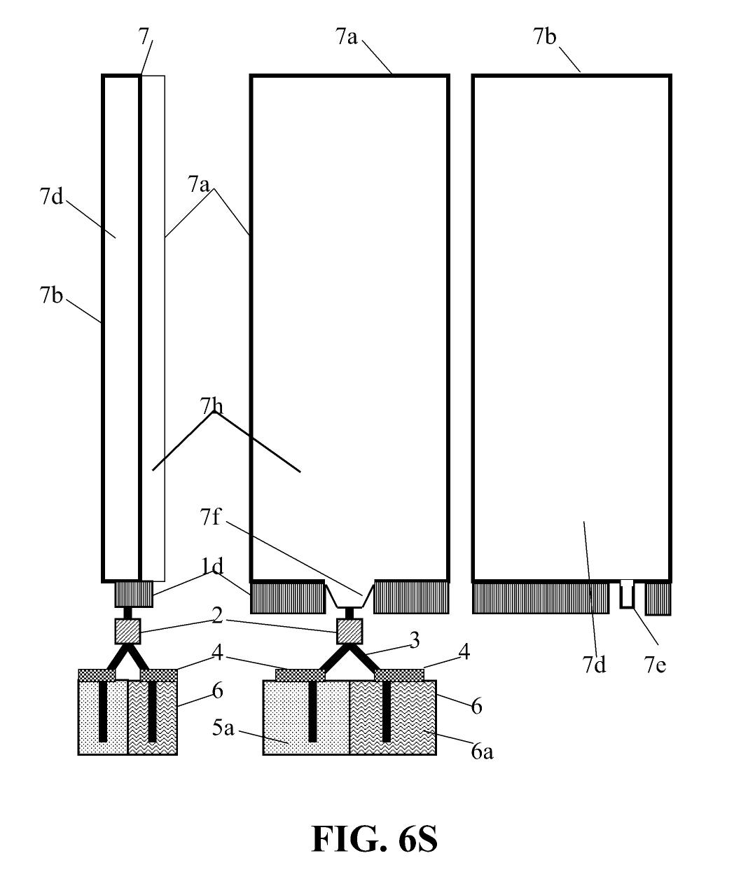

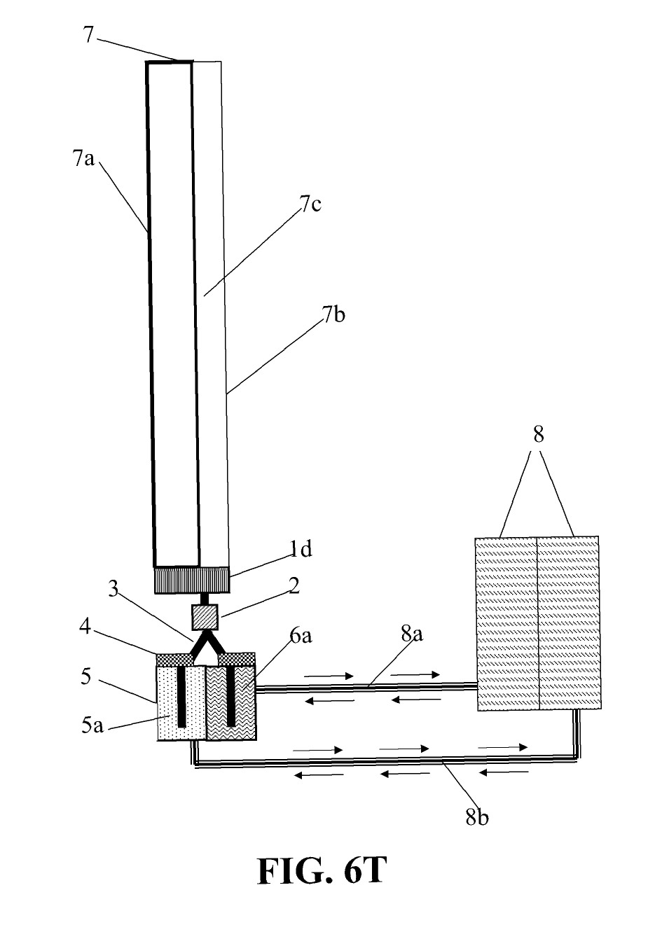

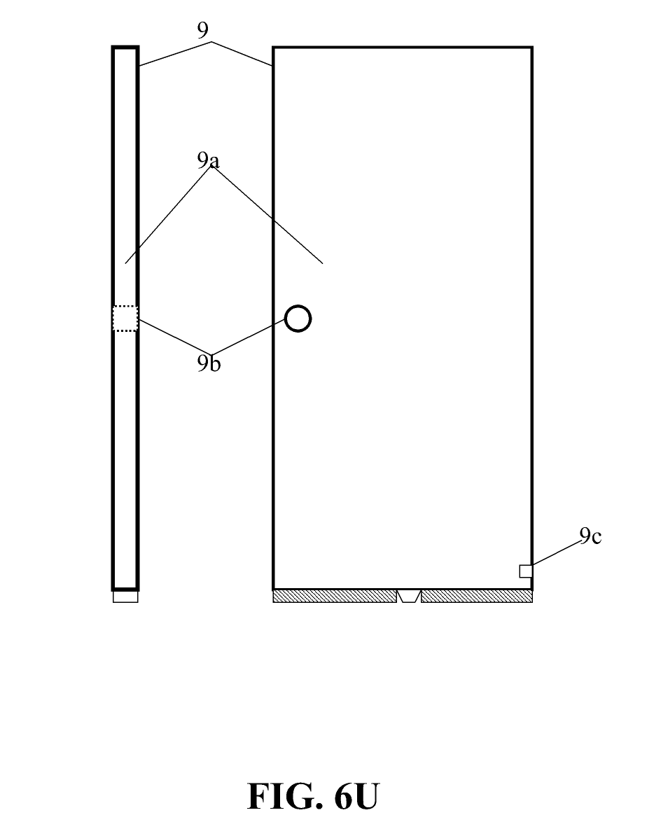

FIG. 6 is top views of glass vacuum insulation panel (VIP) 34 assemblies. The melted glass has four support pellets 64, four glass strip edges 66 and glass nipple 68.

FIG. 6A is sectional views of single and double panel VIP 34 wrapped around with rigid foam 18 edges. Also explaining the formation of triple pane VIP 34.

FIG. 6B is sectional views of the present invention. Shown is the VIP 34 with and without the rigid foam insulation 18. Also demonstrates the unified function & application of various studs 12 of the present invention

FIG. 6C is VIP 34 sandwiched with rigid foam 18 and associate with other rigid foam members creating inactive cavities 38. Also demonstrates the unified function & application of various studs 12 of the present invention

FIG. 6D is a sectional view of VIP 34 sandwiched with rigid foam 18 as spacers creating single inactive cavity 38 between the OSB exterior wall sheathing 46 and the drywall 28. Also demonstrate the unified function & application of various studs 12 of the present invention

FIG. 6E is a top view of different composite insulated vertical members (stud) 12 spaced on-center and VIP 34 and the rigid foam 18 as spacers are configured to form an independent active thermal cavity 36 on the interior side of the VIP 34 by installing a piece of single pane glass 70 adjacent to the interior side of the VIP 34 in between the on-center studs 12. Also demonstrate the unified function & application of various studs 12 of the present invention.

FIG. 6F is a top view of the composite insulated vertical members (stud) 12 and VIP 34. The composite vertical insulated members (stud) 12 and rigid foam members 18 as spacers, (refers to FIG. 6E) by installing another piece of single pane glass 72 adjacent to the exterior side of the VIP 34 creating an inactive cavities 38, therefore cavities are created on either side of the VIP 34 with feature glass. The sheathing 46 and the drywall 28 are applied to the composite insulated vertical members (stud) 12. Also demonstrate the unified function & application of various studs 12 of the present invention

FIG. 6G illustrates the side and front view of the body the un-obscured double pane glass VIP 1. 1a is the cavity of the body of the VIP 1 at this stage it is with no vacuum condition, and 1b shows the protruding fluid drain outlet.

FIG. 6H shows the side and front view of the body of the un-obscured double pane glass VIP 1, with its cavity refer to FIG. 1 as 1a, now it is pre-filled with lighter color fluid lc for the purpose of preparing & precondition the latter pressurized vacuum process to be performed. 1b is the protruding fluid drain outlet.

FIG. 6I shows the sectional view of the mechanical apparatus comprises programmable pumping, controlling devices, tubing & a dual reservoir filled with fluids. As illustrated; 1d shows the rigid foam supporting members to be used to cushion the weight of the glass VIP body set on the frame structure. 1b is the protruding fluid drain outlet connected with the split-flow control valve 2; this is performed by tubing 3 which transports all fluids, the tubing 3 splits its way and connects with two programmable pumps 4. The tubing 3 then extend their ways; one runs into the reservoir 5, which retains with the light fluid 5a and the other runs into reservoir 6 which retains the fluid 6a. Reservoir 5 is not filled to its full capacity in order to leave enough room for the return fluid from the to-be-connected body of the VIP 1 & its cavity 1a both shown in dotted lines; demonstrating the relationship with the incorporated mechanical apparatus.

FIG. 6J shows the side view and front view of the body of the un-obscured double pane glass VIP1 connected with the mechanical apparatus. As illustrated, the mechanical apparatus embraces the programmable pump 4 with controlling device connected by tubing 3 with the dual reservoir 5 & 6 being filled with fluids 5a & 6a. 1d illustrates the rigid foam supporting members that are used to cushion the weight of the VIP panel set on the frame structure. 1b is the protruding fluid drain outlet which helps to drain the last drop of the fluid back into reservoirs to reduce the mixing of the residual of the light color fluid 5a & the darker color fluid 10a to minimum. 2 is the split-flow control valve to guide the separated light color fluid 5a and darker color fluid 6a to return to their own designated reservoirs 5 & 6. 3 is the tubing that connects the protruding fluid drain outlet 1b; the split flow valve 2; the programmable pump 4; and the dual reservoir 5 and 6. The cavity of the VIP body 1 at this preconditioned stage has been pre-filled with light colour fluid 1c, refer to FIG. 2. The reservoir 5 is purposely left almost empty just to retain enough fluid in level to cover the end of the tubing 3 to maintain the consistency of the fluid that relates to creating the vacuum effect in the latter procedure. It also to give room for the light colour fluid 4 when being drawn in and mixed with the fluid in the reservoir 5 to become as fluid 5a. It is an easier procedure to initiate the “repeat at will” vacuum process at the outset. Meanwhile, the reservoir 6 is fully filled with darker fluid 6a, and readily available for its turn.

FIG. 6K shows the side and front view of the body of the un-obscured double pane glass VIP 1 and the incorporated mechanical apparatus in function. 1e illustrates the stage of the cavity of the VIP 1, in which it is pressurized and vacuumed out by withdrawing the light colour fluid 1c to become 5a; refer to FIG. 4. At this point the fluid 1c/5a has been pumped back and retained in the reservoir 5 shows that it is full. The darker fluid 6a, also remains in the reservoir 6, and readily available for its turn. The embodiment of the un-obscured double pane glass VIP 1 at this stage is in the cycle of performing the “repeat at will” pressurized vacuum condition.

FIG. 6L shows the side and front view of the body of the un-obscured double pane glass VIP 1 and the incorporated mechanical apparatus in function, Also illustrated, is the darker color fluid 6a; where it is pumped in and filled in the pressurized vacuum space of the cavity of the body of VIP 1. The reservoir 6 is purposely left almost empty just to retain enough fluid in level to cover the end of the tubing 3, to maintain the consistency of the fluid as it relates to creating the vacuum effect. It also gives room for the return of the darker colour fluid 6a which is in the cavity of the body of the VIP 1 and cycled to be pumped back into the reservoir 6. Meanwhile, the reservoir 5 is fully filled with the light colour fluid 5a, and readily available for its turn.

FIG. 6M shows the side and front view of the body of the un-obscured double pane glass VIP 1 and the mechanical apparatus is in function. As illustrated, at this stage the cavity if of the body of the VIP 1 is pressurized and vacuumed out by withdrawing the darker colour fluid 6a, which has been pumped back and retained in the reservoir 6 shows that it is full, and the light colour fluid 5a, also remains in the reservoir 5 and readily available to be used. This double pane glass VIP 1 embodiment at this stage is in “repeat at will” pressurized vacuum condition. A double pane forced fluid pressurized vacuum insulation panel VIP 1 is transformed into an unique window unit.

FIG. 6N shows the side view of the un-obscured triple pane glass VIP 7 configured to create two attached side-by-side bodies 7a & 7b separated by the middle pane glass sheet. Body 7a shows its front view with a non-vacuumed cavity 7c having a fluid drain outlet 7f, and on the other side of the middle-pane glass sheet; body 7b of the VIP 7 with a cavity 7d shows as the back view of the VIP 7. Hereby, it is important to depict that the cavity 7d of body 7b at this stage is in a pre-treated “permanent” pressurized vacuumed condition of which can be achieved by selecting various processes of prior arts available on the market place and it will be maintained as “permanent” pressurized vacuumed condition through out this continuing patent description. 7e is the nipple provided to facilitate the aforementioned prior art factory vacuum process.

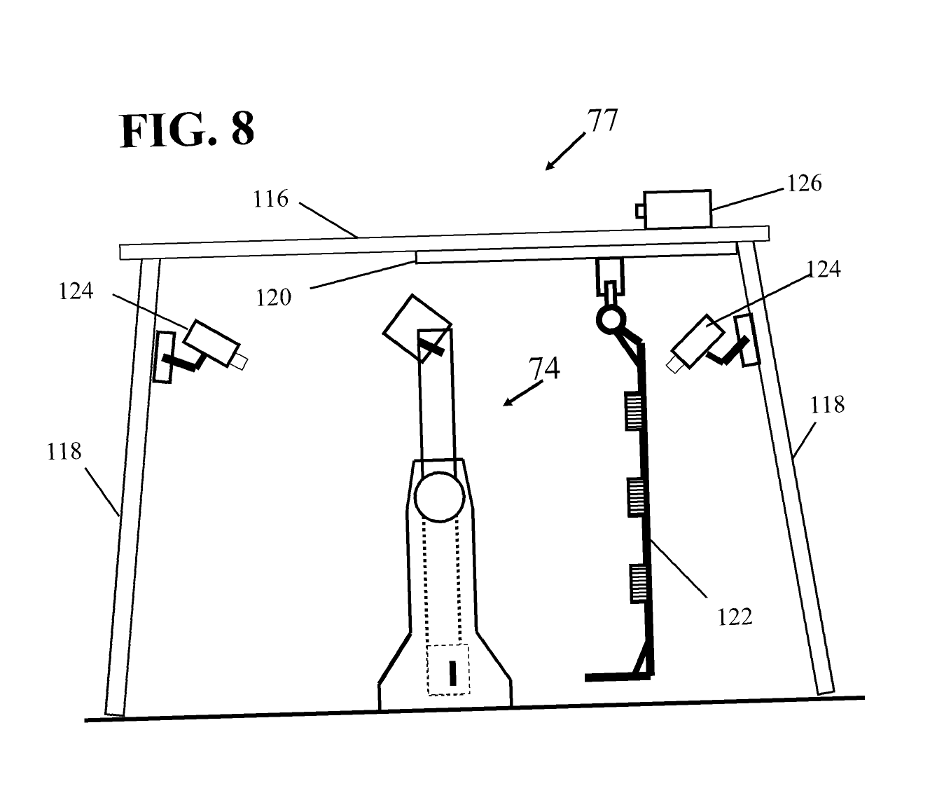

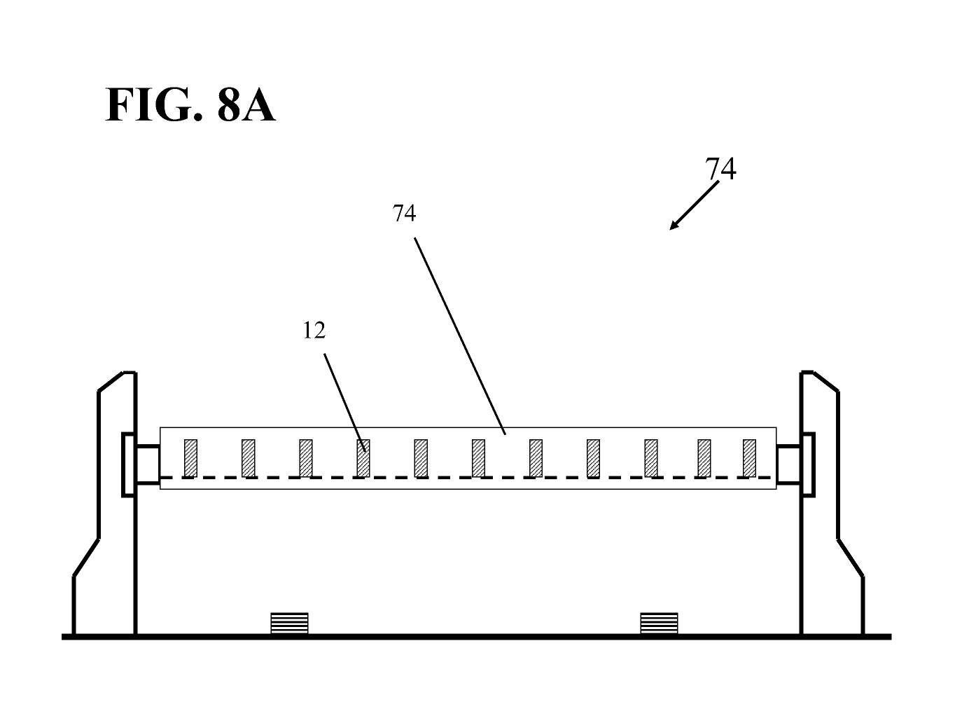

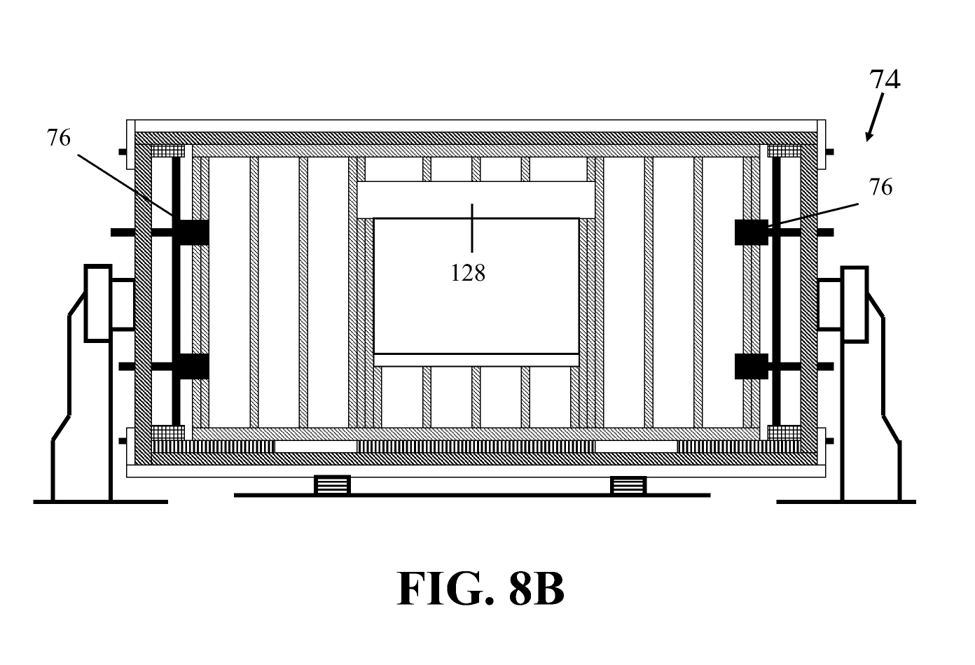

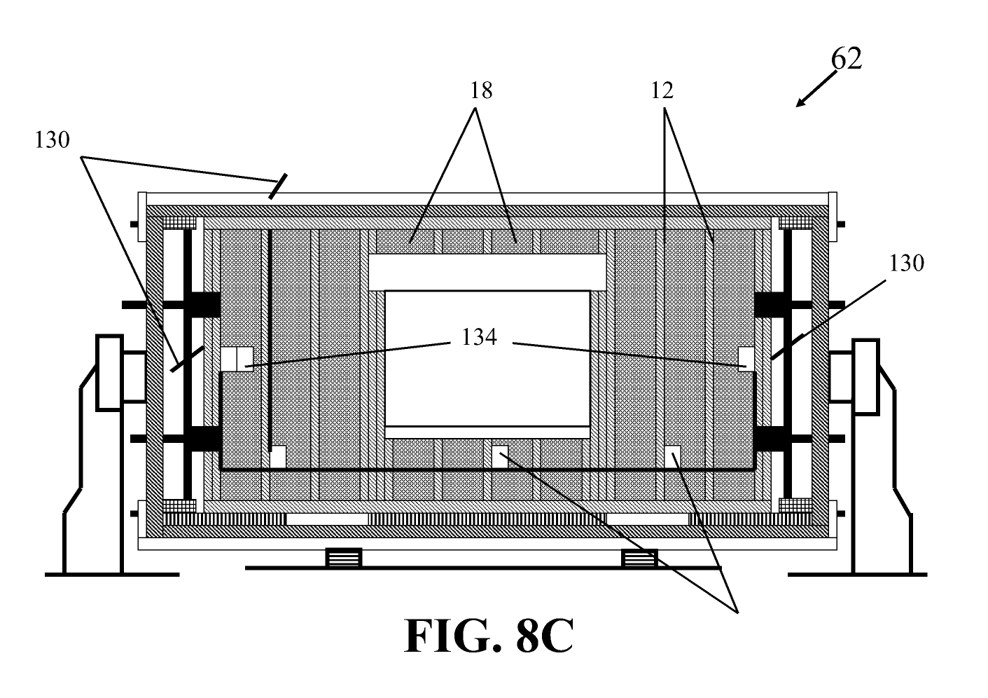

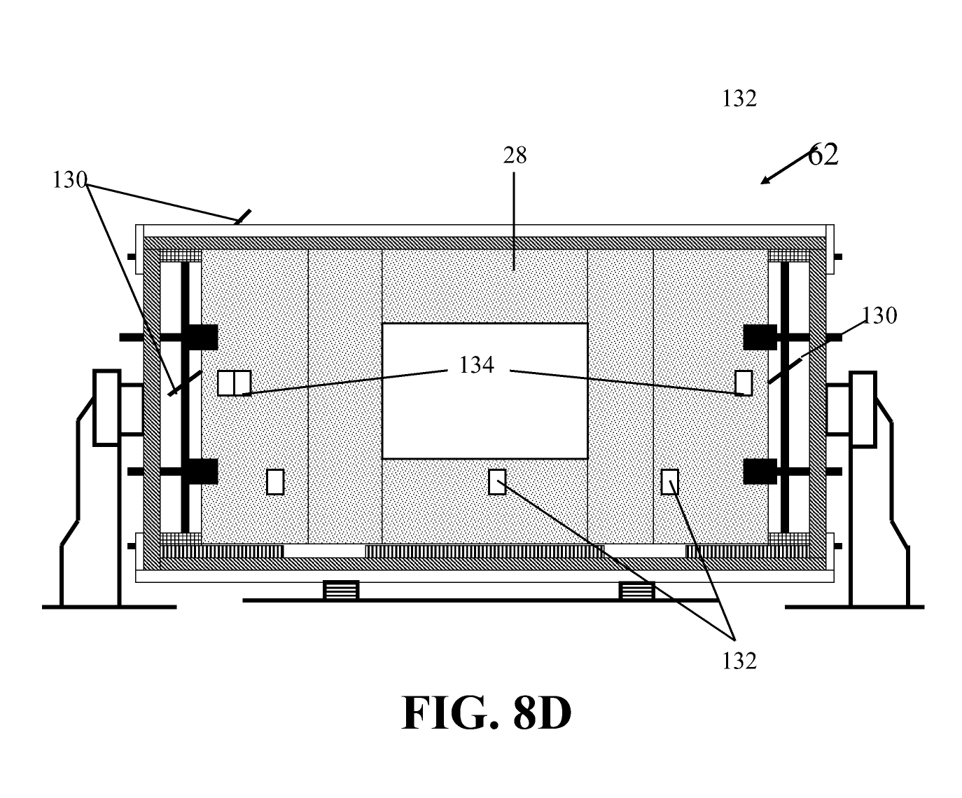

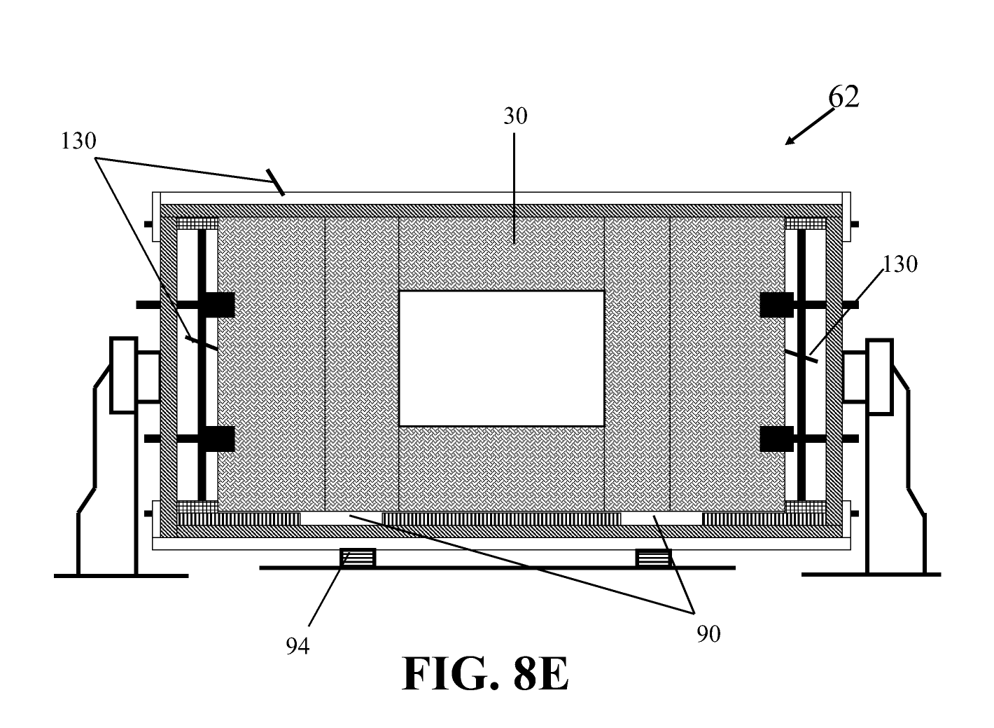

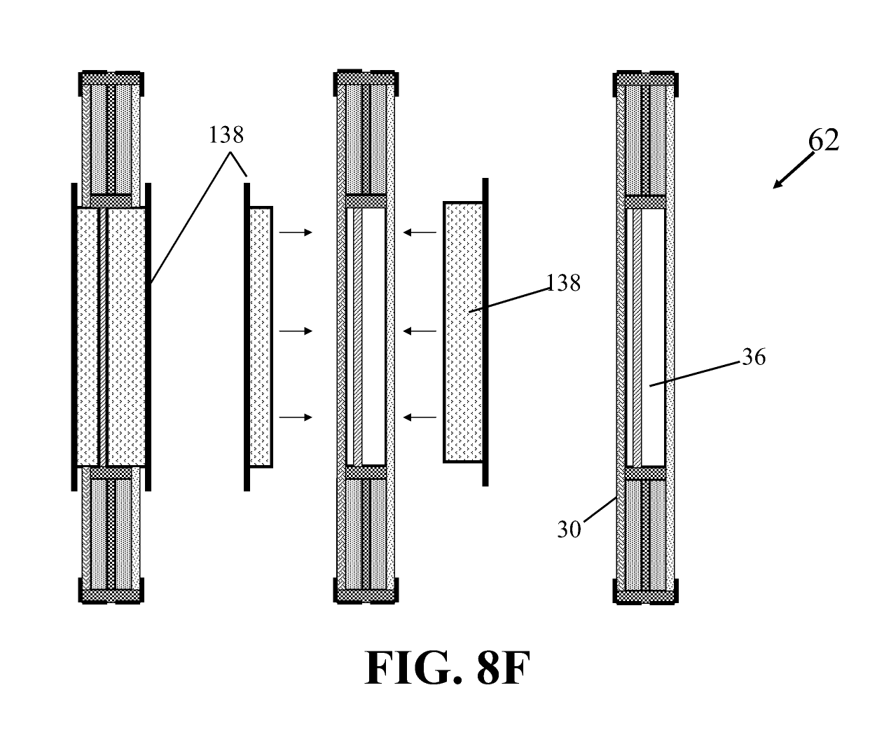

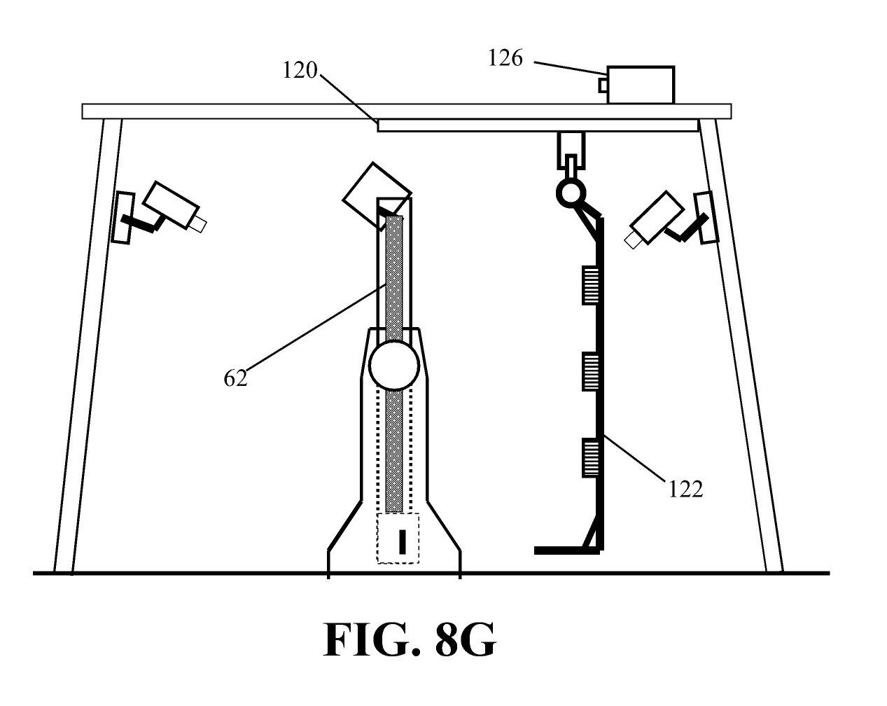

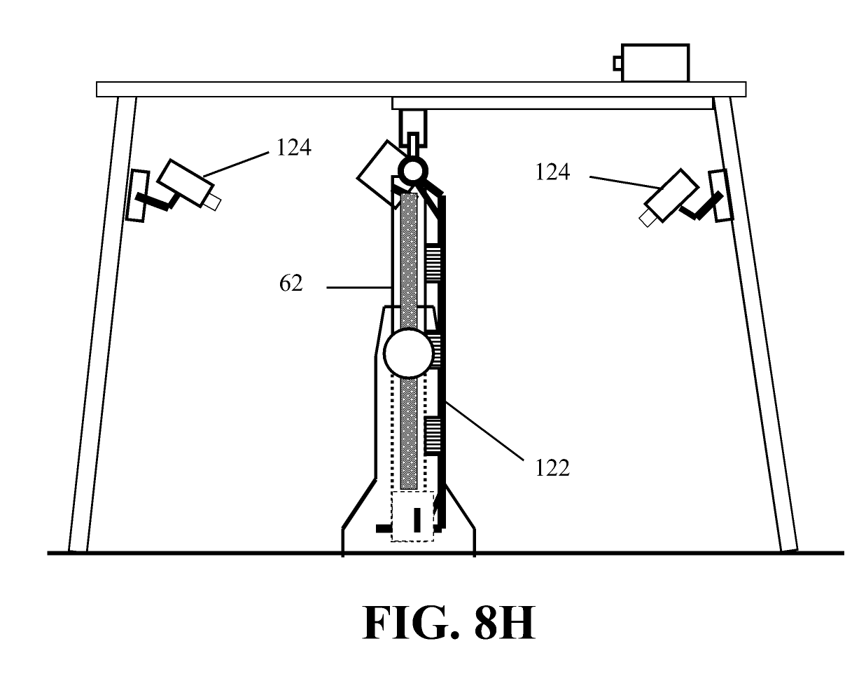

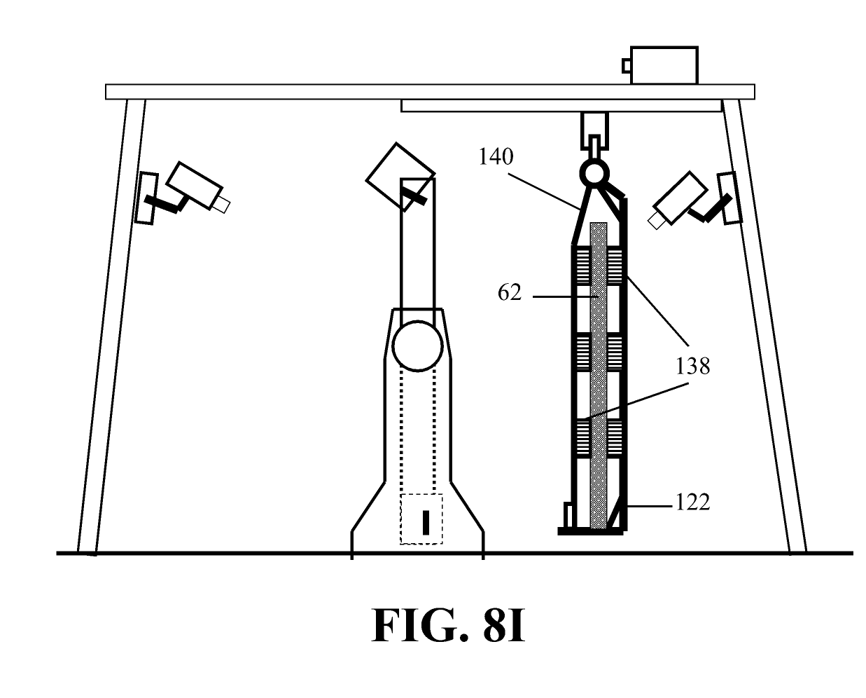

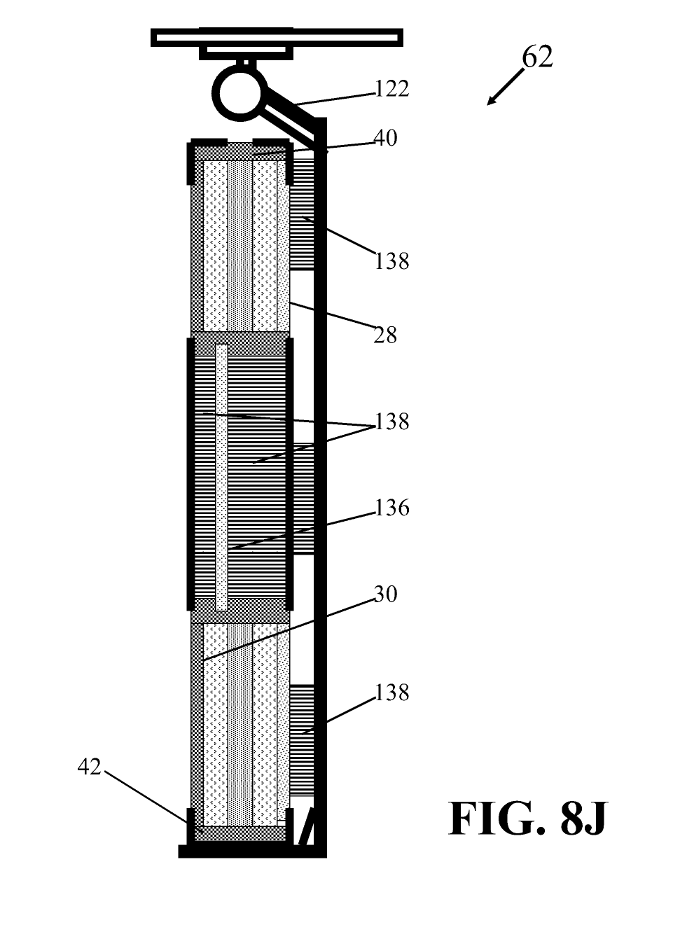

FIG. 6O shows the side view, front view & back view of the un-obscured triple pane glass VIP 7 depicts two separate attached bodies, and 7d is the cavity of the body 7b which is pre-treated and it is in its prior art process “permanent” pressurized vacuumed condition and 7e is the nipple. The space of the cavity 7c, refer to FIG. 8; of the body 7a with fluid drain outlet 7f, at this stage is prefilled with the light color fluid 5a. This “prefilled” process is to pre-condition the “repeat at will” vacuum process latter to be performed by utilizing the cavity of the body 7a to be incorporated with a programmable mechanical apparatus.

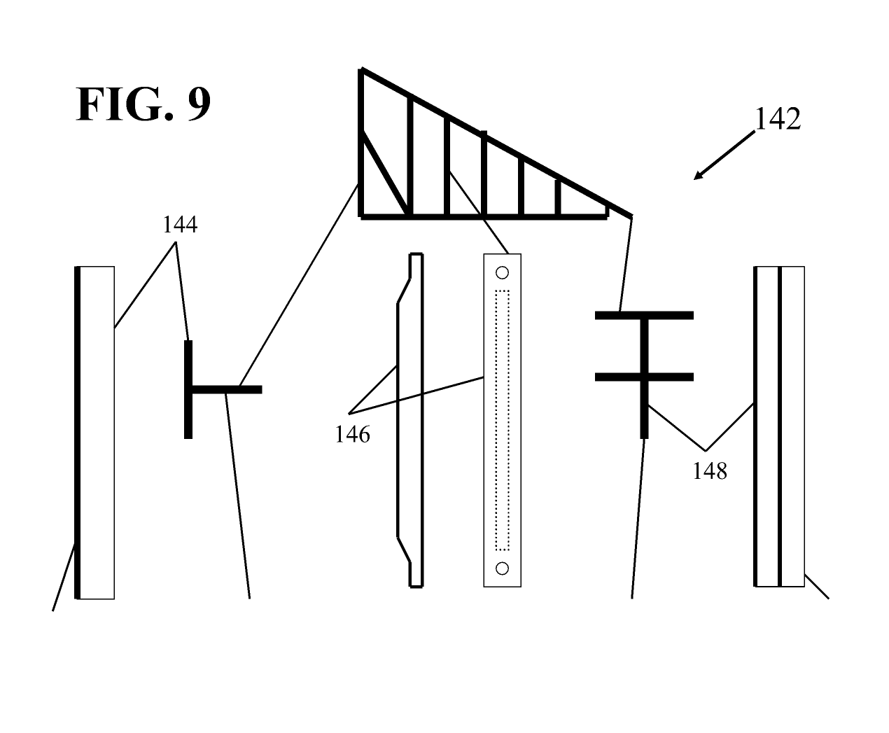

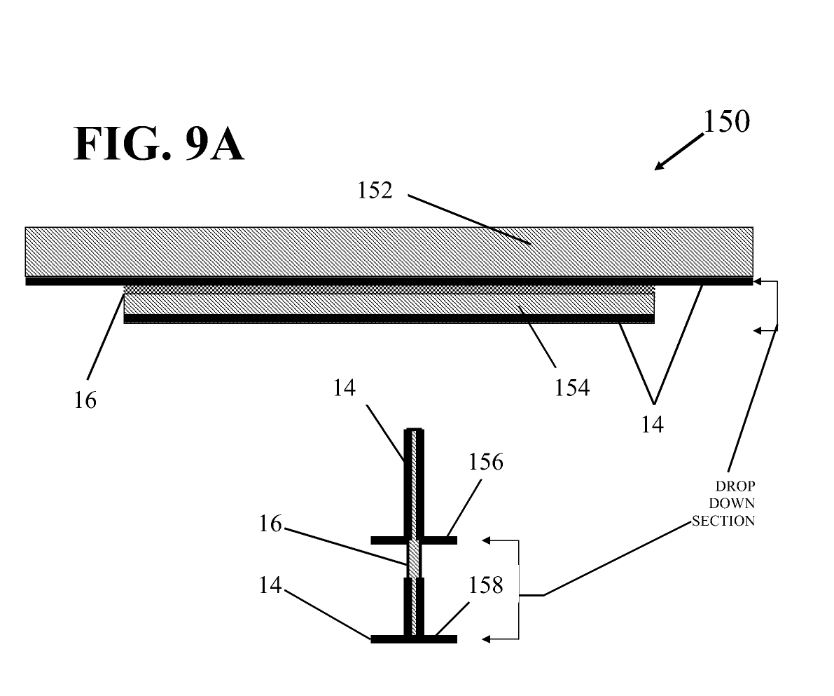

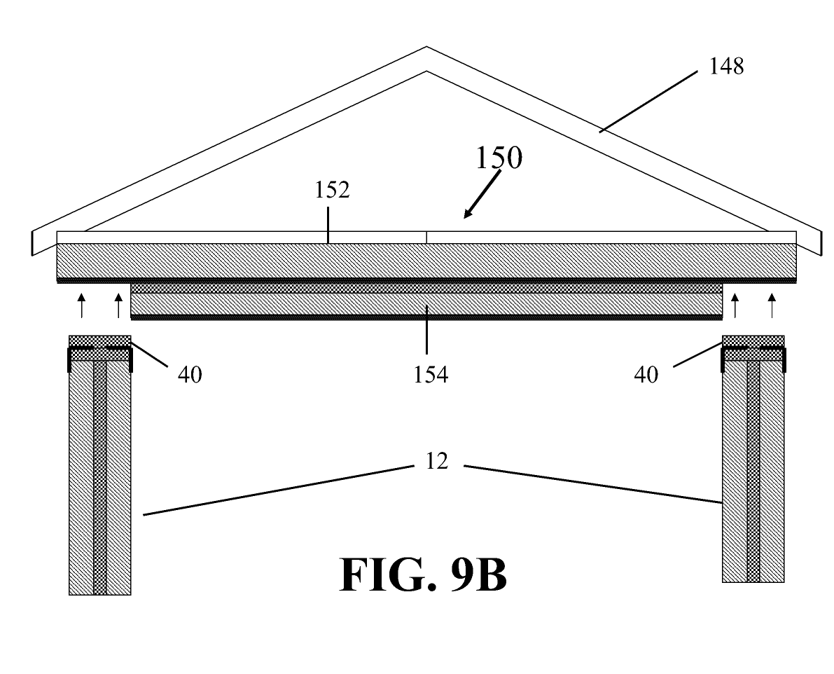

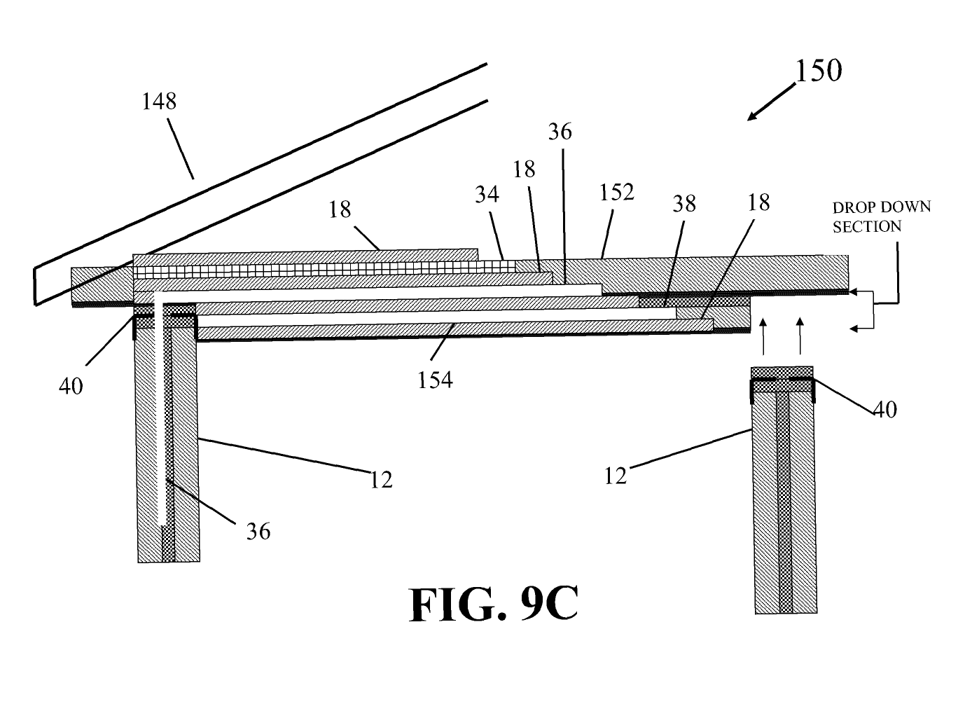

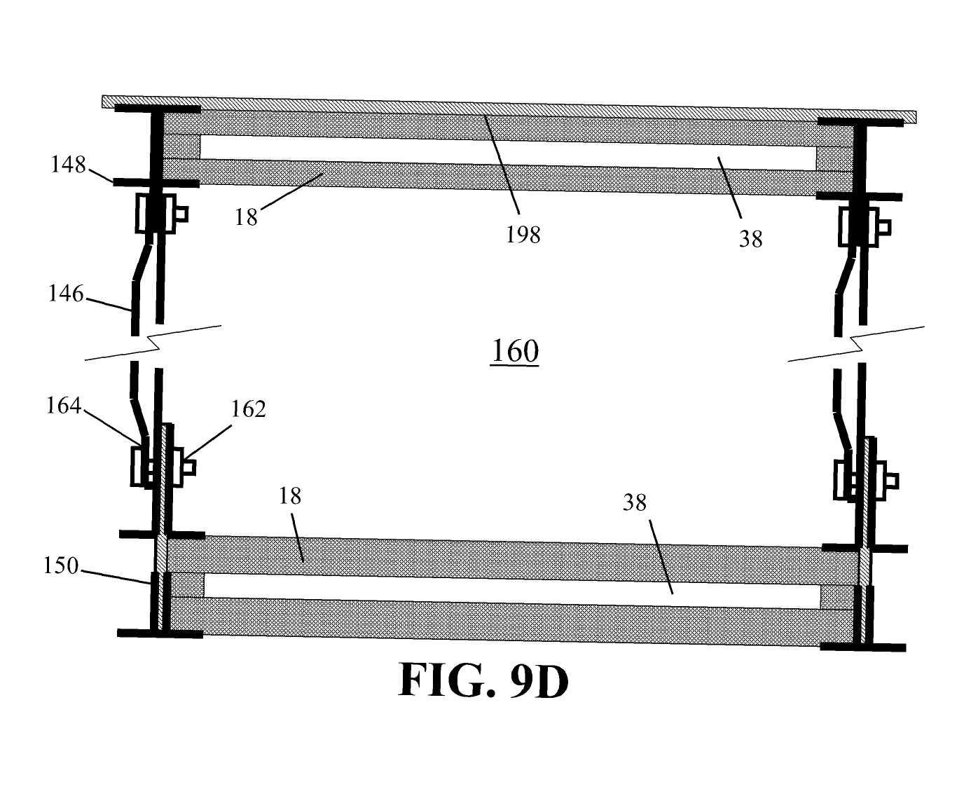

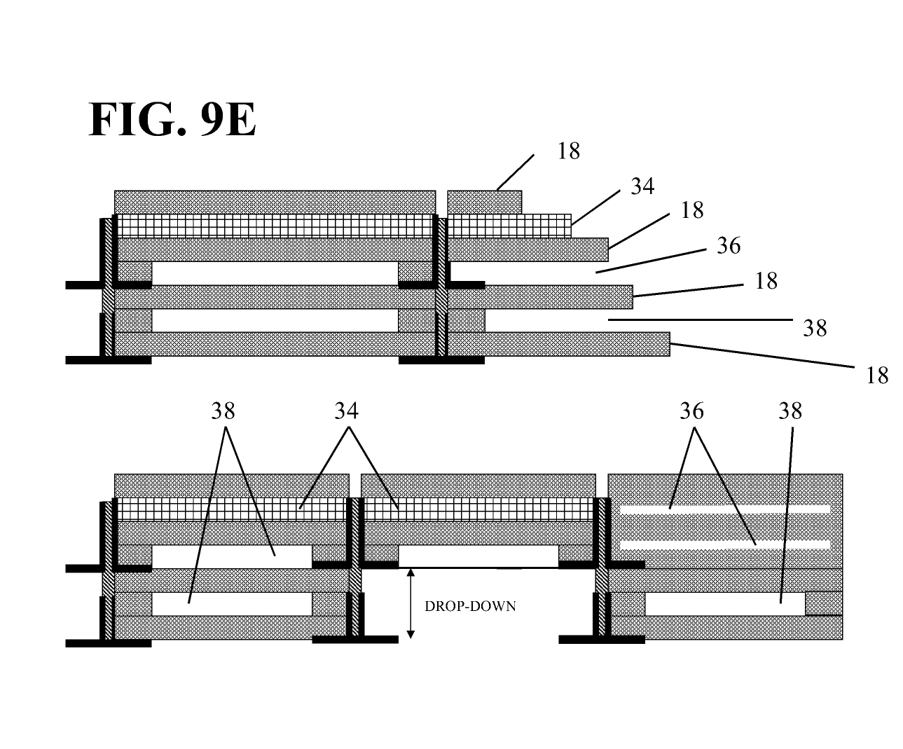

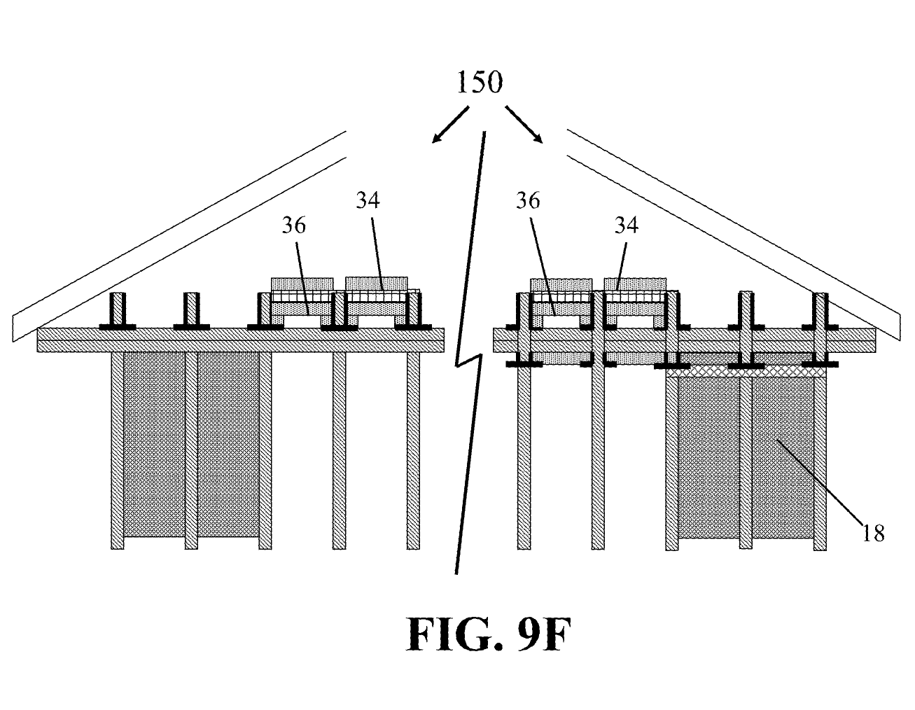

FIG. 6P shows the side view, front view & back view of the un-obscured triple pane glass VIP 7 with dual body/cavity incorporated with the mechanical apparatus; refer to FIG. 3. As illustrated, the sectional view of the mechanical apparatus comprises programmable pumping & controlling devices. 1d shows the rigid foam supporting members to be used to cushion the weight of the glass VIP body set on the frame structure. 7f is the protruding fluid drain outlet connected with the split-flow control valve 2, this connection is performed by tubing 3 which transports all fluids, the tubing 3 splits its way and connects with two programmable pumps 4. The tubing 3 then extend; one runs into the reservoir 5, which retains with the light fluid 5a and the other runs into reservoir 6 which retains the darker fluid 6a. 7d is the cavity of the body 7b, which is pre-treated in permanent pressurized vacuum condition and 7e is the nipple. The light color fluid 5a as described in FIG. 9 was used to pre-fill & precondition the cavity of body 7a; at this stage the pressurized vacuum process can begin and be achieved at anytime by withdrawing the fluid 5a back into the reservoir 5 which is not filled to its full capacity at this point in order to leave enough room for the return light color fluid 5a from the cavity of the body 7a. While the reservoir 6 filled with fluid 6a is in it's dormant mode.

FIG. 6Q shows the un-obscured triple pane glass VIP 7 with dual body/cavity incorporated with the mechanical apparatus. As illustrated, the incorporated programmable pumping and controlling devices and dual reservoir is filled with fluids. 7g a illustrates the stage of the cavity of the body 7a is in “repeat at will” pressurized vacuumed condition by the effect of withdrawing the light colour fluid 5a, which is pumped back and retained in the reservoir 5 shows that it is full, and the darker colour fluid 6a also remains in the reservoir 6, while the pre-treated “permanent” pressurized vacuumed cavity 7d of body 7b remain in tact. A double pressurized vacuum insulation panel VIP 7 is created within one triple pane glass body.

FIG. 6R shows the un-obscure triple pane glass VIP 7 with dual body/cavity incorporated with the mechanical apparatus. The darker color fluid 6a, is being pumped in, and fills the “repeat at will” pressurized vacuumed cavity of body 7a. The reservoir 6 is purposely left almost empty just to retain enough fluid in level to cover the end of the tube 3 to maintain the consistency of the fluid, which relates to creating the repeat vacuum effect and also to give room for the return of the darker colour fluid 6a from the cavity of body 7a. Meanwhile, the reservoir 5 is fully filled with light colour fluid 5a, it is readily available for its turn, while the pre-treated “permanent” pressurized vacuumed cavity 7d of body 7b remains in tact.

FIG. 6S shows the un-obscured triple pane glass VIP 13 with dual body/cavity incorporated with the mechanical apparatus. As illustrated, connected programmable pumping and controlling devices, and the dual reservoir is filled with fluids. 15a illustrates the stage of the cavity of the body 13a is in “repeat at will” pressurized vacuumed condition by withdrawing the darker colour fluid 10a, at this point the fluid 10a is being pumped back and retained in the reservoir 10, and shown that it is full. The light colour fluid 9a also remains in the reservoir 9 in full. The dual body/cavity of the triple pane VIP 13 at this stage are both in pressurized vacuumed condition. One is “permanent” vacuumed condition & the other is functioning as “repeat at will” vacuumed condition. A double pressurized vacuum insulation panel VIP 13 is created within one triple pane glass body and transformed into an unique window unit.

FIG. 6T depicts the triple pane glass VIP 7 that is incorporated with the mechanical apparatus and the thermal apparatus as it becomes one window system. 8 illustrates the heat or cold thermal exchanger depending on climate condition, 8a is the thermal transfer line for fluid 6a and 8b is the thermal transfer line for fluid 5a.

FIG. 6U shows the side & front view a double pane glass VIP 9 to be implemented as an insulation member for doors; 9a is the pre-treated vacuum cavity and 9b is the opening for door knock. This double pane glass door VIP 9 is to be inserted in the exist metal door frame to become an efficient insulation member which is one of the weakest point in terms of negative thermal transfer.

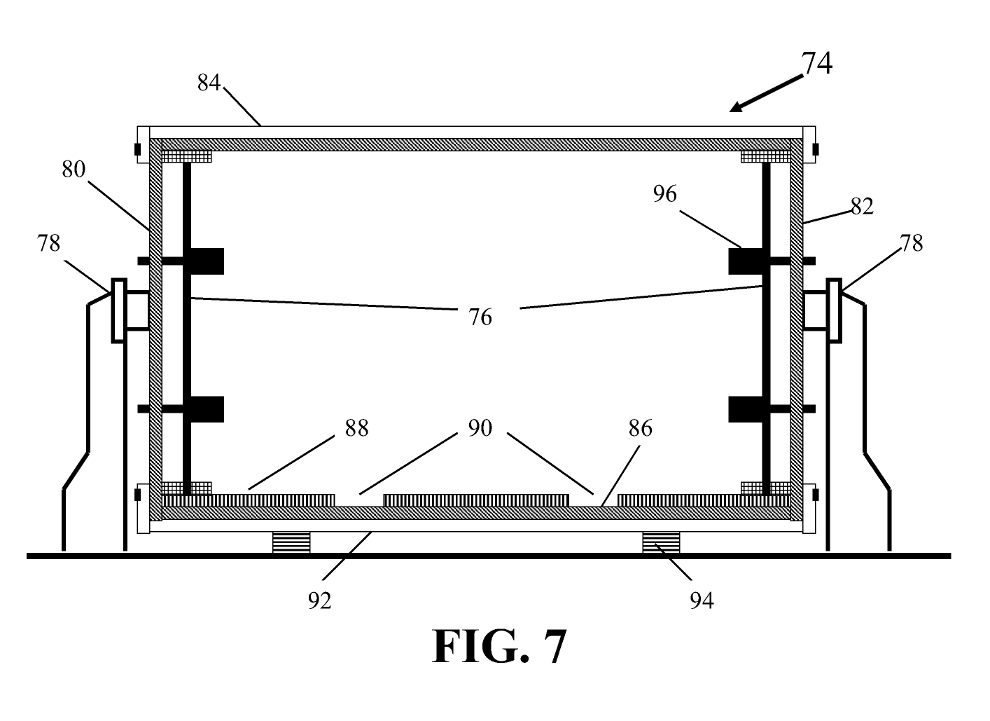

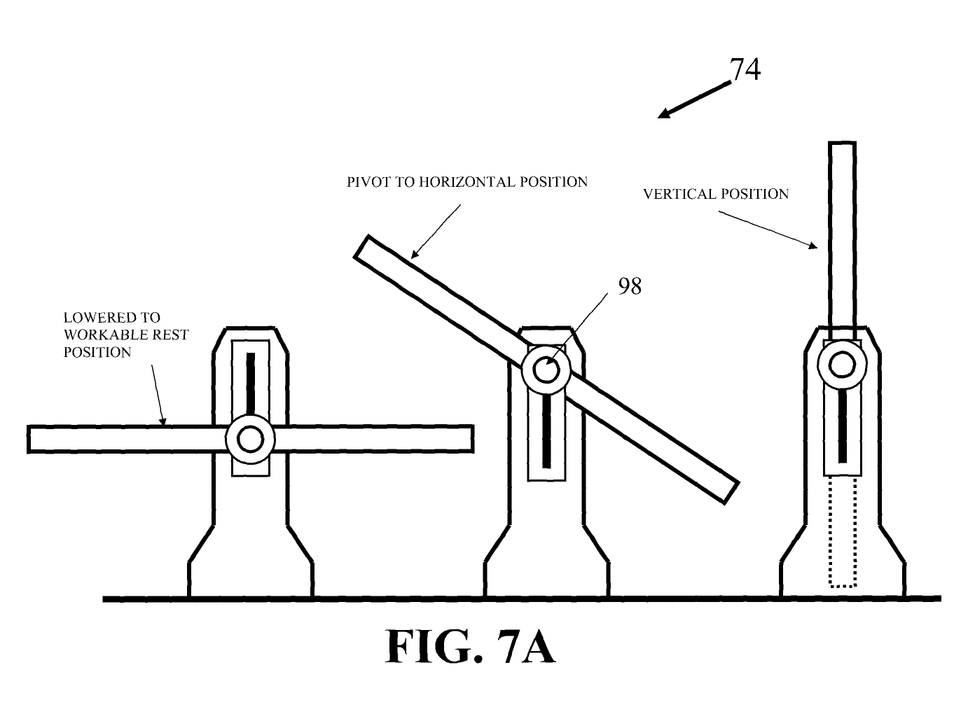

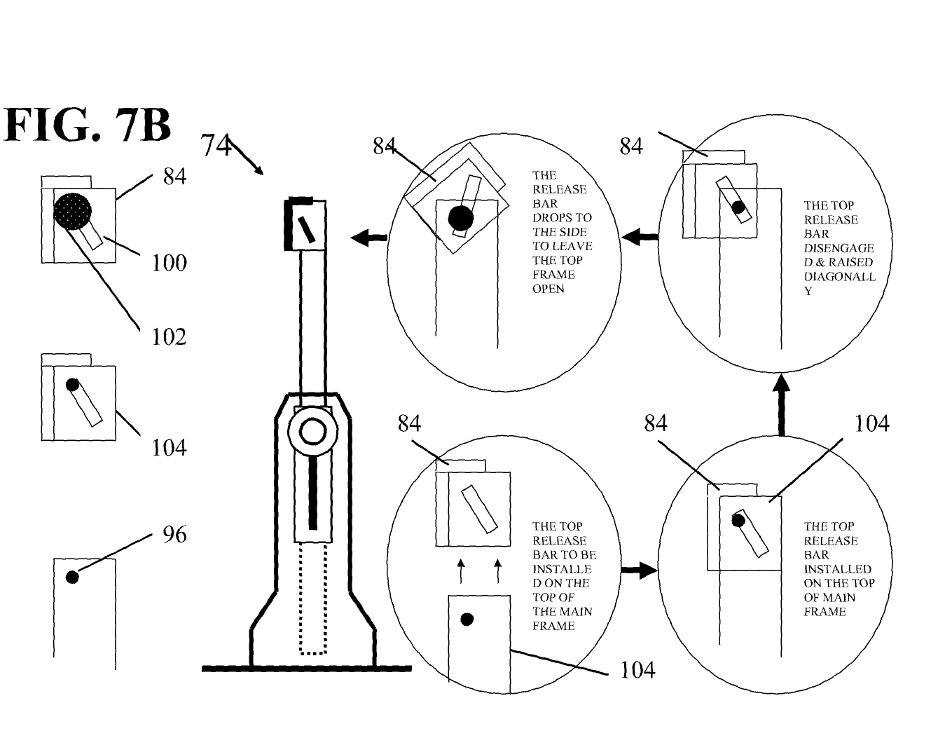

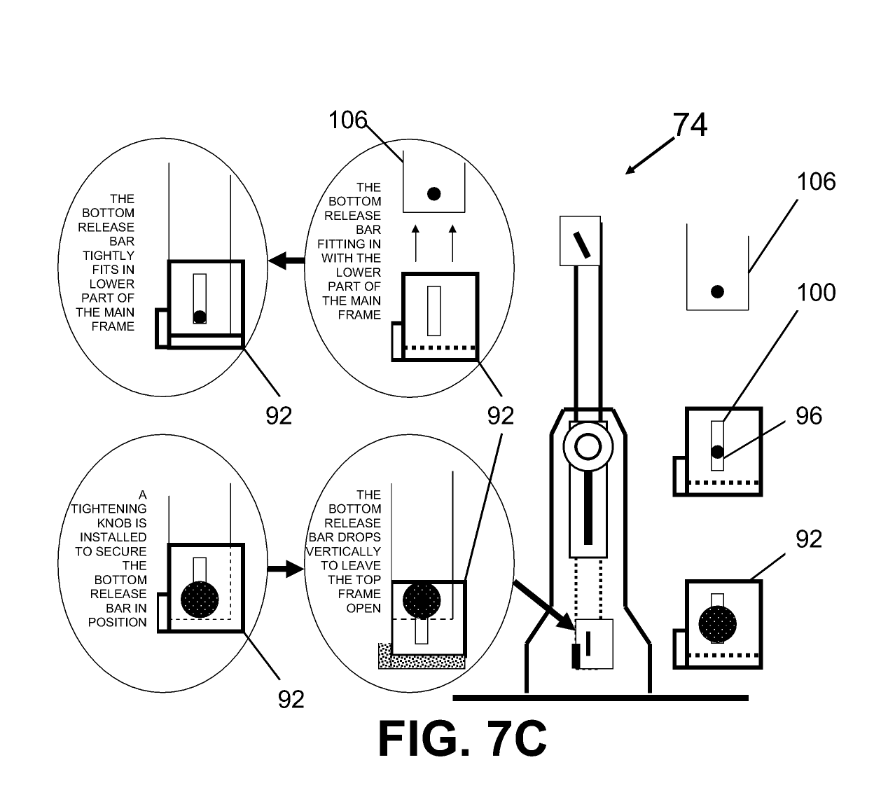

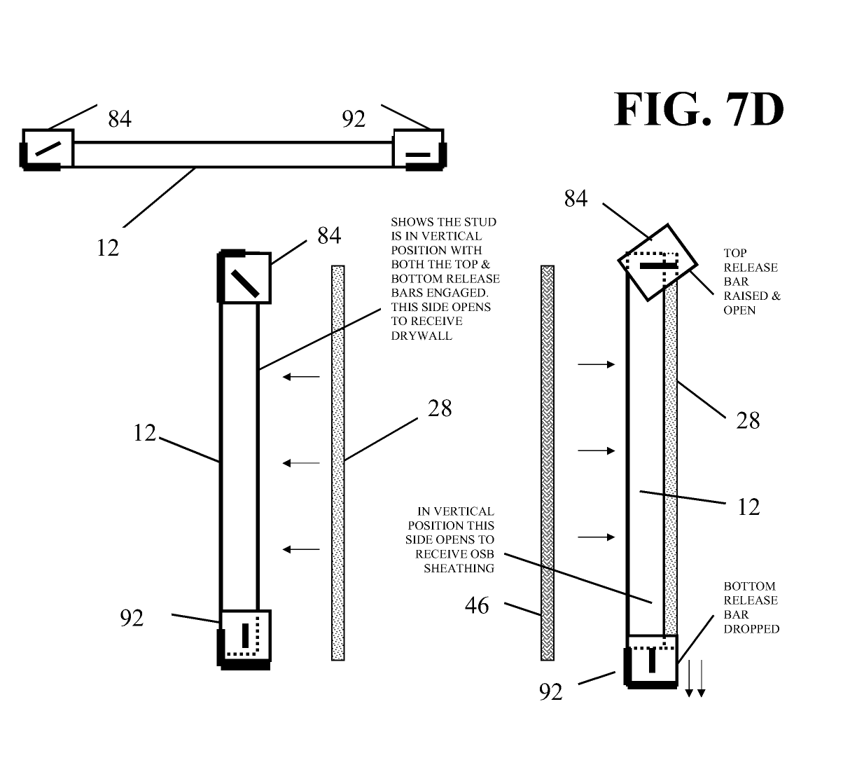

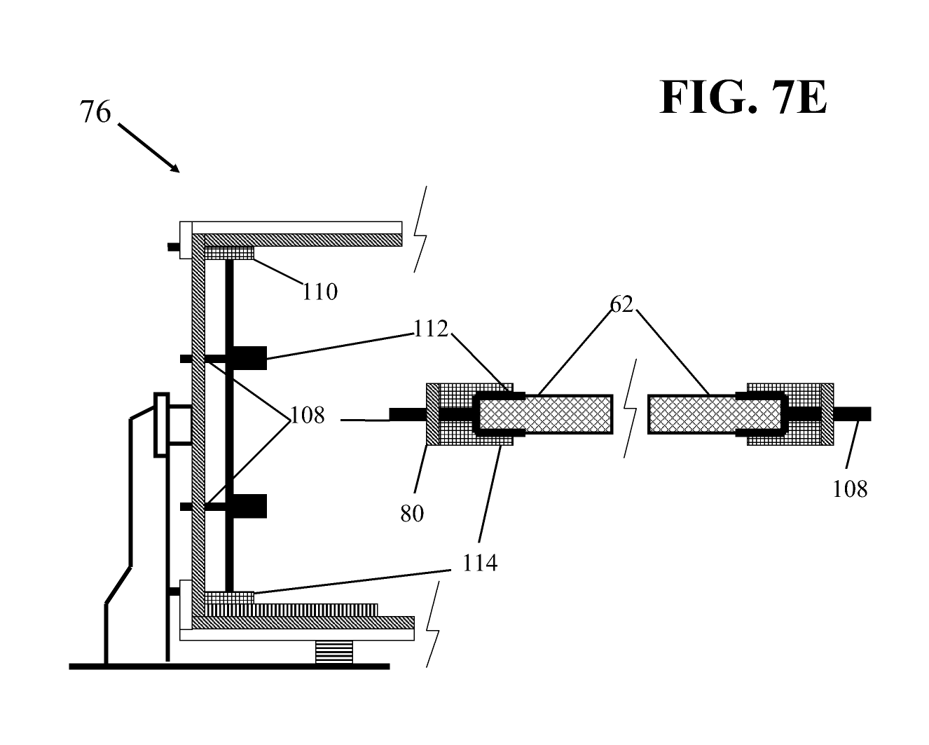

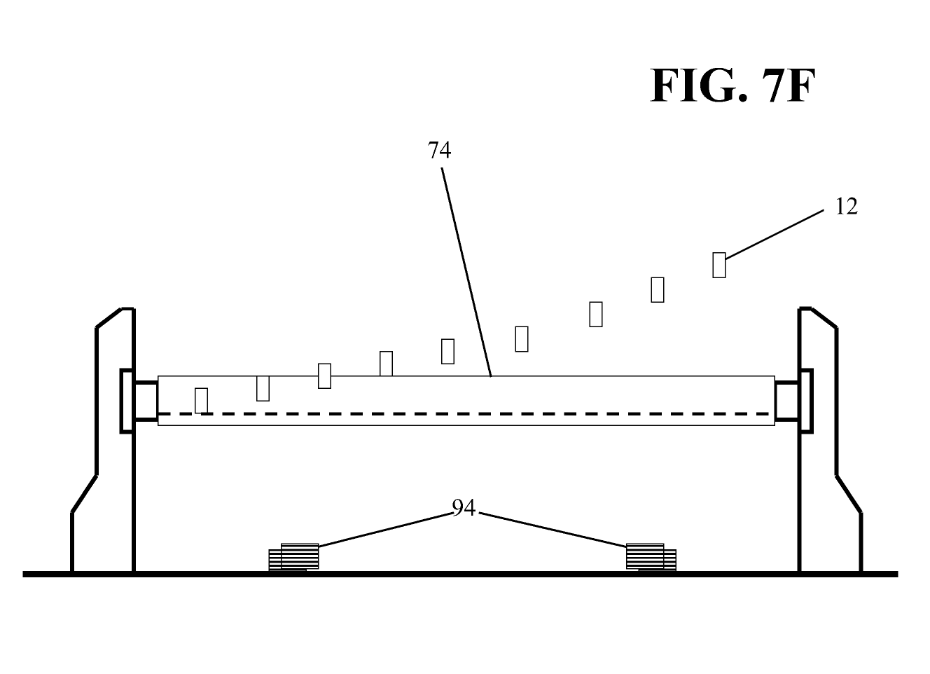

FIG. 7 is a side view of the present invention. Shown is a side view of the master work frame equipment assembly 74 having a vertical wall supporting member (VWSM) 76 on each side. Several huge aluminum (MWF) master work frames 74 (sizes can be flexible according to local market requirements) to be installed and created permanently on the floor for assembling the exterior walls and interior walls. These AMWF 74 are built for flexibility to station and work around easily, the motorized mechanisms 78 allows it to pivot in vertical, horizontal and upward and downward positions at ease controlled by an electrical remote device. At first the MWF 74 lays in horizontal level to receive the top and bottom sill plates and all studs to be laid flat (horizontal as well) on the MWF 74 and be spaced 16″ or 24″ o.c., then it will be adjusted at a workable waist level to allow workers to work on both sides of the wall at the same time, to fasten and install all the top and bottom sill plates, windows and door headers and spaced studs all in place according to specifications. The MWF 74 further comprises a first frame side 80, a second frame side 82, a top release bar 84, a frame bottom plate 86, a timber plate 88, an opening for conveying fork lifts 90, a bottom release bar 92, station bolts 96 and weight supports 94.

FIG. 7A is side-view of the present invention. The MWF 74 is shown rotating from the vertical position to the horizontal position. Also shown is the up and down elevating mechanism 98.

FIG. 7B is side-view of the present invention. Shown is the relationship between the MWF 74 and the top release bar 84 disposed on the top portion 104 thereof showing a side view of the top release bar 84, the station bolt guide track 100 and tightening knob 102 screwed onto the station bolt 96.

FIG. 7C is side-view of the MWF 74 of the present invention. Shown is a side view further explaining the bottom release bar 92 and its relationship with the bottom portion of the main frame 106, the station bolt 96 and its guiding track 100.

FIG. 7D is side-view of the present invention. The horizontal depiction of the stud 12 shows the ends thereof seated in their respective top 84 and bottom 92 release bars. This arrangement allows all studs 12 to be positioned horizontally at a workable level. The release bars also provide support for the assembling process. The vertical depictions demonstrate the relationship of the stud 12 with the top 84 and bottom 92 release bars during installation of drywall 28 and OSB exterior wall sheathing 46 during the installation process.

FIG. 7E is a sectional view of the vertical wall supporting member (VWSM) 76 mounted on one side of the main wall assembling frame, one end of the (VWSM) 76 is mounted to the body of the first frame side 80. Shown cut off top view of both ends of the VWSM 76 mounted on the main frame holds the wall assembly 62 in upright position while the top and bottom release bars are disengaged through assembling process. The VWSM 76 of both ends are adjustable moves horizontally with the guiding rods 108 according to sizes of wall specifications. Also shown are the top mounting member 110, the metal member 112 to hold the wall and the base members 114.

FIG. 7F is a side view of the master work wall frame equipment assembly 74. The master work frame 74 is in horizontal position and is lowered to workable level. The studs 12 are to be placed within the frame 74 and to be fastened in place on specification.

FIG. 8 is a side view of the composite wall frame equipment assembly 77 that has two primary functions: conveying and transporting the finished structure to storage and providing a monitoring system posting live video clips of the production process which allows the buyer to view the process live on-line with a password. Shown is a horizontal track support 116 supported by a leg 118 extending from each end thereof. A motorized track 120 is disposed on the underside of said track support 116 along which a conveying fork 122 travels. A video camera 124 is disposed on the interior portion of each leg 118 and oriented towards its respective work area at the vertical wall assembly member 74 to deliver live streaming video to an internet server. An electric motor 126 drives the conveyor fork 122 back and forth along the track 120.

FIG. 8A is a side view of the master work wall frame equipment assembly 74 with studs 12 laid in place. The master work frame 74 is in horizontal position and is lowered to a comfortable workable level. All plates, headers and studs 12 are to be assembled to form the skeleton of the composite insulated wall frame.

FIG. 8B is a vertical side view of the wall frame production assembly. Shown is the master work frame 74 secured in the upright position the vertical wall support members 76. A wall skeleton with window opening is assembled with a window header beam 128, ready to receive other parts and components such as; insulation members, window components, electrical wiring and boxes, etc. Are all to be installed in place strictly according to specification on the blueprint. There are two sets of blue prints of the same wall reflecting both sides perspective.

FIG. 8C is a vertical side view of the wall frame production assembly 62. Shown is the vertical side view of the insulation components 18 filled between studs 12. Electrical wiring 130, receptacle boxes 132 and light switches 134 are installed.

FIG. 8D is a vertical side view of the wall frame production assembly 62. Shown is the vertical view of the interior side of the finished composite wall with drywall 28 installed, window installed, exposing all electrical boxes 130 and switches 134, wirings 130 for connection.

FIG. 8E is a vertical exterior side view of the finished composite wall 62. Shown is an exterior view of the finished composite wall 62 with OSB exterior wall sheathing 46 installed, exposing electrical wiring 130 for connections. The completed composite wall 62 is ready to be moved away from the master work frame wall assembly by inserting the conveying fork blades into the blade openings 90.

FIG. 8F shows the protective finishing process. Shown is a cut off view of the finished composite wall 62 with window 36 installed. Two protective foam pads 138 sandwich the window frame. OCB exterior wall sheathing 46 also provides a backing for the foam pads 138. Provides protection for transportation and installation on sites.

FIG. 8G is a view of the wall frame production assembly. The composite wall 62 is completed and is ready to be removed from within the frame work. The conveying fork 122 is driven along the conveying track 120 by the electric motor 126 to remove the wall 62.

FIG. 8H is a view of the wall frame production assembly. Shown is the conveying fork 122 engaged to transfer the completed wall assembly 62. As previously mentioned, the cameras 124 are monitoring the entire process.

FIG. 8I shows the conveying fork 122 retrieving the composite wall 62 with safety strap 140 in place. The window is protected by the foam protection pads 138.

FIG. 8J is a sectional view of wall 62 and master frame work. Shown is a clear sectional view of the compositions within the wall 62 and the completed composite wall has been retrieved from the master work frame by the conveying fork 122. Shown are the top sill plate 40, the rigid foam protective pads 138, the window 136, the OSB sheathing 136, the drywall 28 and the bottom sill plate 42.

FIG. 9 shows the roof truss 142 galvanized steel members comprising a center supporting member 144, a web supporting member 146 and a rafter beam 148.

FIG. 9A is a sectional view of the drop down ceiling joist 150 having an extended upper main joist section 152 and lower drop down joist section 154 with ends that terminate prior to the ends of the main joist section 152 thereby defining extensions at the ends of the main joist section 152 which has galvanized steel 14 flanges 156 projecting perpendicularly from the bottom thereof that are to be seated on the top sill upon construction of the structure. The drop down section 154 further includes a drop down flange 158 on its bottom portion thereby defining a space between the two flanges for the inclusion of rigid foam cavity members. An OSB strip 16 forms the core of the joist 150 to short circuit the thermal transfer from metal to metal and provide support for the payload of the “drop down” on which the insulation member and the ceiling drywall are placed.

FIG. 9B is an applying example of the drop down ceiling joist 150. Shown is the main joist section 152 on top plates 40 and the drop down section 154 of the joist rests on top and between the composite vertical supporting members (studs) 12 and supports the rafter beam 148.

FIG. 9C is an applying example of the ceiling joist 150. Shown is the main joist section 152 on top plates 40 and the drop down section 154 of the joist rests on top and between the composite vertical supporting members (studs) 12 and supports the rafter beam 148. The independent active thermal cavity 36 and inactive cavity 38 are shown as well as the VIP 34 and rigid foam insulation 18.

FIG. 9D is an applying example of the ceiling joist 150 relative to the attic space 160. Shown is a sectional view of rigid foam member 18 with an inactive cavity 38 installed into the slot between roof rafters 148. The drop down section of the ceiling joists 150 receive rigid foam insulation member 18 with an inactive cavity 38 set in between the slots. The heavier weight glass VIP 34 rests on the metal flanges of the joist 150, and the web support member 142 connected and bolted the roof rafters 148 and the joist 150 as one piece with nut 162 and bolt 164.

FIG. 9E is a sectional view of multiple insulation patterns applied with the ceiling joist 150. Shown are sectional views of multiple insulation patterns of rigid foam insulation 18 and glass VIP 34 forming an independent active thermal cavities 36 and inactive cavities 38 which can be applied due to the interact benefit of the configuration of the drop down section of the joists 150.

FIG. 9F is an applying example of the wall frame and ceiling joist 150. Shown is a broader scope of relationships between the drop down section of the ceiling joists 150, rafter beams 148, glass VIP 34, rigid foam members 18, independent active thermal cavities 36 and inactive cavities 38.

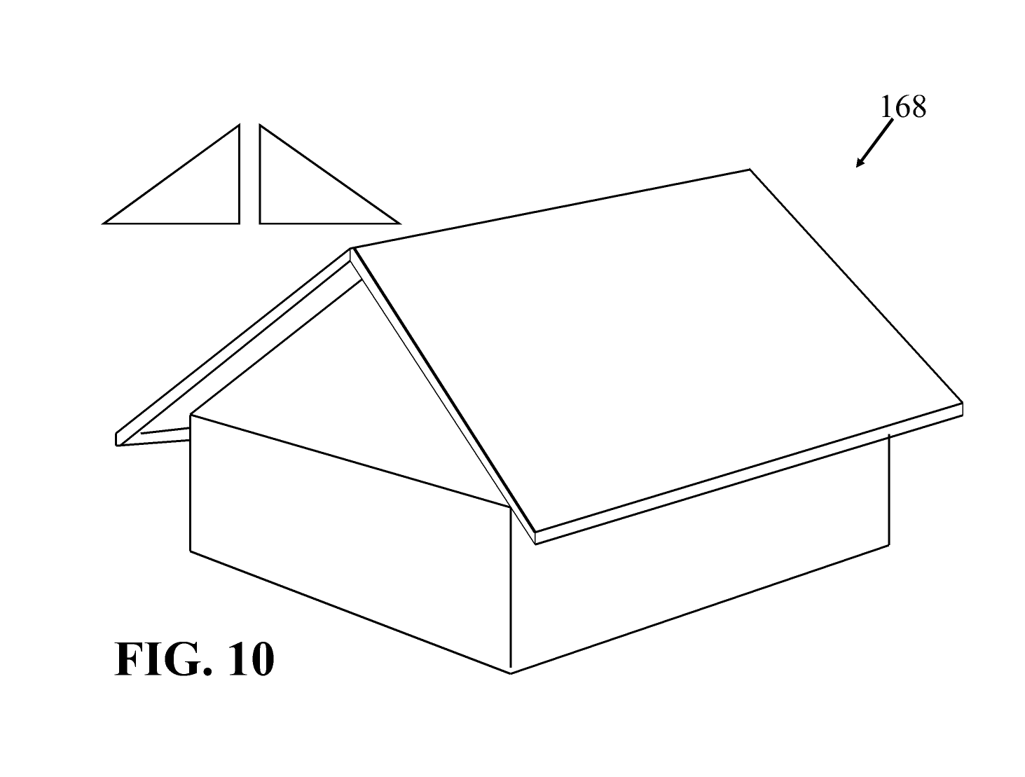

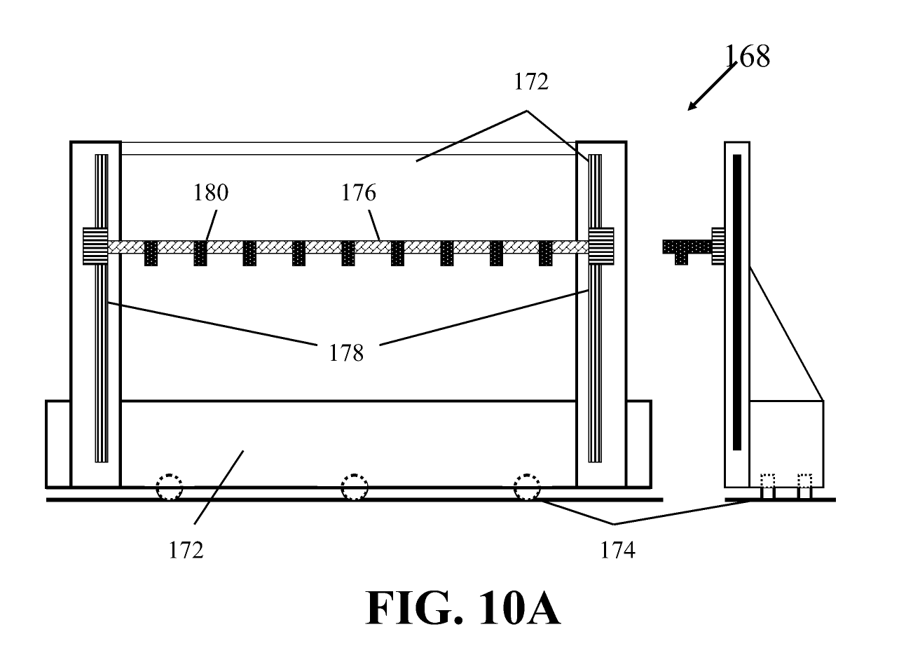

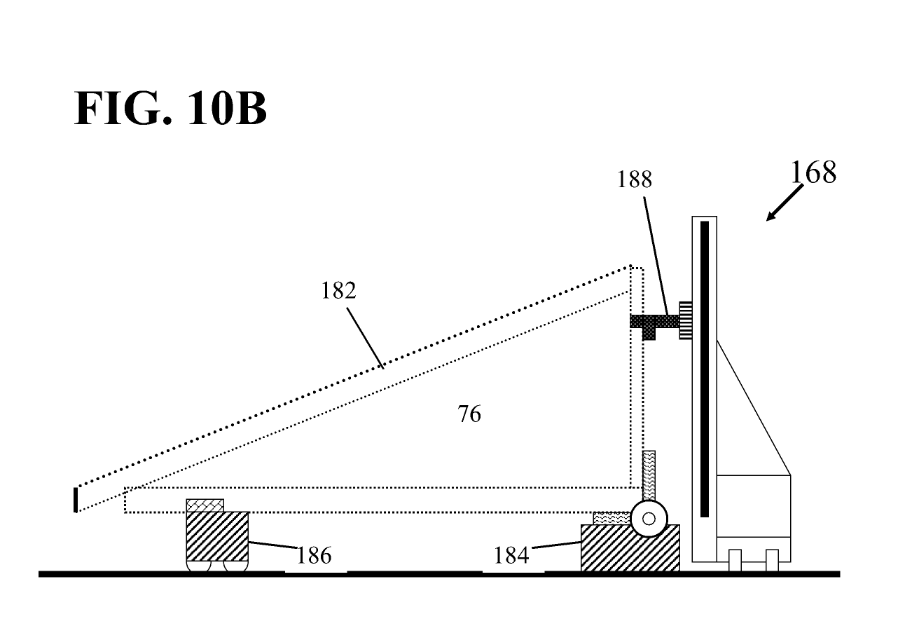

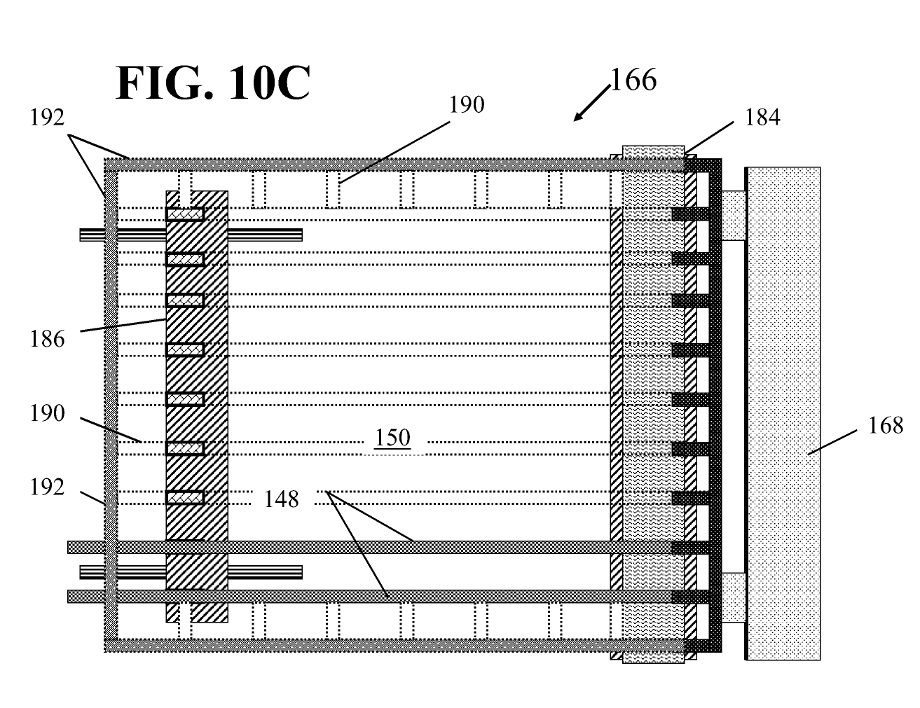

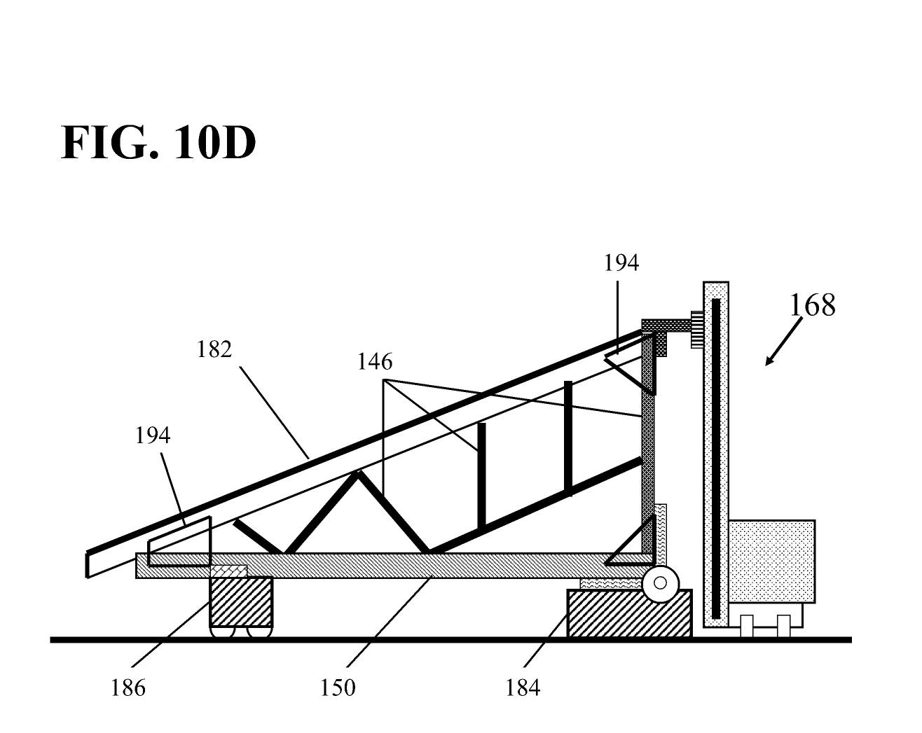

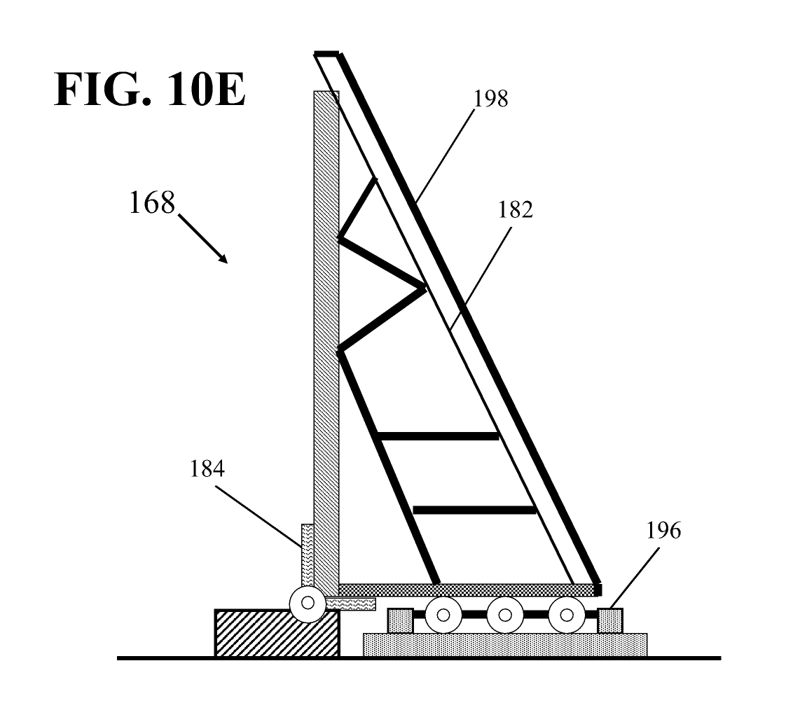

FIG. 10 shows the half and half gable roof 166 prefab assembly. The gable shape roof 166 can be divided into 2 parts by splitting it in the middle for the purpose of delivering and installation.

FIG. 10A is a front and side view of the equipment for the gable roof truss assembly mobile truss anchor station 168 comprising station body structures 172, an elevating mechanism 178 having adjustable heights for various roof pitches, an anchor bar 176 with spacers 180 to adjust O.C. specifications for rafter beams to be attached on and wheels 174 on a track.

FIG. 10B is a side view of the equipment for the gable roof truss assembly mobile truss anchor station 168. Shown is a side view of the relationships of mobile truss anchor station 168 and anchor mechanism 188, ceiling frame support “A” 184 and “B” 186. Dotted lines illustrate half of the truss frame 182 rests on position.

FIG. 10C is a top applying example view of the equipment for the gable roof truss assembly mobile truss anchor station. Shows top view of half gable roof truss assembly 166, mobile truss anchor station 168. Ceiling frame support “A” 184 and “B” 186. Rafter beams 148, bracing members 190, side plates 192 and ceiling joists 150 installed. Shown, a top view of rafter beams 148 attached on anchor bar, dotted lines illustrate ceiling joists 150 are placed directly on same positions underneath the rafter beams 148.

FIG. 10D is a side view of the equipment for the gable roof truss assembly mobile truss anchor station 168. Shown are the half gable roof truss assembly 182 mobile truss anchor station 168 ceiling frame support “A” 184 and “B” 186 after beams, bracing web members 146, side plates and ceiling joists 150 installed and secured with fastening brackets 194.

FIG. 10E is a side view of the completed half gable roof 182 with the roof sheathing and shingles 198 installed. The mobile anchor station 168 has been removed and make room for this flipped over position. This half gable roof 182 is ready to be conveyed away. By means of overhead conveying device 196 or hydraulic crane.

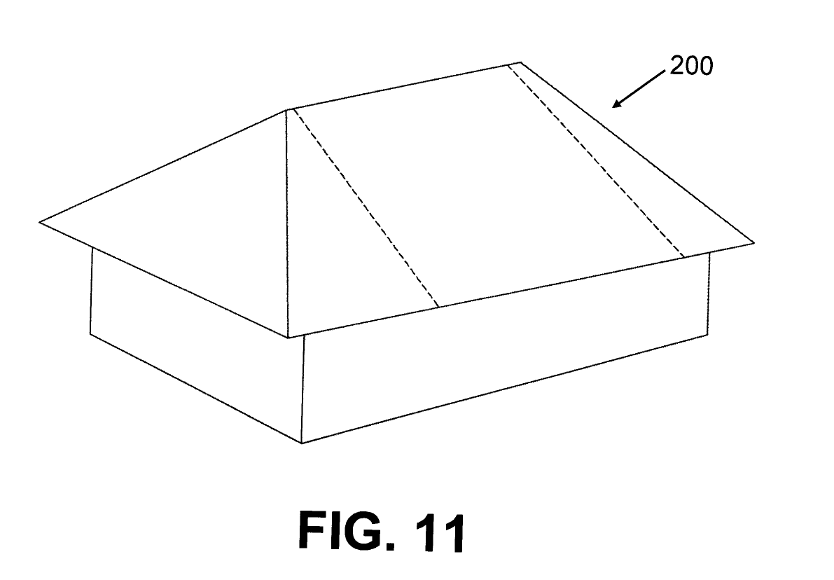

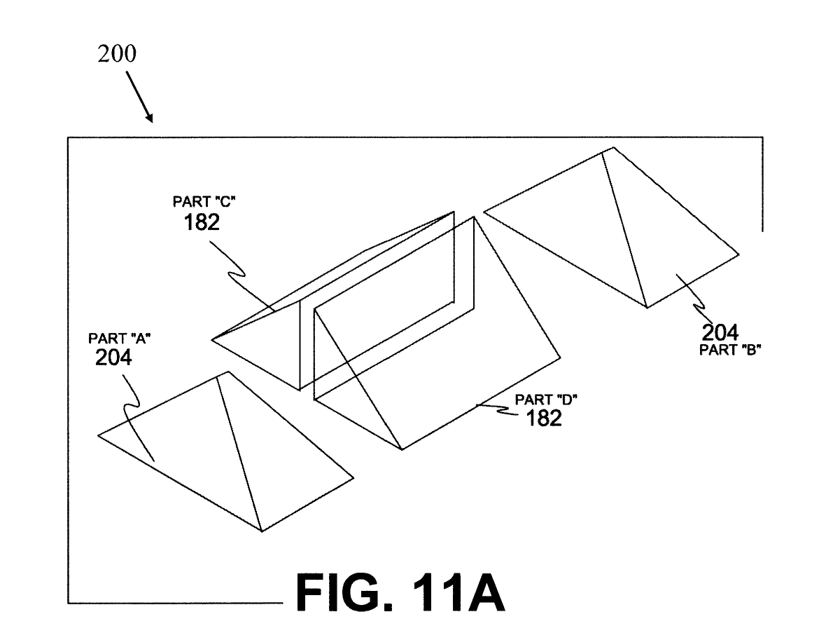

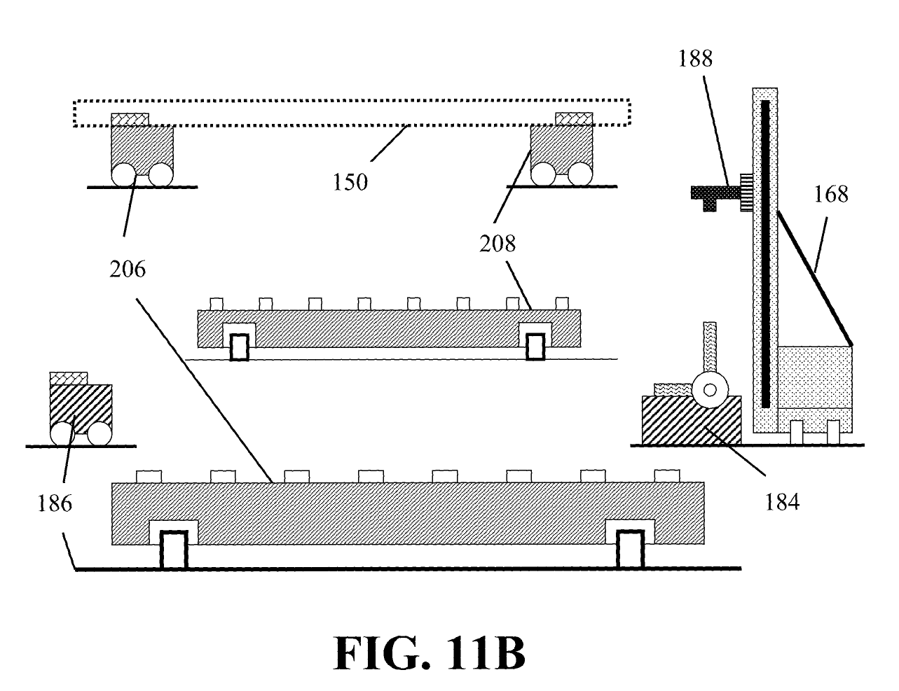

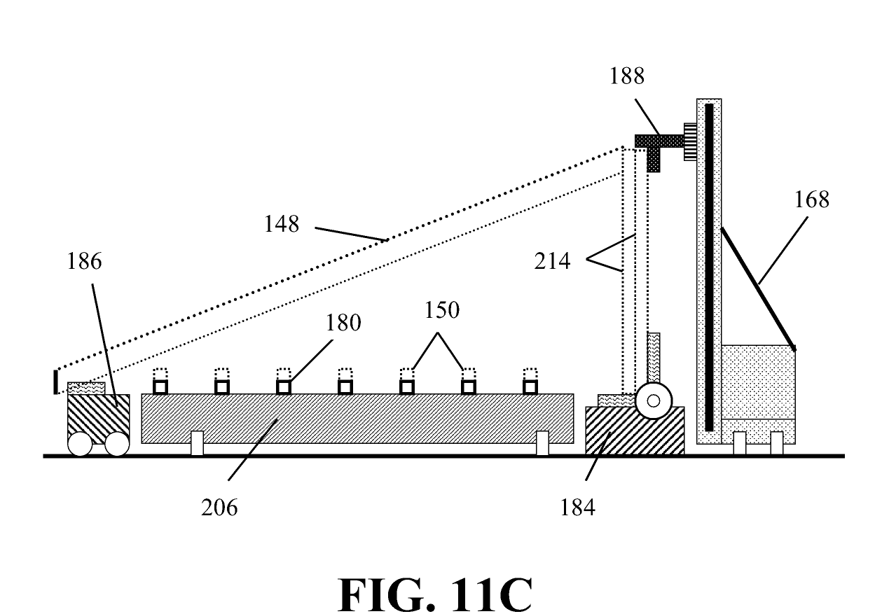

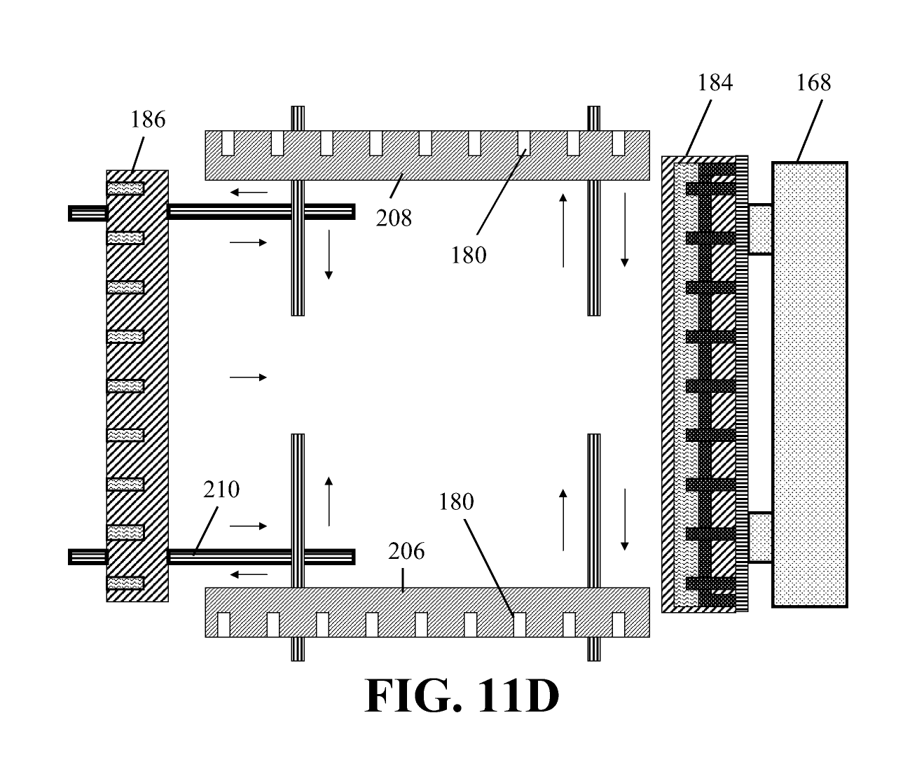

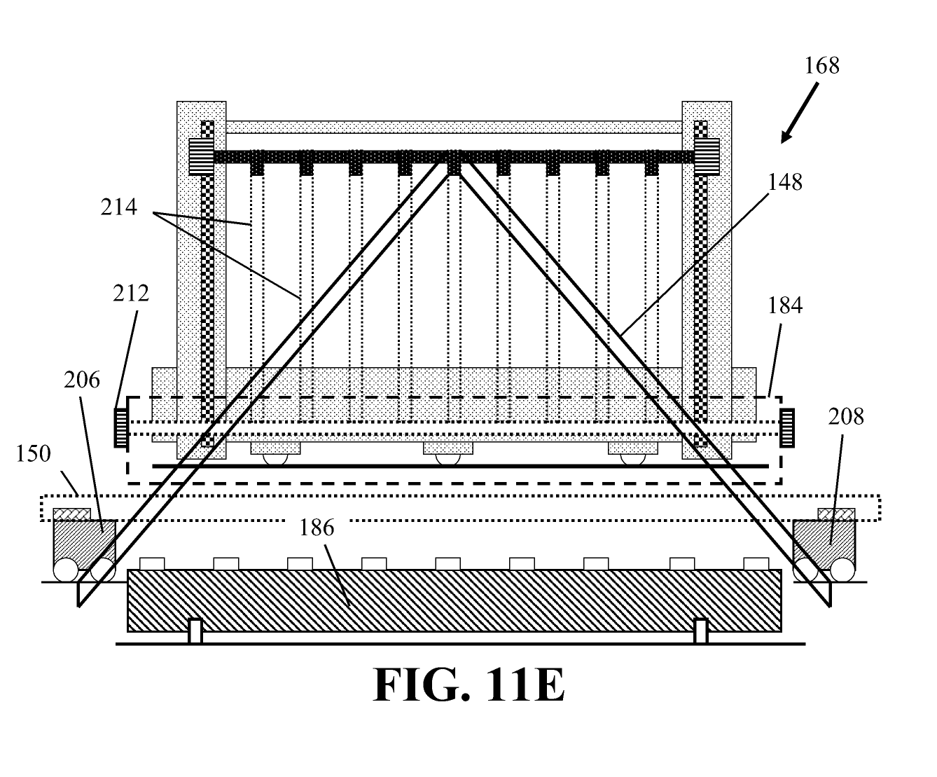

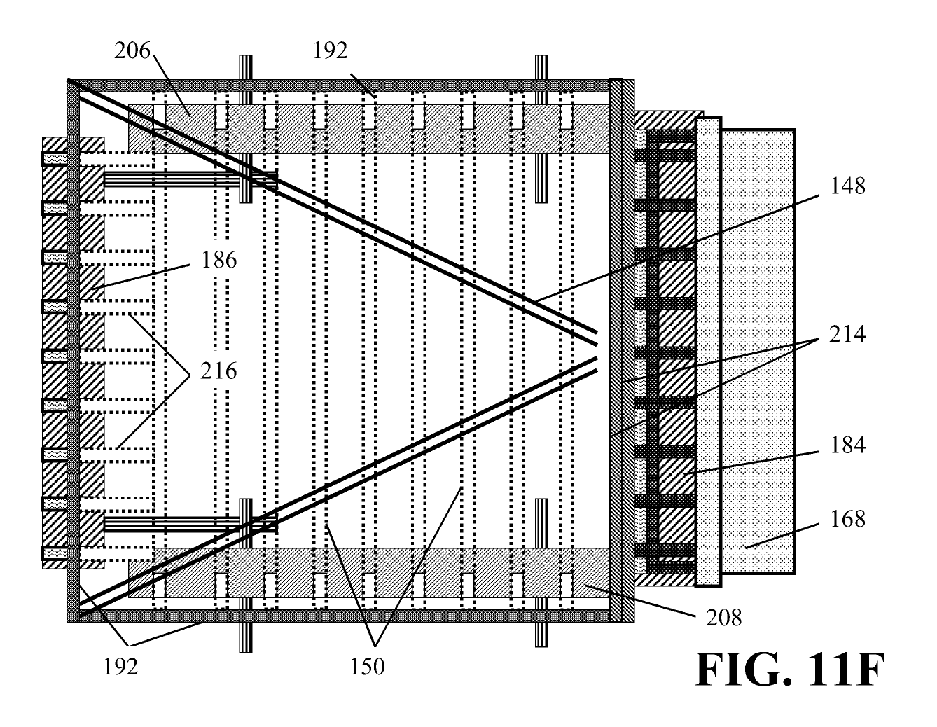

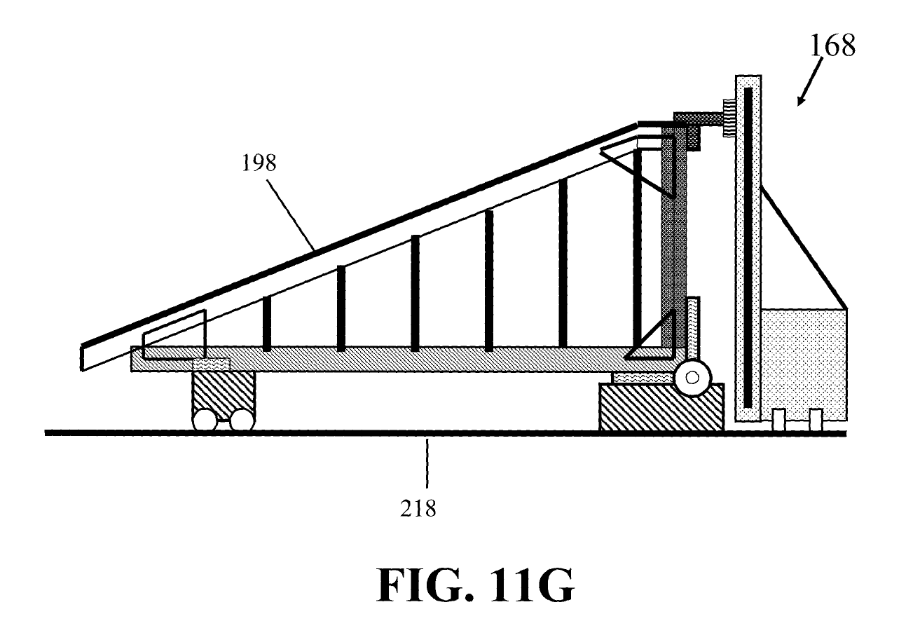

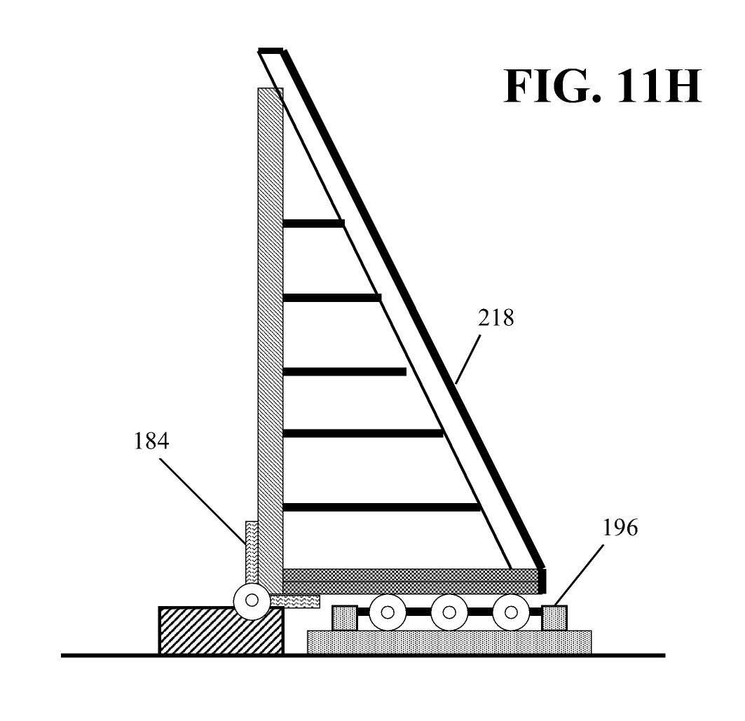

FIG. 11 shows the hip roof 200 equipment and assembling process.

FIG. 11A shows the hip roof 200 equipment and assembling process. The hip roof 200 comprises two half gable sections 182 and two hip ends 204.

FIG. 11B shows the hip roof 200 equipment and assembling process. Ceiling frame supports “C” 206 and “D”208 are the same configuration as support “B” 186. Dotted lines show a ceiling joist 150 resting on the members anchor mechanism 188 can be adjusted up and down for roof pitches

FIG. 11C is a side view of the truss assembly station 168. Ceiling frame support “C” 206 with O.C. spacers moves on tracks to and from center. This ceiling frame support “A” 184 is stationed on the floor permanently. A mechanism 188 allows it to pivot 90 degrees to up right position. Anchor mechanism 188 can be adjusted up and down for roof pitches. Rafter beams 148 from high center point slope down to the low corners of the roof squire. Ceiling joists 150, spacers 180 and vertical support members 214 are also shown.

FIG. 11D is a top view of the mobile truss anchor system 168. This top view shows the relationship and coordination of mobile truss anchor station 168, ceiling frame support “A” 184, “B” 186, “C” 206 and “D” 208. The two added members “C” 206 and “D” 208 include spacers 180 and run on tracks 210 toward and away opposite from each other.

FIG. 11E is a top view of the hip truss mobile anchor station 168. This top view shows the relationship and coordination of mobile truss anchor station 168, ceiling frame support “A” 184, “B” 186, “C” 206, “D” 208. The vertical support members 214 are set on frame support “A” 184. Also shown are the relationships with the rafter beam 148, the ceiling joist 150 and the pivot mechanism 212.

FIG. 11F is a top view of the hip truss mobile anchor station 168. Shown are mobile truss anchor station 168, ceiling frame support “A” 184, “B” 186, “C” 206, “D” 208. Dotted lines illustrate ceiling joists 150 placed under the rafter beams 148 rest on ceiling frame support “C” 206 and “D” 208. Also depicted are ceiling frame supports “A” 184, and “B” 186, the side plates 192, the bridging members 216 and the double adjoining plates 214.

FIG. 11G is a finished section of a half of the hip truss mobile anchor station 168. Shown is a finished section of a half hip truss section 218 with the roof sheathings and shingles 198 installed.

FIG. 11H is a side view of a finished sectional half hip roof 218. Shown is a finished section of a half of the hip truss assembly 218 ceiling frame support “A” 184. A completed half sectional hip roof 218 with roof sheathing board and shingles. The mobile truss anchor station has been removed out of the way to make room for this flipped over process. This sectional half roof is ready to be conveyed away by means of overhead conveying device 196 or hydraulic crane.

FIG. 12 shows the forced air 220 path of the independent active thermal air cavity 36. The forced air 220 travels through a dedicated auxiliary furnace 222 and passes through the sealed independent active thermal cavities 36 that form a channel throughout the various walls, floors and ceiling of the structure including an independent active thermal cavity 36 in the concrete floor 224. The attic roof and walls are insulated with rigid foam insulation 18 and a solar powered fan 228 is energized by a solar panel 226 disposed on the roof to regulate the attic temperature. Also shown an auxiliary air condition unit 223 which generates cooling forced air using the same forced air path 220 by switching the thermal control.

FIG. 12A shows the forced air path 220 of the independent active thermal cavity air blanket 36 associates with the inactive cavity 38, glass VIP 34 within the walls. The forced air 220 path is similarly configured as depicted in FIG. 12 with the addition of the inactive cavities 38 combining with the glass VIP 34 and foam insulation 18. The present invention uses two or three pieces of glass VIP sheets 34. A heating device is used going around four edges by applying appropriate temperature. Thus the entire unit as a whole will be sealed seamlessly with the SME glass material and all melted together as one piece. Also shown is the auxiliary air conditioning unit 223.

FIG. 12B shows a version of active thermal air insulation for building that sought for higher energy saving requirements comprising a casing 232 with multiple independent active thermal cavities 36, galvanized metal sheets 230 and rigid foam insulation 18.

FIG. 12C is an applying example of the insulation component comprising multiple independent active thermal cavities 36 with sheet metals 230 and rigid foams 18 incorporated with studs, sheathing boards and studs.

FIG. 12D is an applying example of the heated forced air path. Heated forced air 220 from the furnace 222 travels in a circulated pattern in the created independent active thermal cavities 36 provides three effective means of heating the building; first, on the main floor, heated forced air travels under the floor skin and heats up the concrete floor 224. Heat rises. Second; forced air continually travels in the created independent active thermal cavities 36 in interior walls to maintain comfort temperature within rooms. Third; forced air continually travels across the ceiling in created independent active thermal cavities 36 heats up the concrete ceiling 234 which is the same concrete slab for the immediate upper flooring, and this concrete floor slab 224 is also heated by a separate in floor independent active forced air cavity 36 system. Actually that the same concrete floor slab 224 separates the lower and upper floor is heated by two separate systems of the same type. The top level ceiling 234 which is shown, it is heated by double layers independent forced air thermal cavities 36. Also shown are the rigid foam insulation panels 18, the glass VIP 34, inactive cavities 38, glass walls 238, added single panes of glass 240 rising ambient heat from the floor 234 and return air 242 to furnace showing the active thermal cavity air blanket forced air movement in walls, travels up the main floor, upper floor and across the attic to the opposite side walls.

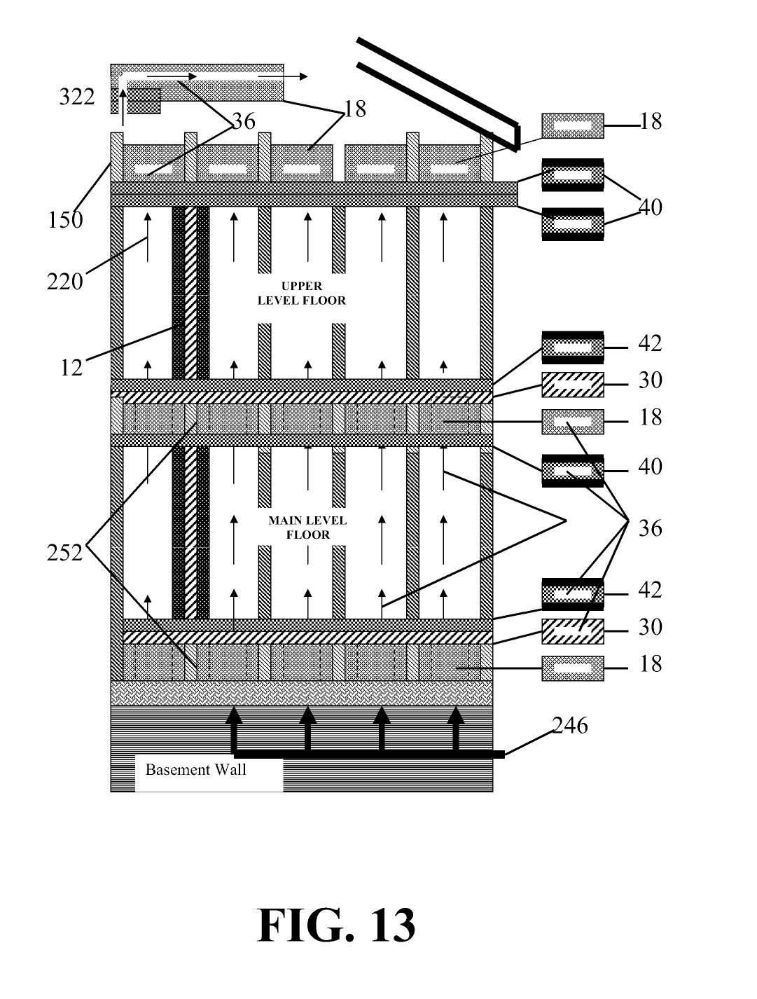

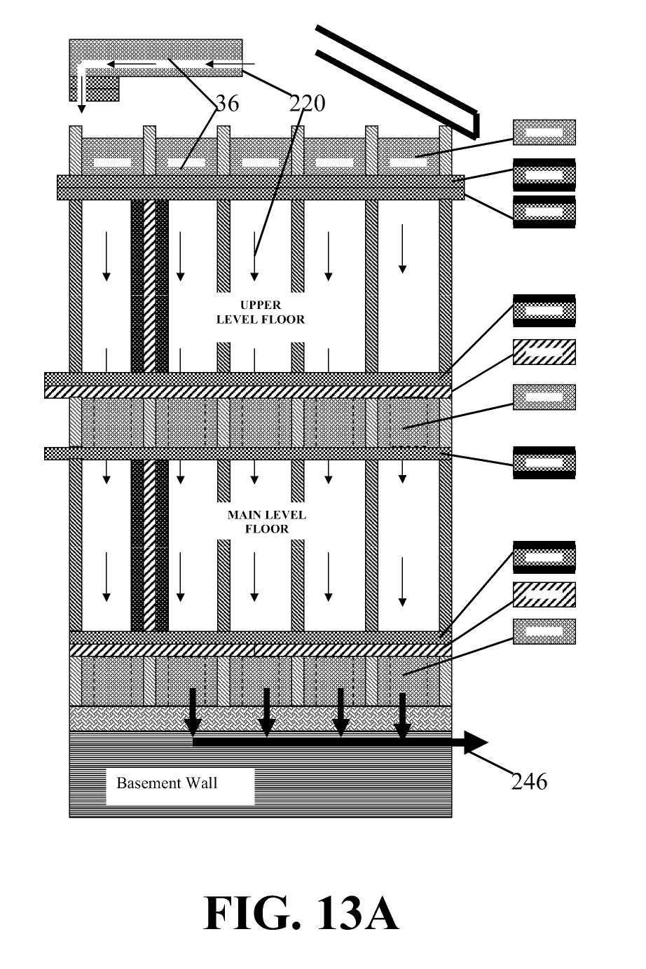

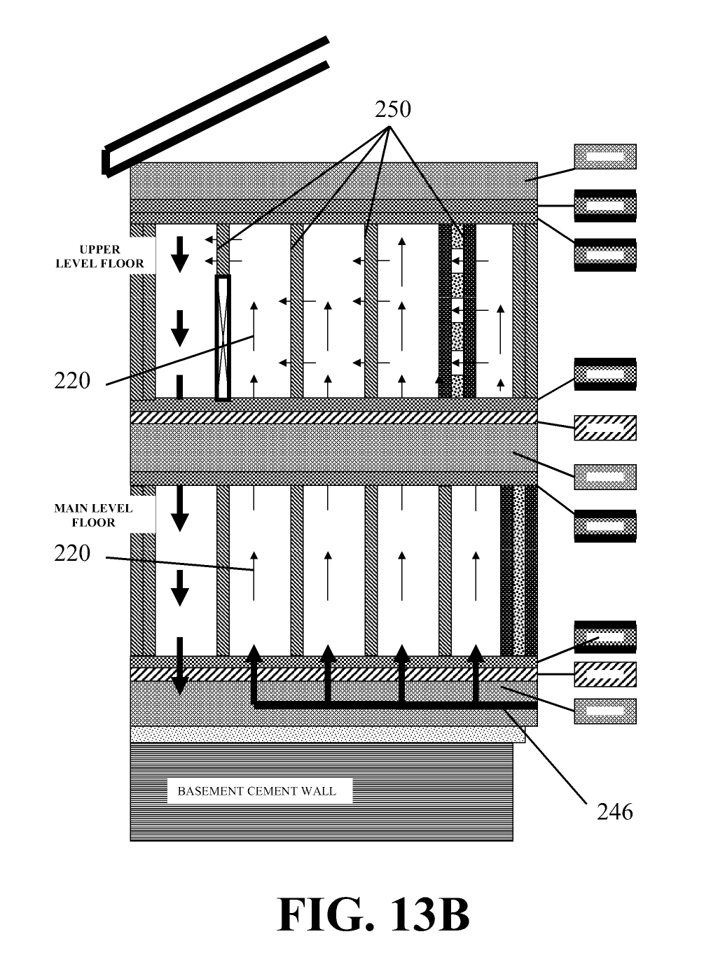

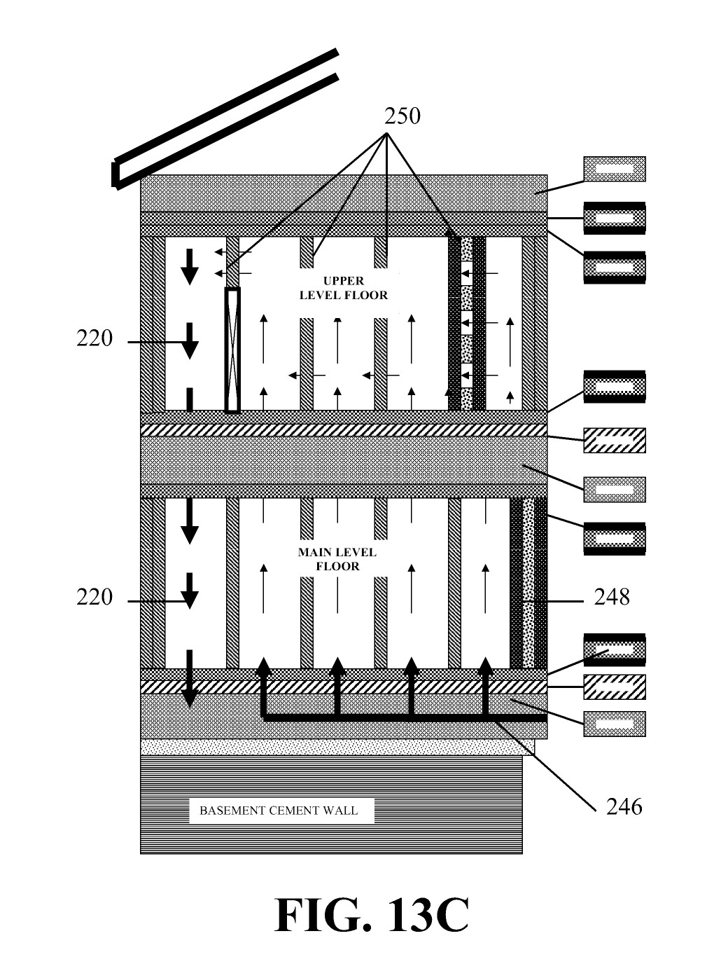

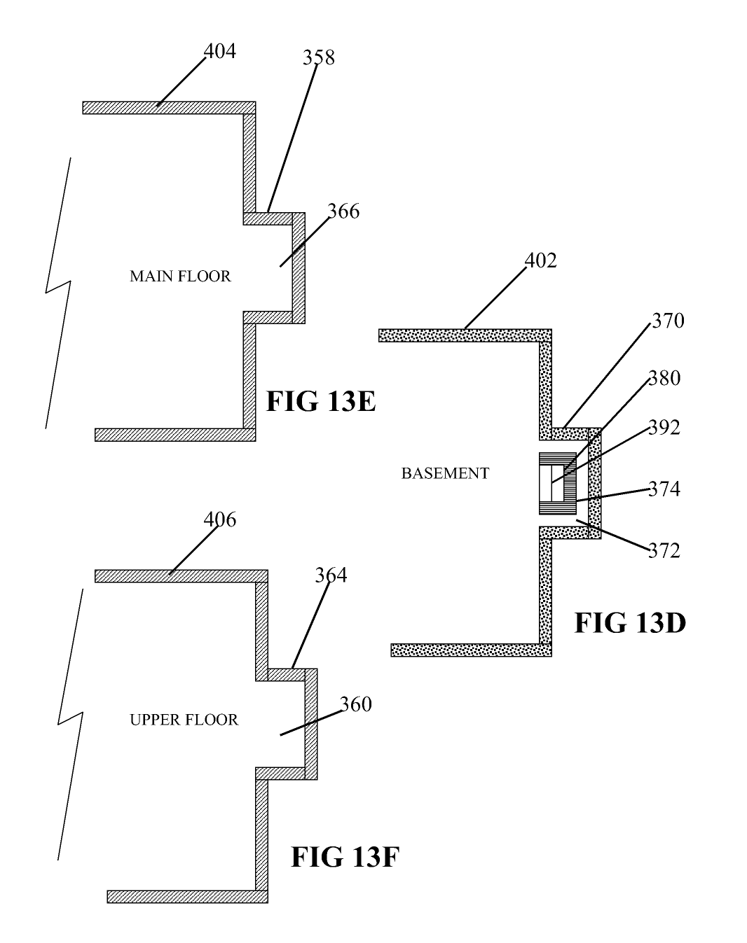

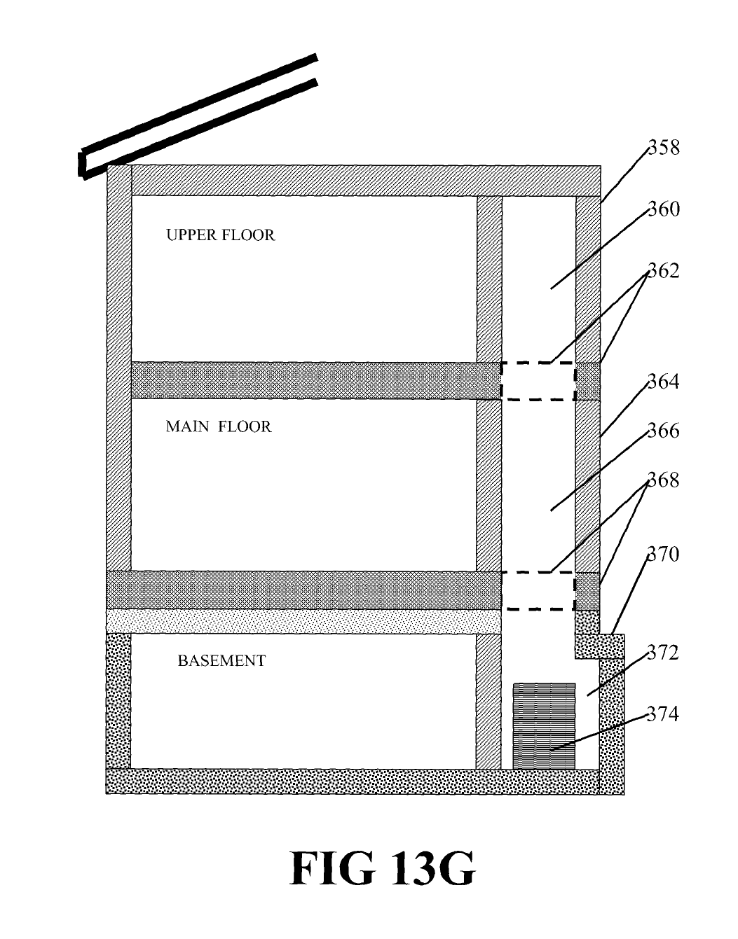

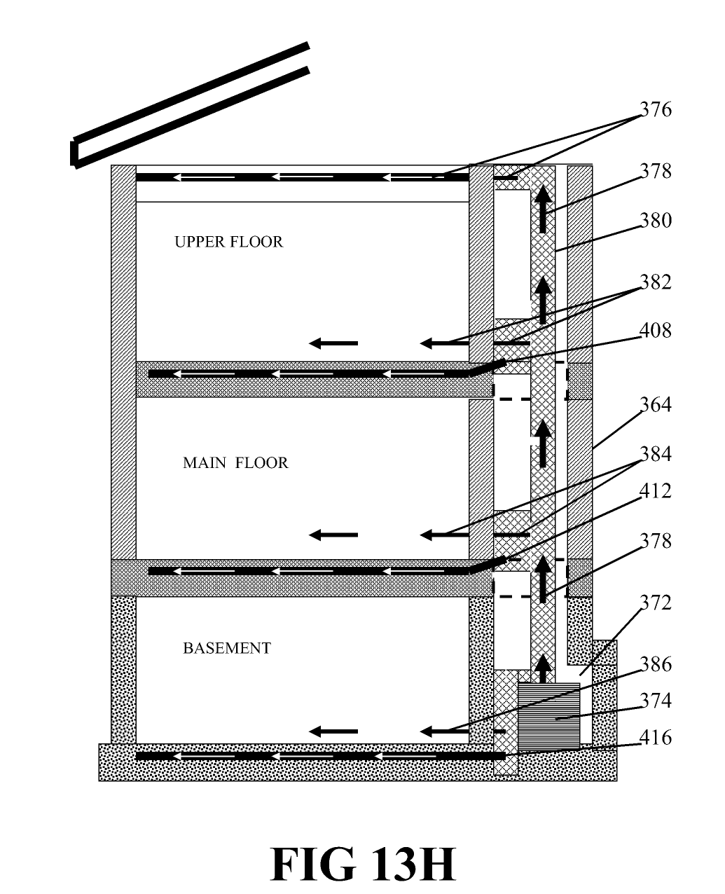

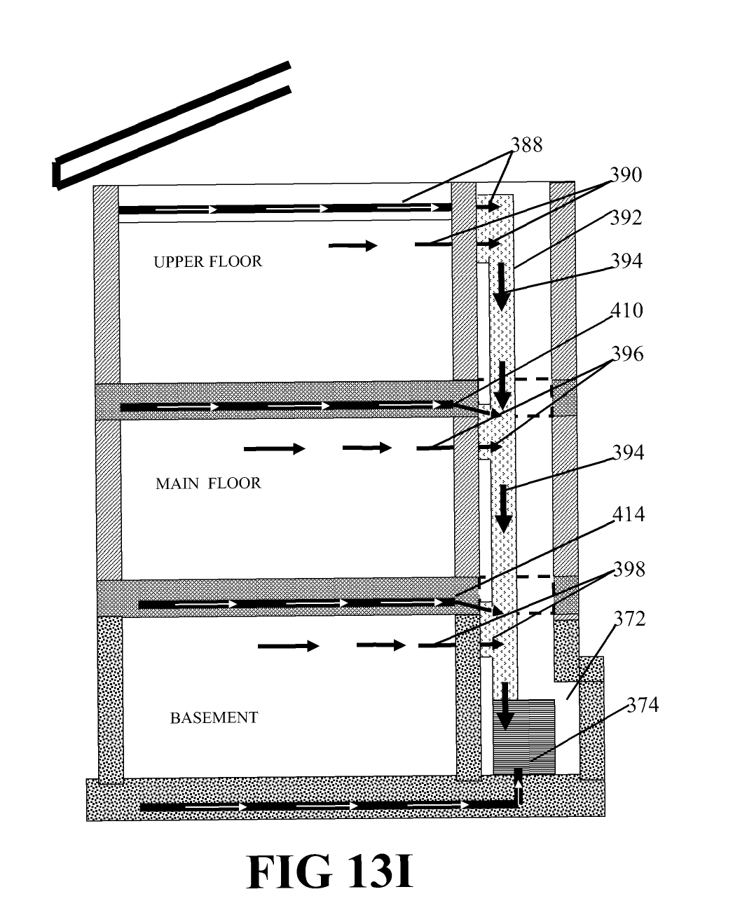

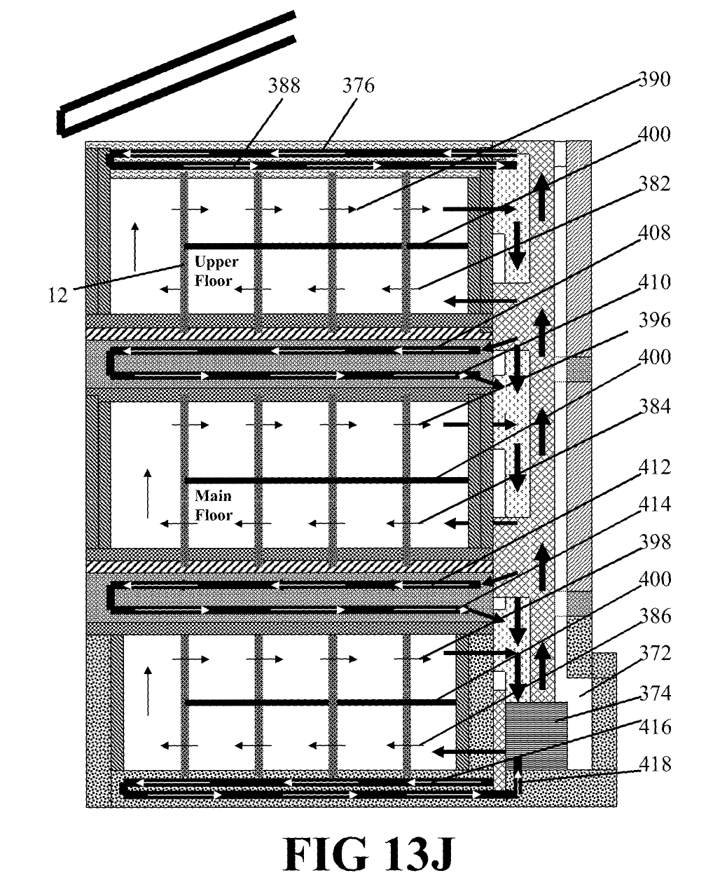

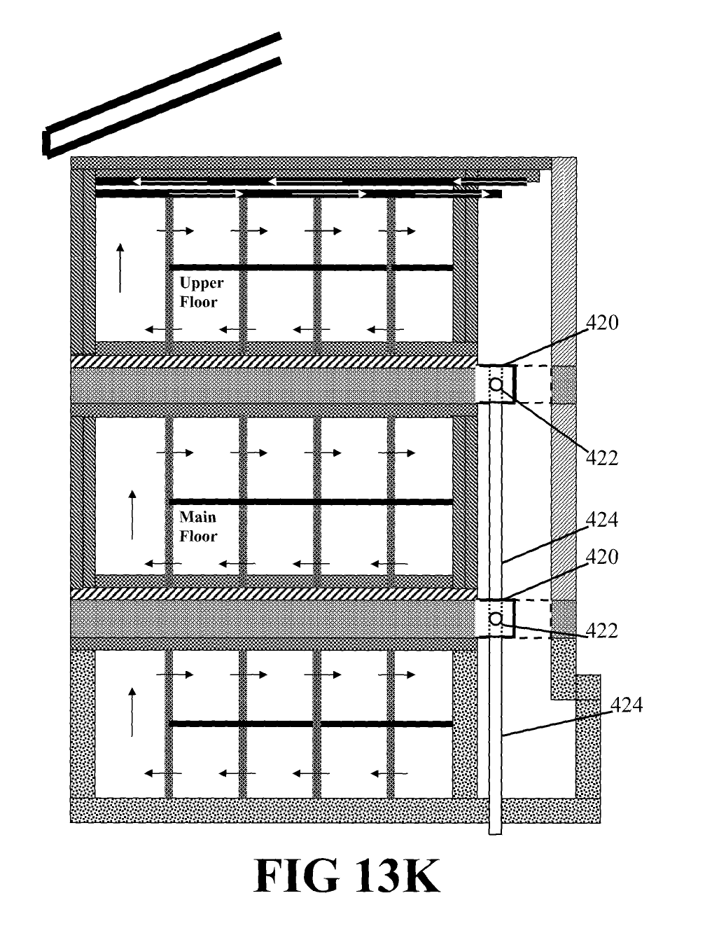

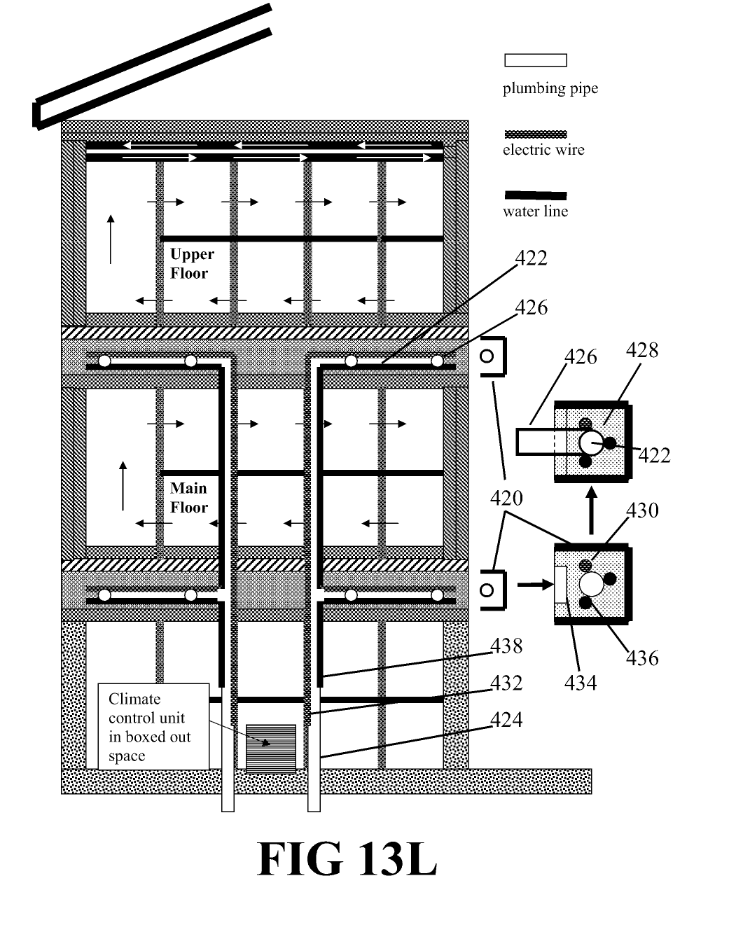

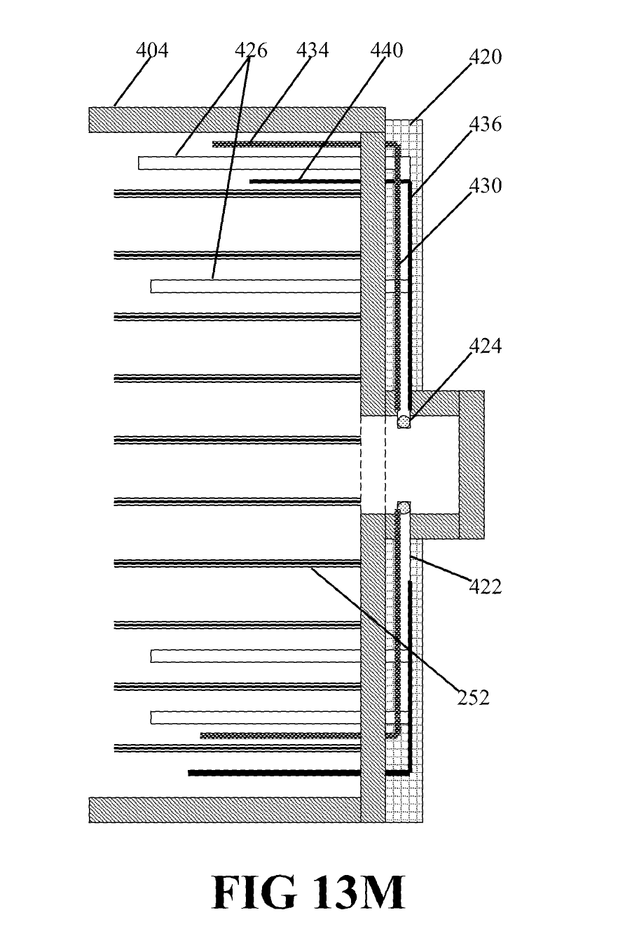

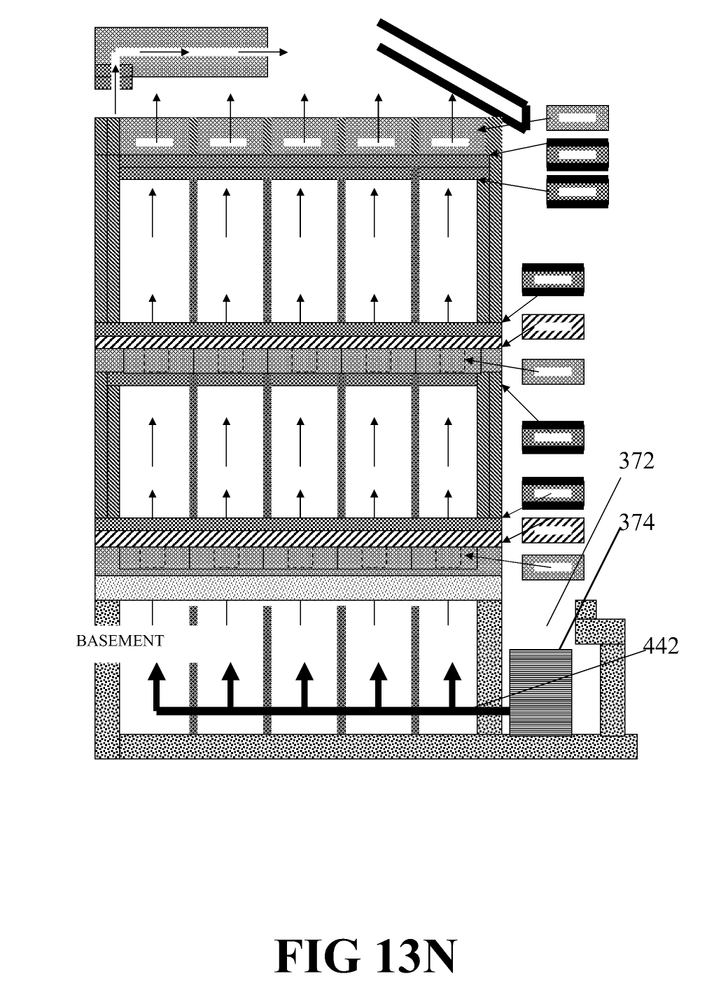

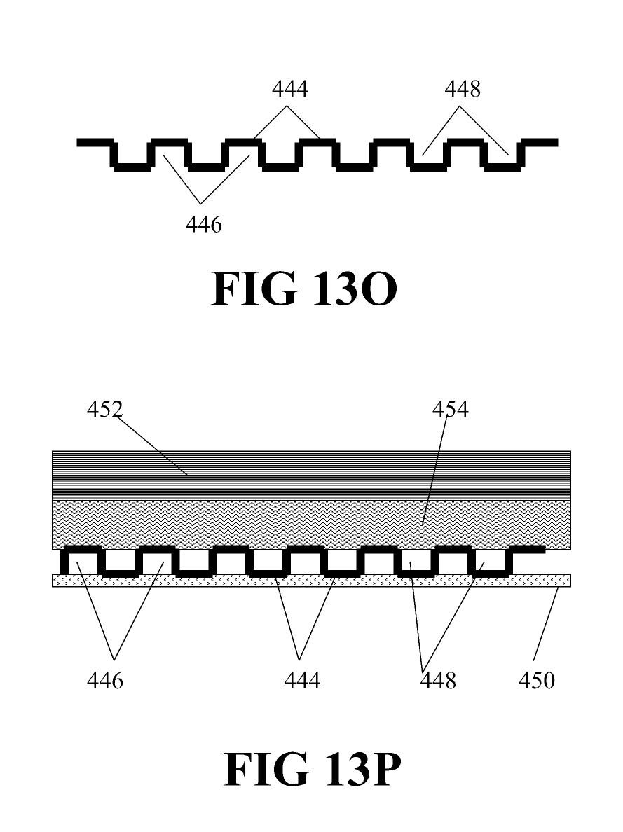

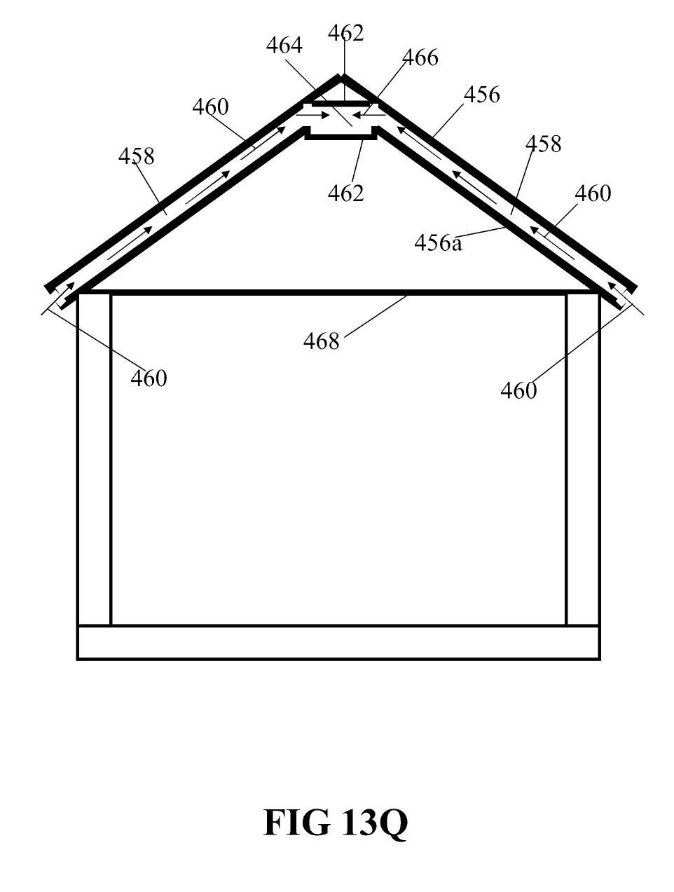

FIG. 13 is an orthographic view of the thermal cavity air blanket forced air 220 upward movement in walls. Shows the independent active thermal cavity 36 air blanket forced air 220 movement in walls, travels up the main floor, upper floor and across the attic to the opposite side walls as directed by the ceiling joists 150, the vertical studs 12, the top plates 40, the bottom plates 42, OSB floor sheathing 30, and the forced air enters in from the ducts 246 underneath main floor between floor joists in the basement. The rigid foam component 18 shows a sectional view in the attic with an independent active cavity 36 for forced air 220 in horizontal movement across and above the ceiling reaching the top plates 40 of the opposite side wall.

FIG. 13A is an applying example of the independent active thermal blanket cavity 36 forced air 220 downward movement in opposite side wall having a similar configuration therewith (refer to FIG. 13 for details). Active thermal cavity 36 air blanket, forced air 220 movement in opposite side wall, travels across the attic, down into the wall of the upper floor, main floor, then returns to auxiliary furnace in basement. Forced air 220 returns in from ducts 246 underneath the basement wall.

FIG. 13B is an applying example of the independent active thermal cavity 36 having air blanket forced air 220 movement in one of the other two sets of walls. Shown, forced air 220 travels up in the wall of the main floor, no openings in studs 248 for horizontal movements. As the forced air reaches the upper floor, openings in studs 250 allow the forced air 220 travels horizontally, note that in the far left diagram, forced air 220 being strategically channeled to return to the auxiliary furnace in the basement through the ducts 246.

FIG. 13C is an applying example of the independent active thermal cavity 36 air blanket forced air 220 movement in one of the other two sets of walls. Shown, forced air 220 travels up in the wall of the main floor, no openings in studs 248 for horizontal movements. As the forced air reaches the upper floor, openings in studs allow the forced air 220 travels horizontally, note that in the far left diagram, forced air 220 being strategically channeled to return to the auxiliary furnace in the basement through the ducts 246. FIG. 13D shown: the top sectional view of a basement wall structure 402 with a boxed out wall 370; created within is a boxed-out space 372 from the basement floor for housing & consolidating the climate control unit 374; the climate control unit 374 comprises an outward forced air duct body 380 and an inward forced air duct body 392.

FIG. 13D shown: the top sectional view of a basement wall structure 402 with a boxed out wall 370; created within is a boxed-out space 372 from the basement floor for housing & consolidating the climate control unit 374; the climate control unit 374 comprises an outward forced air duct body 380 and an inward forced air duct body 392.

FIG. 13E shown: the top sectional view of a main level wall structure 404 with a boxed-out wall 358 creating a boxed-out space 366 aligned on top with the basement wall structure 402 shown in FIG. 13D; the focus herein is the main floor boxed-out space 366 aligned with the basement boxed-out space 372 forming a vertical column. Refer to FIG. 13G.

FIG. 13F shown: the top sectional view of an upper level wall structure 406 with a boxed-out wall 364 creating a boxed-out space 360 aligned on top with the main level wall structure 404 shown in FIG. 13E; the focus herein is the upper level boxed-out space 360 aligned with the main level boxed-out space 366 forming a three level vertical column boxed-out space additionally aligned to the basement boxed-out space 372, forming a multi-level vertical column of boxed-out spaces.

FIG. 13G is an example that relates to FIGS. 13D, 13E & 13F. Depicted is a whole side view of the formation of the multi-level vertical column boxed-out spaces joining and aligning the basement wall structure 370, which has a boxed-out space 372, the main level boxed-out structure 364, which has a boxed-out space 366, and the upper level boxed-out structure 358, which has a boxed-out space 360; therein clearly depicted is the basement boxed-out space housing the climate control unit 374 that frees the basement floor of obstructions to allow for more desirable development and spaces free of conventional cumbersome ducting systems.

FIG. 13H is a side view example, shown is the installed forced air “outward” ducting system body 380 in the basement boxed-out space 372, extending its way up in the aligned multi-level vertical column boxed-out spaces (formation of boxed-out spaces 360, 366 & 372, refer to FIG. 13G) to the main and upper floors, reaching up to the ceiling level, and connecting with various outward passages to each floor level. The active thermal forced air main paths 378 are within the outward ducting system body 380 and move up from the climate control unit 374, which is housed in the basement boxed-out space 372, and clearly depicts the relationships of the various outward active thermal forced air paths from the basement level up. 416 is the basement in-slab active forced air path; 386 is the lower horizontal active forced air path; 412 is the in-floor active forced air of the main floor; 384 is the lower horizontal active forced air path; 408 is the in-floor active forced air path of the upper floor; 382 is the lower horizontal active forced air path; 376 is the in-ceiling active forced air path.

FIG. 13I is an example showing the installed forced air “inward” ducting system body 392 that extends its way up in the aligned multi-level vertical column boxed-out spaces connected from the climate control unit 374 in the basement floor rising up to the main floor and upper floor and reaching up to the ceiling level and connected on the way to various outward passages from each floor level. The active thermal forced air main paths 394 moving within the inward ducting body 392 returns to the climate control unit 374, which is housed in the basement boxed-out space 372 and clearly depicts the relationships of the various “inward” active forced air paths from the ceiling level down; 388 is the in-ceiling forced air path; 390 is the upper horizontal forced air path of the upper floor; 410 is the in-floor forced air path of the upper floor; 396 is the upper horizontal forced air path of the main floor; 414 is the in-floor forced air path of the main floor; 398 is the upper horizontal forced air path of the basement; 374 is the concrete floor in-slab forced air path.

FIG. 13J is a completed consolidated side view of FIGS. 13H & 13I and clearly depicts the combined functions and relationships of: the utilization of the boxed-out space 372, multi-level vertical column boxed-out spaces (formation of boxed-out spaces 360, 366 & 372 refer to FIG. 13G), and the outward and inward forced air ducting systems; it demonstrates all outward & inward active thermal forced air paths connecting & circulating together as a completed system. The arrayed composite insulated wall panels on each floor shown are divided in half by a foam strip 400 to create the horizontal lower outward and upper inward forced air passage pattern. For the basement concrete floor this Figure shown depicts the active forced air path 416 that travels outward in the in-slab concrete floor and shows the inward active forced air path returning to the climate control unit 374. For the basement level this Figure shown depicts the active forced air traveling outward through the 12 in-stud openings into a lower horizontal active forced air path 386, then moving upward through a designated section of an unobstructed wall panel into an inward upper horizontal active forced air path 398 within the same divided and arrayed vertical wall panel cavities. For the main level in-floor the Figure shown depicts the active forced air path 412 traveling outward in the in-floor underneath the sub-floor and between the floor joists; it also shows the inward active forced air path 414 returning to the climate control unit 374. For the main floor, the Figure shown depicts the active forced air traveling outward through 12 in-stud openings in a lower horizontal active forced air path 384, then moving upward through a designated section of an unobstructed wall panel into an inward upper horizontal forced air path 396 within the same divided and arrayed vertical wall panel cavities. For the upper level in-floor, the Figure shown depicts the active forced air path 408 traveling outward in the in-floor underneath the sub-floor and between the floor joists; it also shows the inward active forced air path 410 returning to the climate control unit 374.

For the upper floor, the figure shown depicts the active forced air traveling outward through 12 in-stud openings in a lower horizontal active forced air path 382, then moving upward through a designated section of an unobstructed wall panel into an inward upper horizontal active forced air path 390 within the same divided and arrayed vertical wall panel cavities.
For the ceiling level the Figure shown depicts the active forced air path 376 traveling outward in the ceiling cavities; it also shows the inward active forced air path 388 emerging into the main forced air path and returning to the climate control unit 374.

FIG. 13K is a side view showing the positions to floors of a cut-off view of 2 horizontal boxed-out structures 420, each braced within a cut-off horizontal view of a piece of main plumbing pipe 422, angled 90 degrees at a certain length and connected with another vertical piece of main plumbing pipe 424.

FIG. 13L is a side view, showing a 90 degree angle view of FIG. 13K. It more clearly depicts the relationships and functions of the elongate horizontal boxed-out structures 420 in FIG. 13K, which is associated with the horizontal pipe piece 422 and vertical pipe piece 424. The pipe piece 424 rises up from the ground stresses in the vertical column boxed-out space then elbows horizontally with its extension pipe piece 422, which is braced within the elongate horizontal boxed-out structure 420; another pipe piece 426 with a cut-off view is also elbowed 90 degrees with the pipe piece 422 to extend its length in the void space underneath the sub-floor & between the floor joists. Also refer to FIG. 13K. The configuration of the elongate boxed-out structure 420 created within its horizontal hollow space comprises insulation 428; a horizontal pipe piece 422; water line 430; electrical wiring 436 and an active thermal forced air path 434.

FIG. 13M is a top view of the main floor and further depicts the relationship of the multi-level vertical column boxed-out space associated with the elongate horizontal boxed-out structure 420 bracing within the horizontal pipe piece 422, the electrical wire 430, the water line 436 and the elbowed vertical pipe piece 424. 426 is an elbowed extension pipe of 422, displayed underneath the sub-floor & between floor joists, 434 is the extension piece of the electrical wire of 430. 440 is the elbowed extension piece of the water line 436.

FIG. 13N is a side view demonstrated another active thermal forced air path 441, therein emphasizing the forced air path 441 starting in the basement level; forced air moves outward from the climate control unit 374 which is located in the boxed-out space 372, travel horizontally through openings in the lower section of the wall panels, them rising up through openings & passages reaching up to the ceiling passages/cavities then travel across the ceiling to the opposite wall, then return to the climate control unit 374 in basement in the same movement pattern.

FIG. 13O is a horizontal cut-off view of an existing corrugated metal ceiling component 444 which is widely used as an interior part of the roofing structure in the commercial & industrial buildings, 446 is the interior “void” spaces and 448 is the exterior “void” spaces of which have never been used, the present invention therein to utilize these said “void” spaces by running forced air through to create an active thermal forced air path in each one of these corrugated “void” spaces.

FIG. 13P is a horizontal sectional view further illustrates the formation, configuration and the relationships of the active thermal forced air system to be integrated into a typical roof structure which comprises of an existing corrugated metal ceiling component 444 having exterior insulation 454 in place to create exterior “void” spaces 448 and the exterior roofing material 452 installed on the top, the interior ceiling material 450 to be added to create the interior “void” spaces 446; “void” spaces 446 & 448 therein are the spaces/cavities for the forced air path.

FIG. 13Q is a sectional view further illustrates the insulated attic structure which comprises of foam insulation members 456 & 458 sandwiched together as composite insulated panels creating a cavity to become the passage 460 for the active forced air 462, said panels are to be installed on the roof rafter member (refer to FIG. 9D in the parent application) installed directly underneath the roof sheathing board. The central channel 464 is also made out of rigid foam member configured in an elongated square body installed at the top and center of the interior roof structure laying 90 degree from one end to the other against and attached to the said panels which are positioned from both sides of the roof, and said panels having openings on each high-pitch end matching the openings on each side of the central channel 464 and to be aligned together to each other then forming connected forced air passage 460 and passage 466 to allow forced air to enter from each said panel into the central channel 462. The function of the central channel 462 is to collect and centralize all forced air gathered and entered from all said panels then to be dissipated to the outside or be re-directed to whichever sources to be utilized. This structure is particularly designed for unwanted hot air to be dissipated for hot climates.

FIG. 14 is a sectional view and a side view of a composite floor joist 252 with opening/recesses 282 for forced air passage and openings 32 for plumbing and electrical, comprising OSB members 16 and galvanized steel structural members 14.

FIG. 14A is a sectional view and a side view of a composite interior floor joist 254 with openings/recesses 282 for forced air passage and openings 32 for plumbing and electrical, OSB members 16 and galvanized structural members 14. This interior floor joist 254 is for additional floor to be anchored on (refers to FIG. 14C).

FIG. 14B is a sectional view and a side view of an exterior composite insulated joist side plate 256 for floor joist 252 to be anchored on (refers to FIG. 14C) comprising OSB members 16, rigid foam insulation 18 and galvanized steel structural members 14 and openings 32 for plumbing and electrical.

FIG. 14C is a sectional view of the relationships of floor members and demonstrate the formation of a principal floor 272 and a sectional floor 270; on the left shown side view of the composite floor joist 252 with openings 282 for in-floor forced air passage and openings 32 for plumbing and electrical, joists 252 to be anchored between composite exterior joist side plate 256 and composite interior joist 254 (both in cut off view) forming the sectional floor 270. On the right shown the cut off view of two pieces of composite floor joists 252 spaced apart on-center having foam members 18 installed beneath the floor sheathing 46 to create the void space for in-floor forced air cavity 284 thereof; forming the principal floor 272 and sectional floor 270 structures completed with drywall 28.

FIG. 14D is a front view of the non-movable station 260 “A”. The platform 266 when hoisted up 5 to 6 feet above ground for workers to work the surface and underneath. The safety railing 258 heights can be easily adjusted.

FIG. 14E is a front view of the mobile stations 262 “B”, “C” and “D” all movable on their wheels 174 on tracks. The safety railing 258 when hoisted up 5 to 6 feet above ground for workers to work the surface and underneath. The platform 266 heights can be easily adjusted.

FIG. 14F is a side view of the principal floor assembly. The motorized floor joist assembling station “A” 260 with an adjustable platform 266 for desired heights is stationary and not moveable. Motorized floor joist assembling station “B” 262 has an adjustable platform 266 for desired heights and mobile on tracks. The side plates 264 secure to the floor joist 252 and the supporting members 268 are 90 degrees to the joists 252

FIG. 14G is a side view of the principle floor assembly. Shown are the joist side plates 264 mounted on the floor joist 252 and resting on the platforms of the two stations 260 “A” and 262 “B”. Once the floor is completed with sheathing board installed, station “A” 260 will be retreated and moved out of the way, and the finished floor will be laid on these supporting members 268, then the conveying equipment will move in, hoist up the floor and move to storage for shipment.

FIG. 14H is a side view of the principal floor 272 and two additional floors 270 on each side including pre-installed in-floor forced air channels 284.

FIG. 14I is a top view without the OSB floor sheathing installed, the relationships of the four platforms (ABCD) 260, 262 which can assemble all sizes of principle floors and additional floors. Also shown are supporting members 268 on wheels and tracks.

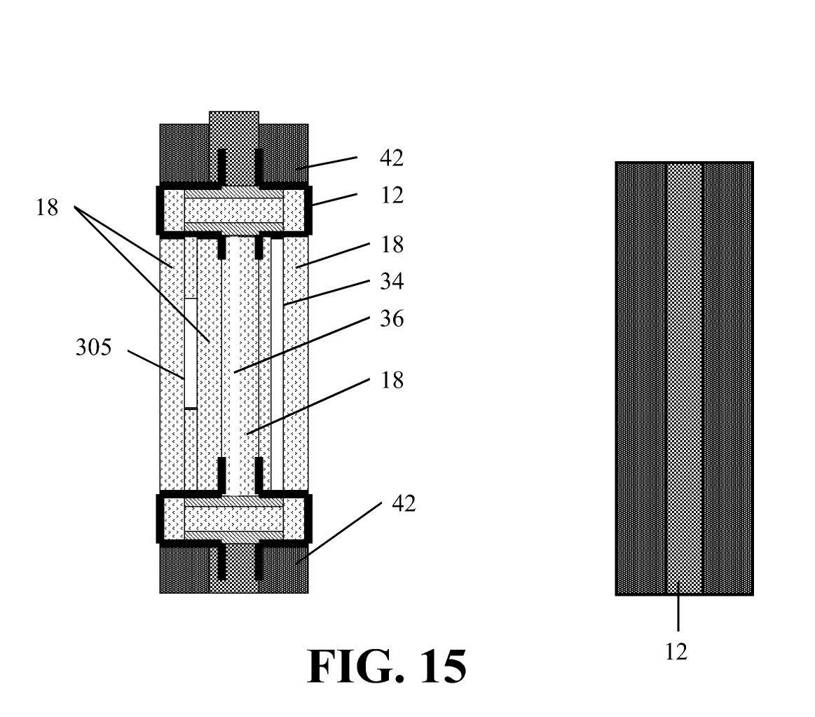

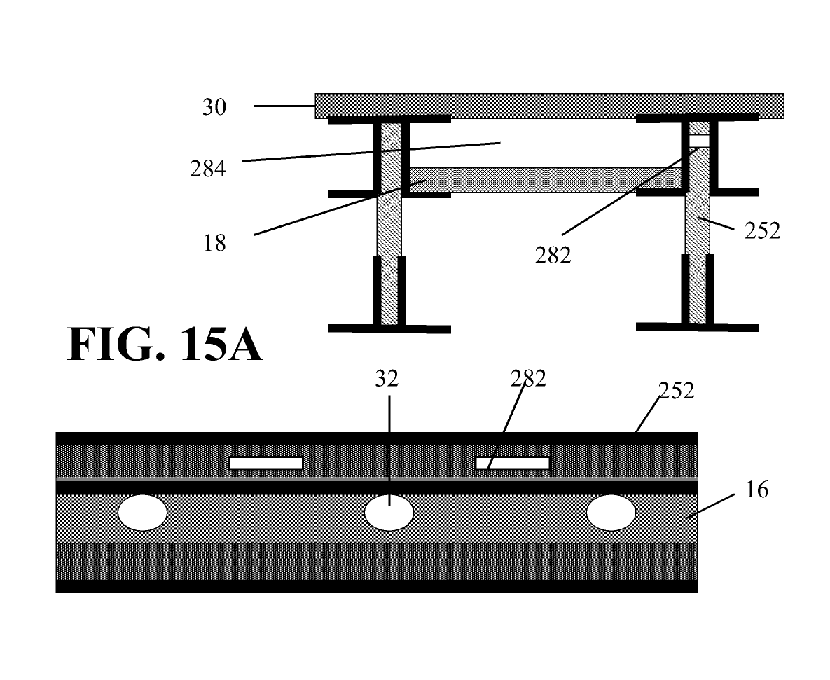

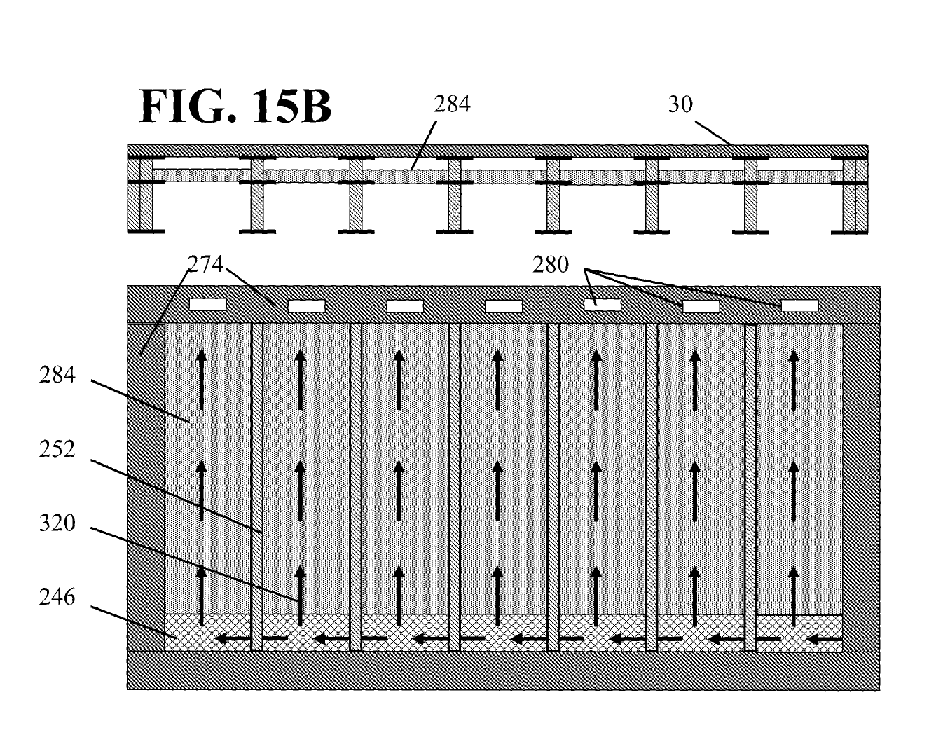

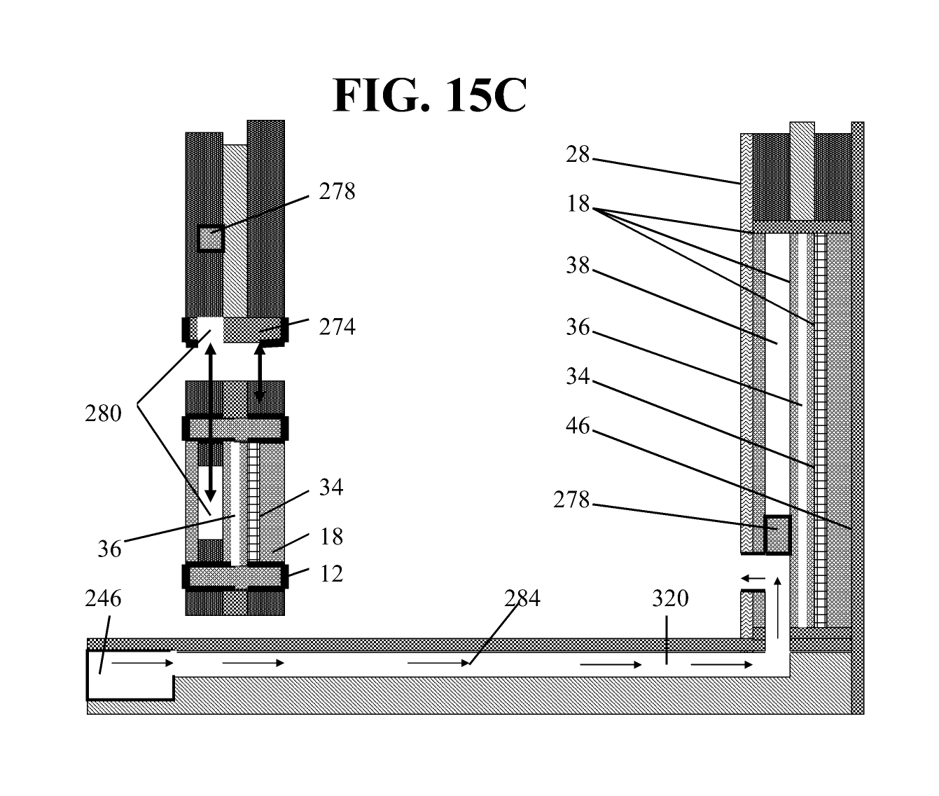

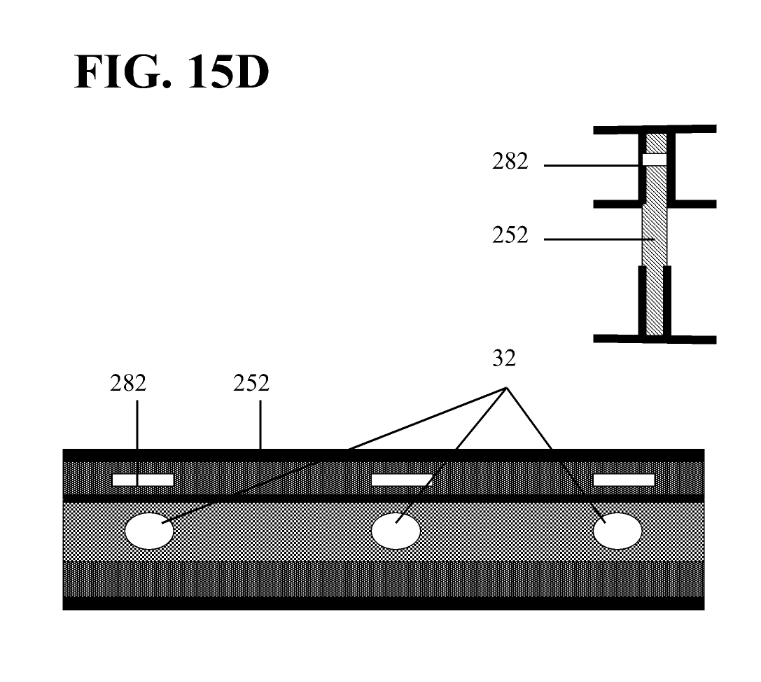

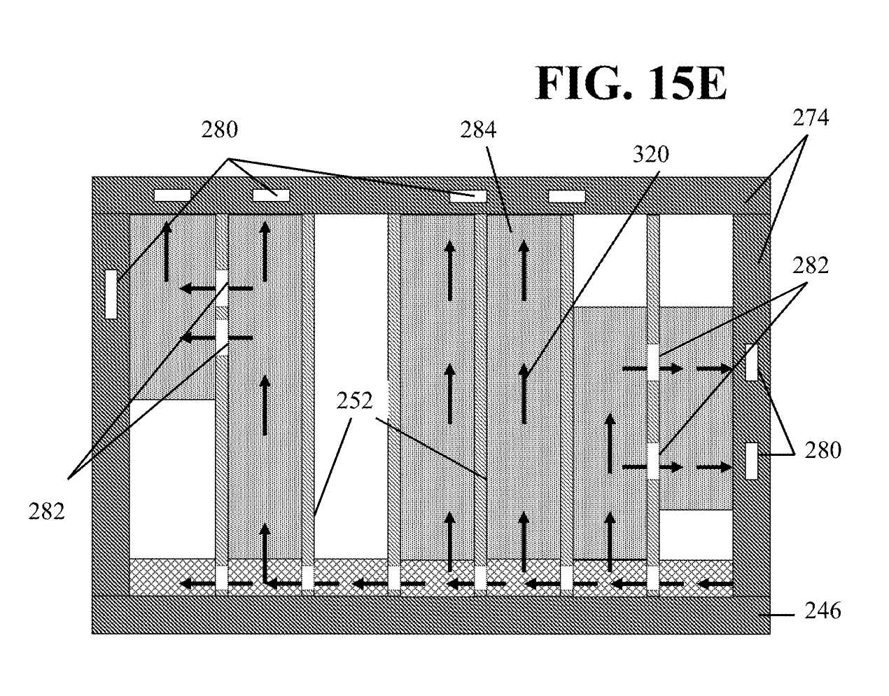

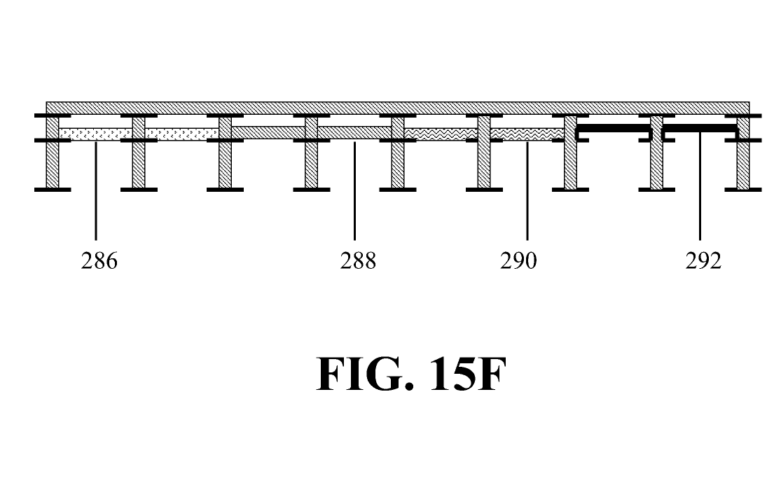

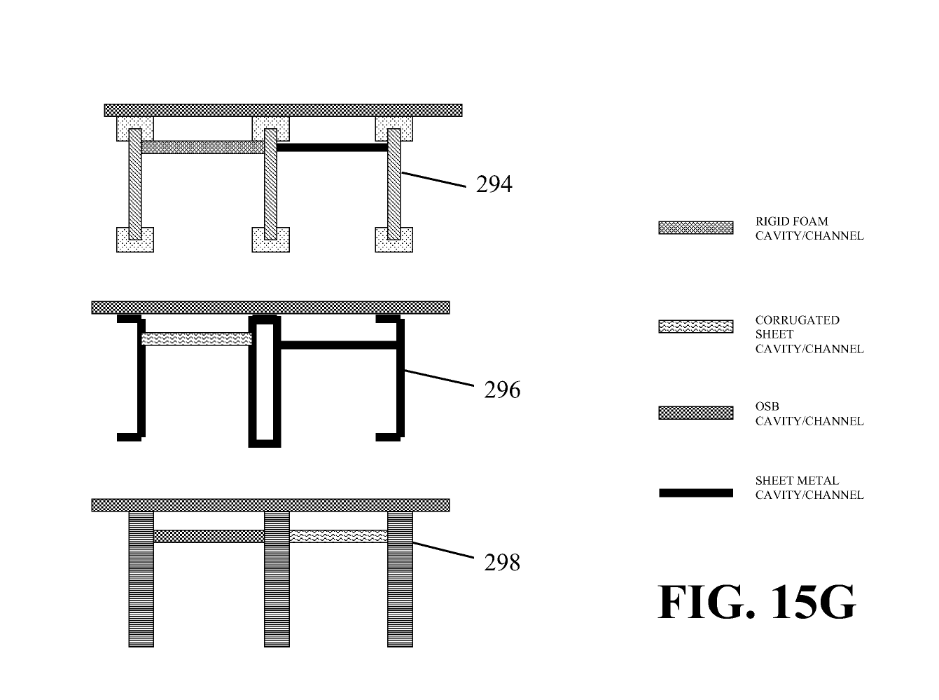

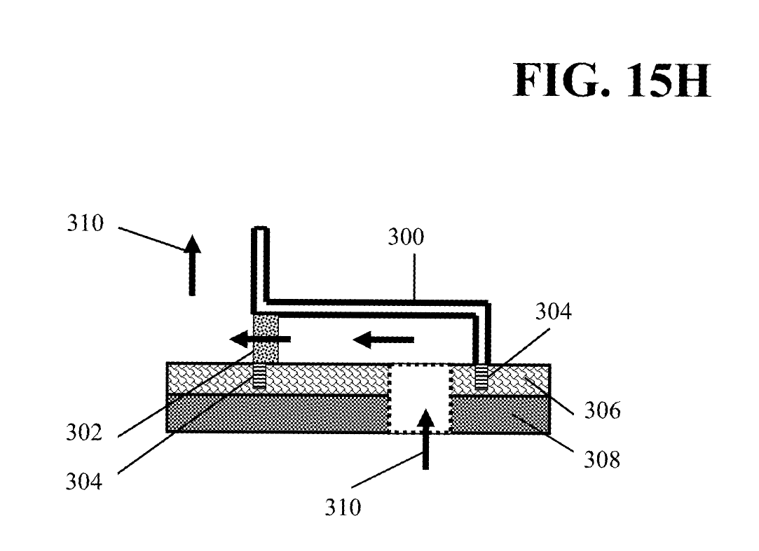

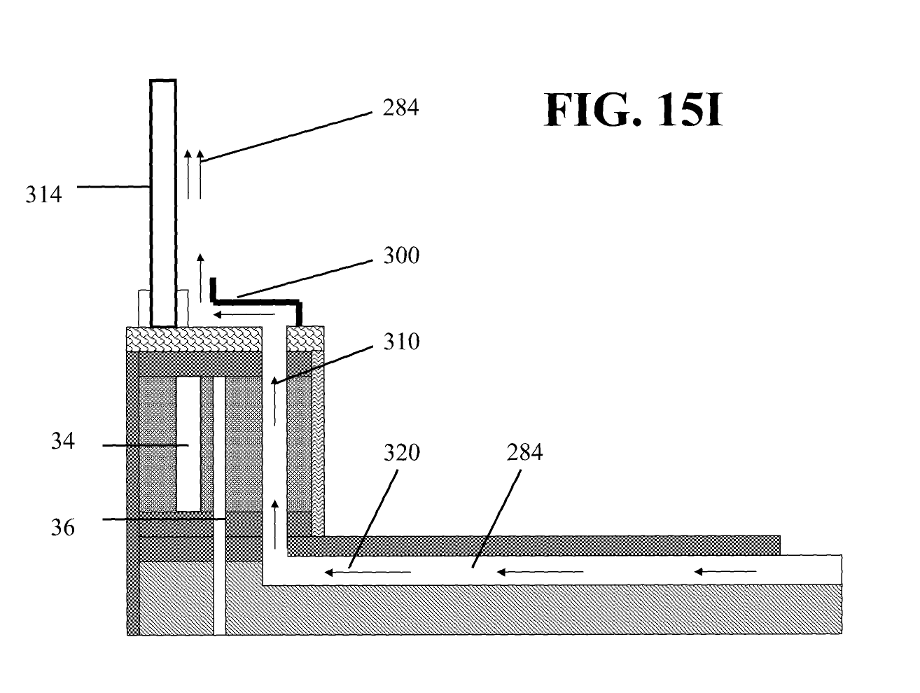

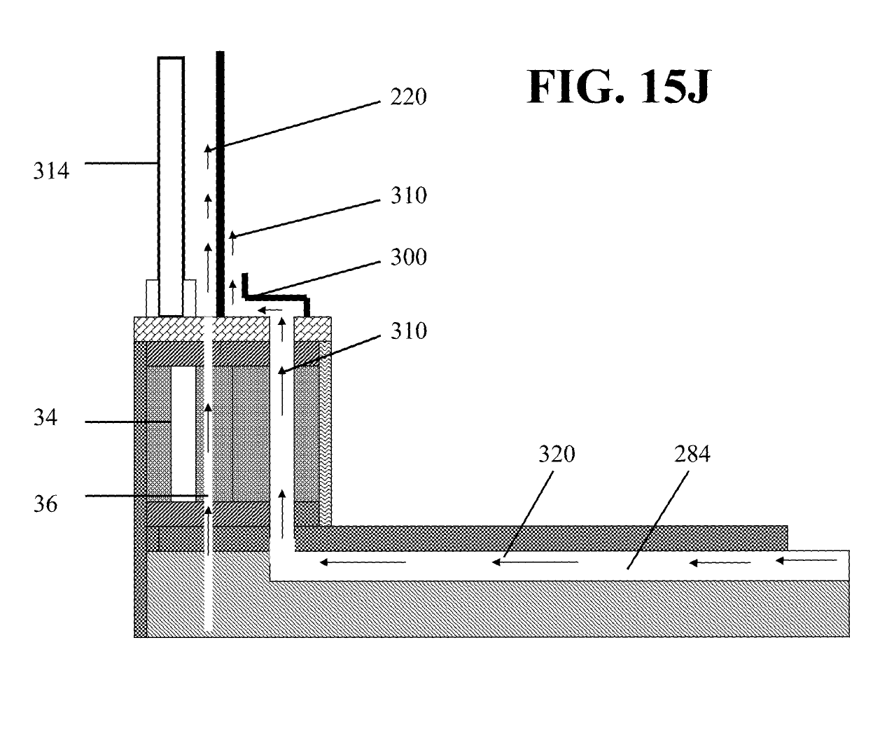

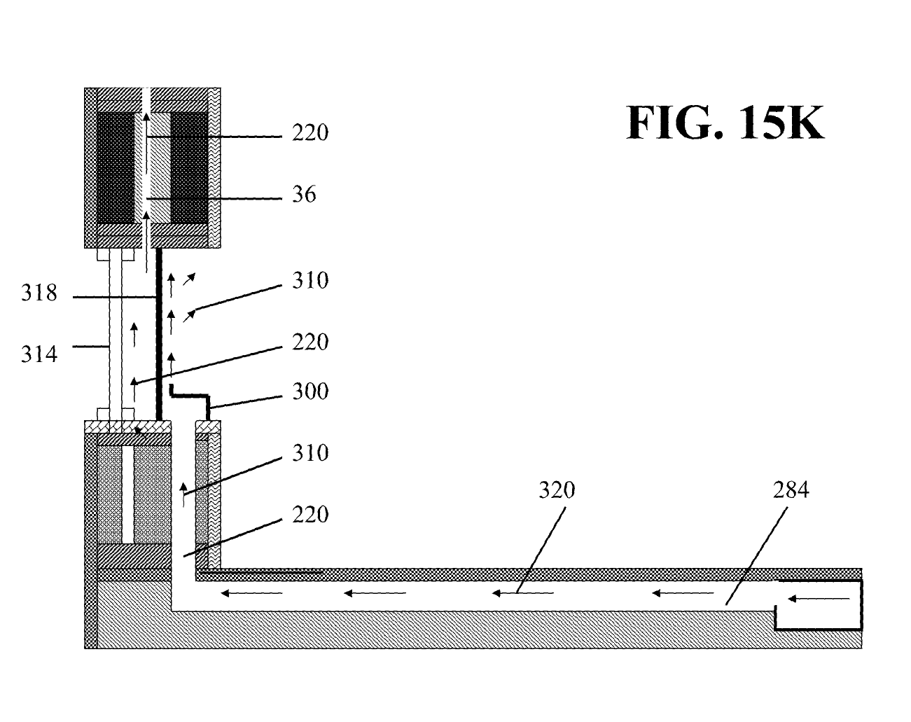

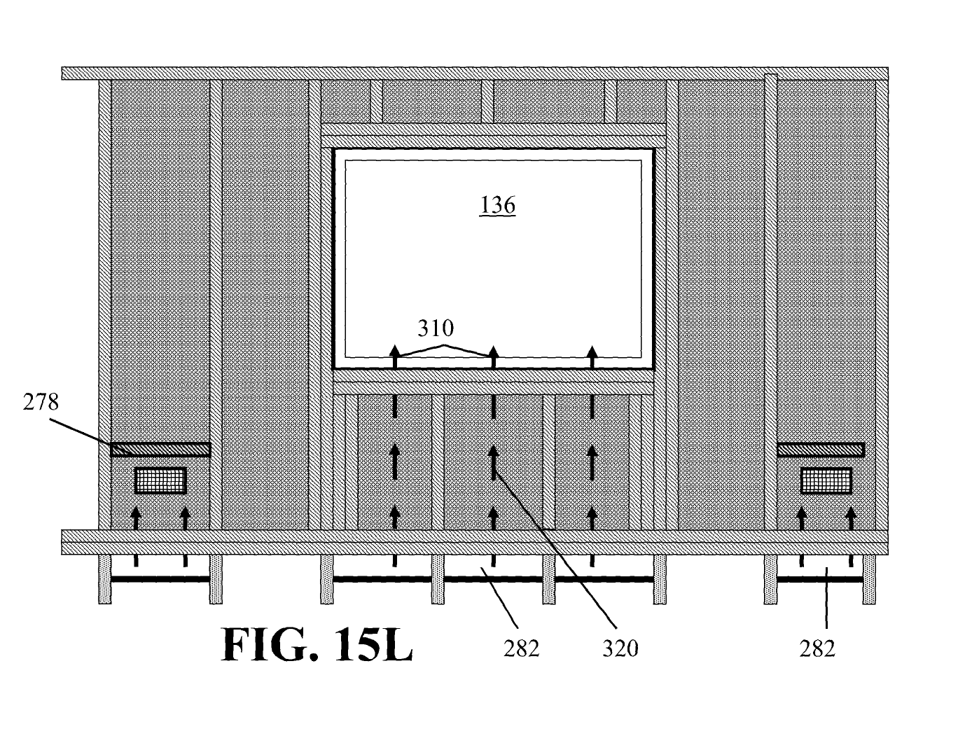

FIG. 15 shows the top view of the sectional bottom sill plate 42 with openings 350 for in-floor forced air passage. The position of the studs 12 and rigid foam members 18 forming the in-wall and in-floor forced air circulation with relationship to the independent active thermal cavity 36, and glass VIP 34. This opening 350 in bottom sill plate 42 opens up and connects to blocked inactive cavity 38 (not shown refers to FIG. 15C). Also shown, the top view and side view of the stud 12. This in-floor forced hot air is used for these following examples, said in-floor forced air travels through and up the opening 350 in the bottom sill plates 42, and out to the rooms through said blocked inactive cavities 38 in walls. The size of these outlets 350 can be adjusted to control the volume of the air flow. In-floor forced hot air travels underneath the floor in created channels, it also heats up the floor.

FIG. 15A is a sectional and side view of the floor joist 252 explaining the function of the floor joist 252 creating in-floor forced air channels 284 underneath the floor 30. Also shown are openings 32 for plumbing and electrical, rigid foam 18, OSB members 16, opening 282 on top part of floor joist 252 for in-floor forced air traveling through horizontally.

FIG. 15B wherein the lower illustration is a top view of the exposed main floor structure without the floor sheathing board 46 showing the in-floor forced air circulating route with the in-floor forced air 320 from the main furnace entering through the main duct 246 into the created rigid foam air channel system 276 between the floor joists 252. Openings 280 in bottom plates 274 are for in-floor forced air 320 to travel through and up to window & wall air register outlets into the room refers to FIG. 15C). The upper illustration demonstrates a sectional view of created forced air channels 284 underneath the floor, further explaining the configuration and arrangement of the components and openings relate to the in-floor and in-wall forced air system.

FIG. 15C is a view of an applying example of the in-wall and in-floor forced air circulation and the relationships of inactive cavity 37, independent active thermal cavity 36 and glass VIP 34. In-floor forced air 320 moves from the main air duct 246 through the created in-floor forced air channel 284 between the floor joists comes out above the floor from the recess 280 in the bottom plate 274. The vertical wall stud 12 rests on the bottom plate 274 shows cut off view of the position of the foam strip 278 on the side of the stud. The horizontal partition foam strip 278 blocks off the inactive cavity 38 and creates the in-wall forced hot air route from this blocked off inactive cavity 38. Also shown is the relationships of OSB exterior wall sheathing 46, rigid foam members 18 and drywall 28.

FIG. 15D is a view of the composite floor joist 252 with openings 282 and openings 32. These openings 282 are only needed when forced air is to be directed in another direction. For example: to travel horizontal to next adjacent channel.

FIG. 15E is a top view shown, forced air circulating areas that can be controlled and be selected; as required due to the flexibility, such as bathrooms which may have cold ceramic tile flooring. Individual space between joists 252 can be connected through strategic openings 282 in floor joists 252 and bottom plate 274 with openings 280 which facilitate the in-floor forced air 320 travel up the walls and windows then emit ambient air into the room. Top view exposed floor structure without the floor sheathing board, shows the in-floor forced air circulating route from the main duct 246 and through the created void space 284 between the floor joists 252.

FIG. 15F shows applying examples for created in-floor cavities for in-floor forced air circulation on any type of floor joists or floors, such as engineered floor joists, galvanized steel “C” channel floor joists, timber floor joists, as well as concrete floor. The materials can form a rigid foam cavity/channel 286, corrugated sheet cavity/channel 290, galvanized sheet metal cavity/channel 292 or an OSB cavity/channel 288 as illustrated. Choice of materials depending on applications. This system of the present invention can be applied on most any type of existing floor joist system, with excellent flexibilities; for commercial floorings and vast area concrete flooring. Example: temperature rises through the floor sheathing to warm the floor and room space above, thus creates the effects of in-floor heating in a very economic way. It offers excellent benefit particularly for warming up floorings such as ceramic tile floor and hardwood floors and concrete floor.

FIG. 15G shown are applying examples of the present invention on the existing engineered floor joist system 294, galvanized steel single or double joist system 296 and timber floor joists system 298.

FIG. 15H is a side view of a window forced air deflector 300, snapped onto the top surface of the window frame 308. Also shown are the window sill pane 306, the snap-on device 304, the supporting point 302 and the window defroster forced air rout 310.

FIG. 15I shows the applying example and the relationships of a window defroster with deflector 300, shows the independent active thermal cavity air blanket (active thermal cavity) 36 not extending to window double pane glass 314. In-floor forced air 320 from in-floor cavity 284 moves through between floor joists, travels up to the interior surface of the glass window 314, then showing in-floor forced air 320 when reaching the window sill plate to be designated as window defroster forced air 310 rises ambient entering in the room. Also shows the positions of the glass VIP 34 and the independent forced air cavity 36 not passing through window sill to the window.

FIG. 15J shows the interacting relationships (refers to FIG. 15I) of adding a single pane glass 318 to the window defroster. In this formation the independent active thermal cavity air blanket 36 is separated and not connected with other cavities; window deflector 300 and extended to glass VIP 34 thereby magnifying the benefits to the double pane glass window 314.

FIG. 15K refers to FIGS. 15I & 15J shown a connected upper wall section with a cavity window defroster adding a single glass pane 318 adjacent to said double glass pane 314 forming the independent active thermal cavity 36 therebetween shows the extending route of the independent forced air thermal blanket 220 running up and pass the openings in the window sill plates into the created cavity 36 between window 314 and glass pane 318 while the in-floor forced air 320 coming up from in-floor cavity 284 on the other side of the single pane glass 318 is directed thereto by the forced air deflector 300 and rises into the room to achieve the ultimate insulation effectiveness of the window.

FIG. 15L shown a broader scope explaining the relations and functionality of the in-floor forced air 320 system facilitates the extended benefits of cavity window defroster; the in-wall forced air flow for room air ambient and the directed in-floor heating. The in-floor forced air 320 is generated by the main climate control and separated from the independent active forced air system. Herein shown the side sectional view of a composite wall structure comprises cavity window defroster refers to FIGS. 15C & 15I; in-wall and in-floor forced air 320 circulation. The in-floor forced air 320 travels upward from the in-floor cavity channels 282 and is delivered to the window 136 to become window defroster forced air 310. Also shows the same in-floor forced air 320 path travels up into the blocked cavities in the wall and emits into the room via in-wall air registers. Shows foam strip 278 blocking the inactive cavity and air register 316.

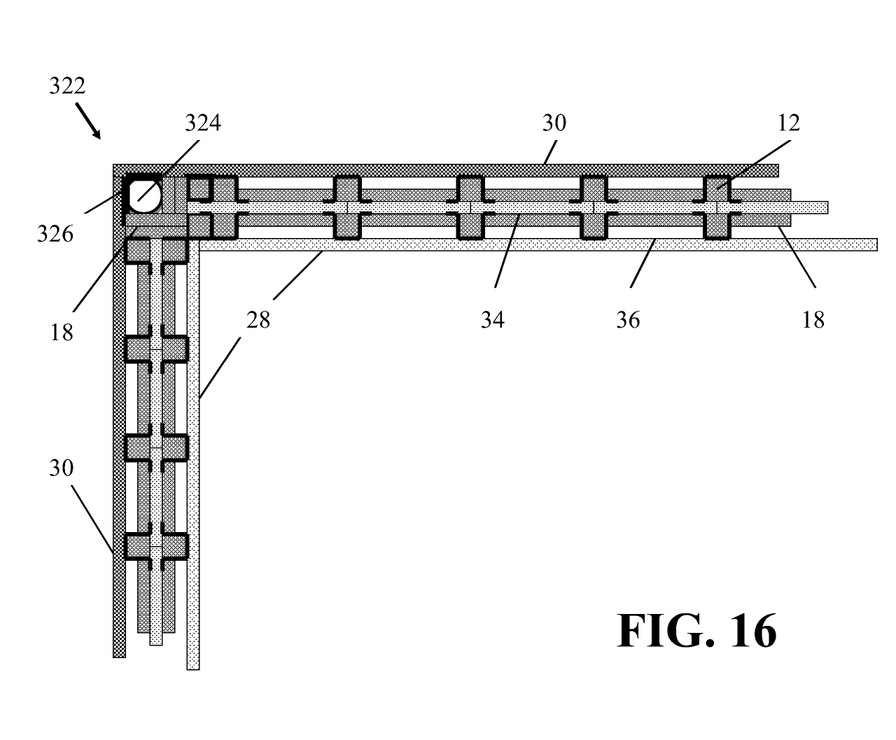

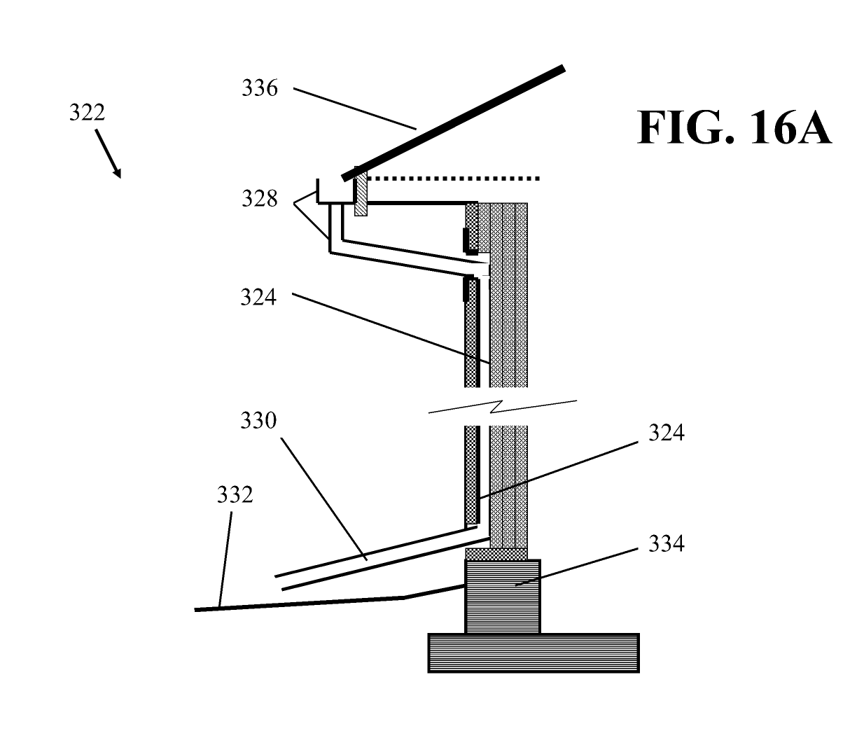

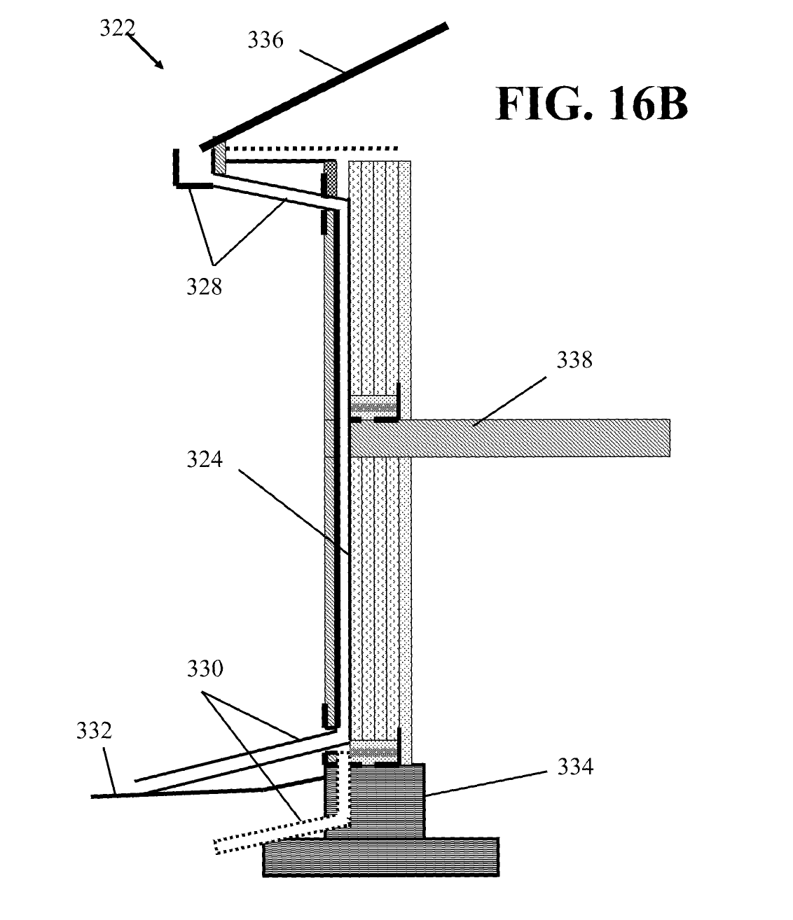

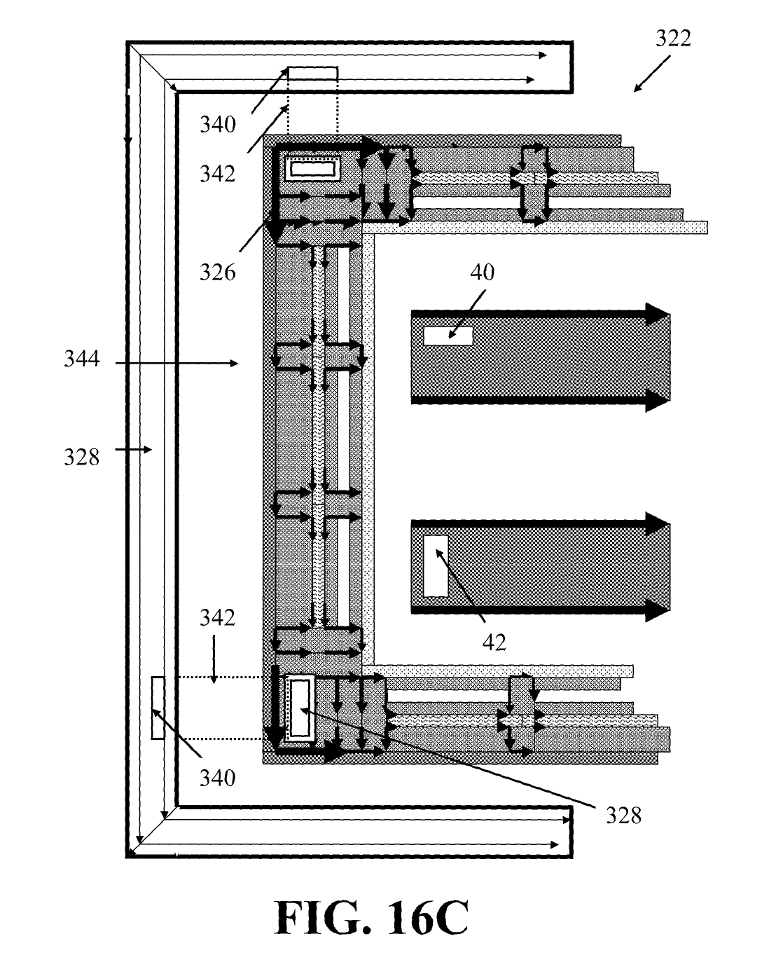

FIG. 16 is a top view of a composite insulated wall panel structure with rain water drainage system 322. The rain water drainage system 322 includes an in-wall drain pipe 324 with double piping to insure no water leakage and is secured therein by a steel reinforced supporting member 326. Also shown is the studs 12, OSB exterior sheathing 30, rigid foam insulation 18, drywall 28, VIP 34 and active thermal cavity 36.

FIG. 16A is a sectional side view of the in-wall hidden rain drainage system 322. Shown is the relationship between the roof line 336, the rain gutter and eve through system 328, the in wall hidden down pipe 324, the down spout 330, the foundation cement wall 334 and the ground grading 332.

FIG. 16B is a vertical sectional view of the hidden rain water drainage system 322 with rectangular wall passages. Shown is the relationship between the roof line 336, the rain gutter and eve through system 328, the in wall hidden down pipe 324, the upper floor 338, the down spout 330, and the ground grading 332.

FIG. 16C is a top view of the hidden rain water drainage system 322. All drain openings 340, drain channels 342, down pipes 324 and openings on top 40 and bottom plates 42 are rectangular shapes to accommodate the corner space between walls as is the rain gutter and eve through system 328 Also shown is the soffit space 344, and reinforcing steel supporting member 326.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. The combined formation and the method and the configuration and the usage of the composite insulated building components and assembly equipments for prefabricating building sections for a structure to specification having improved multiple composite insulation patterns of preventing unwanted thermal transfer from component to component and from interior space to exterior space and providing a more efficient means for distributing thermal forced air throughout the structure as a new & efficient insulation value while facilitating on-site construction comprising:
a) at least one metal (aluminum) master work frame installed and erected on the floor of the fabrication site;
b) a plurality of composite insulated vertical studs that are assembled on said metal (aluminum) master work frame forming the skeleton frame-work of composite insulated wall panels;
c) a plurality of composite insulated top & bottom sill plates that are assembled on said metal (aluminum) master work frame forming the skeleton frame-work of said composite insulated wall panels;
d) a plurality of said composite insulated wall panels that are constructed on said metal (aluminum) master work frame;
e) a composite wall frame equipment assembly associated with said metal (aluminum) master work frames for conveying and transporting the finished composite walls to storage;
f) a composite floor equipment assembly comprising a principal and a plurality of auxiliary floor assemblies;
g) a plurality of composite floor joists & floors that are constructed on said assemblies;
h) at least one composite roof truss & ceiling joist equipment assembly comprising;
i) a principal mobile truss anchor station for assembling said roof truss to various height according to the pitch of the roof and adjusting on-center specifications for the rafter beams to be attached thereto:
I) at least one composite roof truss & ceiling joist equipment assembly comprising a plurality of roof truss mobile assembly stations and a non-mobile station for disposing composite ceiling joists to various on-center specifications and length; and
II) a plurality of composite insulated roof trusses and insulated ceiling joists that are constructed on said assemblies;
j) a plurality of thermal forced air (heating & cooling) active cavity systems disposed in a plurality of composite insulated components that form a sealed conduit being further described as a thermal blanket between said composite insulated components to provide complete and efficient heating or cooling coverage throughout said structures upon the completion thereof;
k) a plurality inactive cavity systems disposed in a plurality of composite insulated components that form a sealed conduit between said composite insulated components to provide complete and efficient heating or cooling coverage throughout said structures upon the completion thereof; and
l) an on-line monitoring system posting live streaming video to the internet thereby enabling authorized persons to monitor the construction from any internet accessible electronic device once an appropriate password is entered.

2. The composite insulated building components and assembly equipment for prefabricating a structure recited in claim 1, wherein said multiple composite insulation patterns comprise;
a) a plurality of rigid foam members forming composite insulation components;
b) created forced air thermal active cavity or cavities formed in between a plurality of sealed insulation members;
c) created inactive cavity or cavities formed in between plurality of insulation members;
d) glass vacuum insulated panel (VIP) members;
e) glass insulated panel (VIP) associated with an added clear glass pane on the interior or exterior side of the VIP spaced apart to create thermal forced air passages;
f) a clear glass pane added on the interior side of the clear glass wall panel commonly used on existing industrial & commercial building spaced apart to create a thermal forced air passage; and
g) at least one galvanized steel-sheet member implemented as a divider(s) or temperature barrier(s) within a created forced air thermal active cavity to form multiple active thermal cavities;

3. The composite insulated building components and assembly equipment for prefabricating a structure recited in claim 2, wherein said composite rigid foam insulated components of said multiple insulation patterns comprises;
a) sandwiched plurality of rigid foam members spaced apart with partially or completely sealed conduits bonded on edges with foam strips or sealed with membranes on edges to create inactive cavity or cavities to become as one unit with no forced air to channel through;
b) sandwiched plurality of rigid foam members spaced apart with partially or completely sealed conduits bonded on edges with foam strips or sealed with membranes on edges to create active thermal forced air cavity or cavities having passages for forced air to channel therethrough; and
c) said created active & inactive cavities can be combined together to become as one component (unit) by separating them with at least one rigid foam member and herein to claim their configurations.

4. The composite insulated building components and assembly equipment for prefabricating a structure recited in claim 1, wherein said glass vacuum insulated panel (VIP) comprises a plurality glass panels spaced apart by supporting pellets and glass nipples and having a plurality of glass strip and glass edges melted together with appropriate heat forming said panels as one vacuum unit to increase the R-value of said VIP members;
a) to dispose as insulation members being as part of the composite insulated vertical stud to form as one structure;
b) to dispose as insulation members being as part of the composite insulated top and bottom sill plates to form as one structure;
c) to dispose as part of the insulation members of the composite floor joists system;
d) to dispose as part of the insulation members of the composite insulated wall panel;
e) to dispose as part of the insulation members of the composite ceiling and attic insulation component; and
f) to dispose as insulated feature wall to bring in natural light by adding single pane glass on the exterior side and or on the interior side creating hollow spaces as thermal cavities channeling forced air through said cavities to provide and increasing R-value.

5. The composite insulated building components and assembly equipment recited in claim 1 wherein said cavities are active and inactive cavities;
a) created thin hollow spaces between choices of insulation members or materials not limited to rigid foam members described as cavity and or cavities within walls and floors and ceilings and within any composite structural members disposed as means of insulation to regulate and to provide increased R-values therein;
b) inactive to allow for the passage of electrical wire, cable and plumbing therethrough;
c) inactive within the composite wall panel of the present invention and in any composite structural members forming any composite wall panel acting as a mean of insulation value; and
d) active for allowing the passage of thermal (heating or cooling) forced air therethrough in order to yield the benefit of the differences of the thermal effects also being described as a thermal blanket in this present invention used as a means of increasing or regulating R-value;
e) active and inactive cavities to be disposed within any types of walls not limited to said composite insulated wall panel of this present invention disposed as insulation value and for regulating climate control as thermal blanket covering partial and/or entire building;
f) active thermal cavities in conjunction with forced air which is not limited to hot and or cool forced air and or any temperature forced air within any building structures and or components to carry away unwanted temperature within walls to regulate and maintain desirable room temperate and increase R-value.
g) another active thermal cavity in conjunction with forced air channel travel through the created in-floor void spaces between floor joists directly underneath the floor sheathing as forced air passages to be disposed as thermal active cavities/channels for in-floor heating or cooling means and for facilitating the window defroster and in-wall forced ambient air in the room via registers;
h) source of forced air from climate control system(s) associated with the active cavities can be directed separately from an auxiliary climate control unit and or from main climate control unit; and
i) any single and or plurality of forced air systems in conjunction & associated with created cavity or cavities related to this invention to be utilized and be used by any means related to climate control and regulating temperatures and thermal transfer and providing insulation or increasing insulation R-value covering and connecting partial or entire building structure.

6. The composite insulated building components and assembly equipment recited in claim 5, wherein said thermal active cavities mate with respective active cavities disposed in connected any composite structural members and any composite insulation components to allow for the passage of forced thermal air of (heating or cooling or room temperature) to be channeled throughout the entire framework of any building structures including channel through beneath any type of flooring & ceiling structures including concrete flooring & concrete ceiling structures and any type of structural walls disposed as insulation means and to regulate and to increase the R-value comprising;
a) a single galvanized metal-sheet is disposed between the thermal active cavity in walls or in ceilings acts as a thermal barrier for increasing R-value; and
b) a plurality of galvanized metal-sheets are disposed in the thermal active cavity to create multiple thermal active cavities act as a multiple thermal barriers to increase R-value.

7. The composite insulated building components and assembly equipment for prefabricating a structure recited in claim 1 and wherein said composite insulated vertical stud members comprising:
a) at least a plurality of 10 composite insulated vertical studs of each formed by 2 identical parts fastened as one;
b) said any one of the 10 configurations formed by 2 identical parts can be mixed & matched with any of each 9 others of the present invention to form as different ones;
c) said plurality of composite insulated vertical studs configurations not limited to the said ten illustrated configurations;
d) glass vacuum insulated panels (VIP) disposed within said composite insulated vertical stud to form as one structure;
e) a plurality of rigid foam members disposed within said composite insulated vertical stud;
f) configured galvanized steel members forming as the structural members;
g) at least one oriented strand board member disposed within said composite insulated vertical stud forming as part of the structure;
h) a plurality of openings through out the body being as passages for forced air and for plumbing & electrical needs; and
i) the combined configurations of the 10 and the mixed & match of the composite insulated vertical studs.

8. The composite insulated building components and assembly equipment for prefabricating a structure recited in claim 1 and wherein said composite insulated top and bottom sill plates comprise at least one of the following;
a) configured galvanized steel members;
b) a plurality of rigid foam members;
c) glass insulated panel (VIP) members;
d) thermal active cavity or cavities;
e) inactive cavity or cavities;
f) a single or plural strips of OSB member disposed within the said composite insulated top and bottom sill plate being as part of the structure;
g) a plurality of openings through out the body being as passages for forced air; and
h) configurations of said plurality of composite insulated top & bottom sill plates.

9. The composite insulated building components and assembly equipments for prefabricating a structure recited in claim 1 and wherein said composite insulated wall panel comprises;
a) a plurality of composite insulated vertical studs;
b) a plurality of composite insulated top and bottom sill plates;
c) a plurality of composite insulation components of multiple insulation patterns to be disposed and filled between the on-center spaces of the skeleton frame which is constructed by said composite insulated vertical studs and said composite insulated top & bottom sill plates;
d) thermal active cavities created between said insulation components in walls for forced air to channel through as a thermal blanket;
e) inactive cavities created between said insulation components in walls with no forced air to channel through;
f) a plurality of composite insulation components forming part of the structure of said composite insulated vertical studs and said composite top & bottom sill plates;
g) within said composite wall panels to provide passages (cavities) for forced air functioning as window defroster;
h) within said composite wall panels functioning to provide thermal forced air passages (cavities) to emit forced air from in-wall to eliminate on-floor air register-outlets.
i) orientated strand board sheathing on the exterior portion of the said assembled composite wall panel; and
j) sheet rock on the interior portion of said assembled composite wall panel.

10. The composite insulated building components and assembly equipment for prefabricating a structure recited in claim 5 and wherein said composite floor joists and created in-floor thermal active cavities comprising at least one of the following;
a) configured galvanized steel members;
b) a plurality of OSB strips members;
c) strategic openings on the body of said floor joists to allow passage for forced air and for electrical and plumbing needs;
d) created void space (forced air channels) not limited choices of partition materials being used;
e) the created in-floor void spaces between & along floor joists directly underneath the floor sheathing to be disposed as thermal active cavities for in-floor heating or cooling means to further facilitate the window defroster and the in-wall forced ambient air for rooms thereto; and
f) the entire formation of the configurations of a plurality of composite floor joists and sheathing and created void space and window defroster and in-wall forced air system.

11. The composite insulated building components and assembly equipment for prefabricating a structure recited in claim 1 and wherein said composite insulated ceiling joists with a drop down section assemble a composite insulated ceiling comprising;
a) a plurality of composite rigid foam insulation components;
b) configured OSB members;
c) the configurations of the ceiling joist with a drop down section & the composite multiple insulation ceiling formation.
d) a composite ceiling comprising active thermal cavity & cavities with insulation values;
e) a composite ceiling comprising inactive cavity & cavities with insulation values;
f) a composite ceiling comprising glass vacuum insulated panels VIP; and
g) configured galvanized steel members and galvanized metal-sheet members as thermal barriers;

12. The composite insulated building components and assembly equipment for prefabricating a structure recited in claim 1 and wherein said composite roof insulated truss (rafter beam) members provide slots to embrace a plurality of rigid foam members forming single or plural cavities as insulation components directly underneath the roof sheathings and a plurality of composite roof trusses rafter beams and their configurations;

13. The composite insulated building components and assembly equipment for prefabricating a structure recited claim 12; wherein said composite ceiling joists with a drop down section assemble a composite insulated ceiling and wherein said roof truss (rafter beam) members provide slots to embrace a plurality of composite rigid foam insulation members forming at least one cavity as insulation components directly underneath the roof sheathings together create an unique sealed temperatures regulated composite attic space for improved attic and ceiling R-value.

14. The composite insulated building components and assembly equipment for prefabricating a structure recited in claim 9 and wherein said active thermal forced air system and said composite insulated wall panel together comprise a window defroster system that has a thermal blanket traveling across the interior of said window by providing forced air through a forced air passage in the lower part of said window frame and said window sill plate for delivery to said window via a forced air deflector that directs said air toward the window surface;
a) said forced air is channeled from the main climate control system travels through created void spaces (channels) in between & along floor joists underneath the floor through openings on the body of the composite insulated bottom sill plates reaching up the cavities formed in the composite insulated components in walls between disposed composite insulated vertical studs and through openings in window sill plate; and
b) to claim the created in-wall void space being utilized as forced air passages for window defroster.

15. The composite insulated building components and assembly equipment recited in claim 14, wherein said window defroster system with the extension of said in-wall active thermal forced air heating system further creates a window heating & insulation system functioning simultaneously with the said window defroster system by adding a clear single glass pane to the interior side of the window pane creating a thin hollow space as cavity or cavities between the added single clear glass pane and the interior side of said window pane by directing active thermal forced air traveling through said created thin hollow space (cavity or cavities) for added insulation means to the window and at the same time the window defroster system is functioning simultaneously on the other (interior) side of the said added single clear glass pane having a separate forced air path.

16. The composite insulated building components and assembly equipment recited in claim 15, wherein said independent forced air heating system further creates a forced air system applies to existing commercial & industrial buildings with extensive “composite clear glass vacuum insulated wall panels” as building exterior wall structures to separate the exterior & the interior wherein by adding a single clear glass pane on the interior side of the said “composite clear glass vacuum insulated wall panel” creating a thin hollow space as cavity or cavities between said “composite clear glass vacuum insulated wall panel” and said added single clear glass pane by directing thermal forced air traveling through said created thin hollow space (cavity or cavities) as added insulation means to the existing “composite clear glass vacuum insulated wall panels” to regulate and to improve R-value.

17. The composite insulated building components and assembly equipment recited in claim 9, wherein assembly of said wall panel is accomplished by the following steps:
a) laying bottom sill and said top sill in spaced apart parallel fashion on said master work frame;
b) placing said vertical composite members therebetween and perpendicularly thereto at distances according to specification;
c) mechanically raising said aluminum master work frame to a comfortable level for workers;
d) fastening said vertical composite members to said top sill and said bottom sill by two workers, one on each side;
e) rotating said master work frame and said wall frame into a vertical position;
f) installing any required electrical wire and boxes and associated components with one worker on each side thereof;
g) installing horizontal composite members to rough in any required doors and windows;
h) installing rigid foam insulation therein;
i) installing OSB sheathing on the exterior portion of said wall frame; and
j) installing drywall on the interior portion of said wall frame.

18. The composite insulated building components and assembly equipment recited in claim 1 and wherein said master work frame comprises:
a) a substantially rectangular work frame;
b) a pair of opposing motorized mechanisms for raising and lowering and rotating the wall structure;
c) a horizontal track rail disposed above said work frame,
d) a conveying fork lift suspended from said track rail;
e) a motor for moving said conveying fork; and
f) a pair of opposing video cameras oriented towards the work area and disposed on either side of said wall frame to upload the entire building process thereof live on steaming video.

19. The composite insulated building components and assembly equipment recited in claim 18 and wherein said conveying fork moves along said track rail powered by a remote control unit to transport said completed wall unit to storage.

20. The composite building components and assembly equipment recited in claim 19 and wherein said windows are protected by rigid form pads disposed on each side thereof during transport and storage.

21. The composite insulated building components and assembly equipment recited in claim 1 and wherein said roof truss is fabricated in two symmetrical mating halves each comprising:
a) a center supporting member;
b) a plurality of roof truss web supporting members;
c) a roof rafter beam; and
d) a slot for fitting an insulation member.

22. The composite insulated building components and assembly equipment recited in claim 1 and further including at least one drop down ceiling joist comprising:
a) an elongate main joist portion;
b) a drop down joist portion subjacent to said main joist portion and having ends terminating prior to the ends thereof;
c) a galvanized steel plate substantially covering the sides and top of the entire length of said main joist portion with flanges extending perpendicularly from the bottom edges thereof;
d) a galvanized steel plate substantially covering the sides and bottom of the entire length of said drop down joist portion with flanges extending perpendicularly from the bottom edges thereof; and
e) an OSB strip integral with each said joist portion to separate said galvanized steel plates to short circuit the thermal transfer from metal to metal and provide support for the payload of “drop down” on which the ceiling and drywall are placed.

23. The composite insulated building components and assembly equipment recited in claim 22, wherein the extended ends of said main portion of said drop down joist is seated on the top plates of said studs and said drop down portion resides therebetween.

24. The composite insulated building components and assembly equipment recited in claim 21 and wherein said structure has a half and half roof gable system.

25. The composite insulated building components and assembly equipment recited in claim 24, wherein said gable roof system is fabricated by a mobile truss anchor station comprising:
a) a station support structure;
b) a vertical elevating mechanism to adjust to various according to the desired roof pitch;
c) an anchor mechanism to support said center supporting member of said truss;
d) a first ceiling frame support that is stationary and disposed below said anchor mechanism onto which said ceiling joists are seated for fabrication; and
e) a second ceiling frame support with on-center spacers that is mobile and moves on tracks to and from center.

26. The composite insulated building components and assembly equipment recited in claim 25 and wherein fabrication of said half gable on said mobile truss anchor station comprises the steps of:
a) seating said ceiling joists horizontally on the spaced apart ceiling frame supports;
b) securing the rafters and side plates and bracing members thereto; and
c) installing truss structure web members, fastening brackets, roof sheathing and shingles to complete the assembly.

27. The composite insulated building components and assembly equipment recited in claim 26, wherein said stationary ceiling frame support pivots said truss assembly 90 degrees and said mobile ceiling frame support is removed so conveying equipment can roll in for transporting the completed truss.

28. The composite insulated building components and assembly equipment recited in claim 21, wherein said structure has a hip roof system comprising a pair of mating half gable sections and a pair of hip ends to attach to the ends of said gable roof.

29. The composite insulated building components and assembly equipment recited in claim 28 and wherein said mobile truss assembly further includes third and fourth mobile ceiling frame supports which are mobile and configured similar to said second ceiling frame support and are spaced apart and parallel to one another and perpendicular to said first stationary and second mobile frame ceiling supports and are used for fabricating said hip sections.

30. The composite insulated building components and assembly equipment recited in claim 29 and wherein said mobile ceiling frame supports further include spacers disposed on the top portions thereof.

31. The composite insulated building components and assembly equipment recited in claim 1 and wherein said forced air system further includes an independent auxiliary furnace to feed thermal (heated) forced air into said system through a duct.

32. The composite insulated building components and assembly equipment recited in claim 1 and wherein said forced air system further includes an independent air conditioning to feed thermal (cool) forced air into said system through a duct.

33. The composite insulated building components and assembly equipment recited in claim 32 and wherein the forced air path of the thermal cavity air blanket associates with the inactive cavities and glass VIP within the walls floors and joists to provide comprehensive coverage throughout the entire structure.

34. The composite insulated building components and assembly equipment recited in claim 33 and wherein active thermal cavity insulation further includes galvanized steel dividers for buildings that seek higher energy saving requirements.

35. The composite insulated building components and assembly equipment recited in claim 33, wherein the attic of said structure includes a solar powered fan to regulate attic temperature and the solar power for said fan is harvested by at least one solar panel disposed on the roof.

36. The composite insulated building components and assembly equipment recited in claim 33, wherein each floor of said structure has an independent forced air (hot) thermal blanket supplied by its own independent furnace.

37. The composite insulated building components and assembly equipment recited in claim 33 and wherein each floor of said structure has an independent forced (cool) air thermal blanket supplied by its own independent air conditioning unit.

38. The composite insulated building components and assembly equipment recited in claim 1 and wherein floor sections comprising a plurality of composite floor joists are fabricated on a principal floor assembly.

39. The composite insulated building components and assembly equipment recited in claim 38, wherein said principal floor assembly comprises:
a) a stationary motorized floor joist assembly station with a height adjustable platform;
b) a mobile motorized floor joist assembling station having a height adjustable platform oriented towards the platform of said stationary station; and
c) a pair of supporting members linearly disposed between the two floor joist assembly stations an in a 90 degree relation with said floor joists.

40. The composite insulated building components and assembly equipment recited in claim 39 and wherein the ends of a plurality of composite floor joists are laid out on said platforms and the floor is constructed thereon complete with sheathing board.

41. The composite insulated building components and assembly equipment recited in claim 40 and whereupon completion of said floor and the platforms are lowered to rest on said supporting members and said mobile assembly station is removed.

42. The composite insulated building components and assembly equipment recited in claim 41 and wherein said supporting members have wheels on tracks to enable them to be spaced accordingly depending on the length of said floor joists and positioning of said mobile assembly station.

43. The composite insulated building components and assembly equipment recited in claim 1 and further comprising a hidden drain water system that is not visible.

44. The composite insulated building components and assembly equipment recited in claim 43, wherein said hidden drain water system comprises:
a) a rain gutter and eve through system disposed at the bottom of the roof line;
b) at least one hidden down pipe leading from said gutter and extending downward through the walls of said structure that is double piped to insure no leakage;
c) drain recesses in said rain gutter;
d) a drain channel to receive drain water from said drain recess and transfer it to said down pipe; and
e) a down spout at the bottom of said down pipe exiting said structure.

45. The composite insulated building components and assembly equipment recited in claim 44, wherein all drain recesses, drain channels and down pipes are rectangular to accommodate the corner space between walls.

46. The composite insulated building components and assembly equipments recited in claims 1, 31, 33, 36, & 38 in conjunction with the active thermal forced air system to claim the method; formation; configuration and usage of a boxed-out space to accommodate and relocate the climate control unit; the electrical panel and wiring and the plumbing system are to be housed and consolidated within the boxed-out space in a basement facilitated to free up desirable development space with no obstructions along with others; such as the conventional cumbersome ducting system and to simplify the plumbing routes.
a) the vertical column multi-level boxed-out spaces aligned with the above said basement boxed-out space in claim 46 accommodating outward and inward ducting systems connected from the climate control unit functioning for the active thermal forced air circulation system, therein claiming the method; formation; pattern; configuration; usage and function;
b) to claim the method; formation; pattern; configuration and usage of the aligned vertical column boxed-out spaces applied to a multi-level building to consolidate the electrical panel and electrical wiring running vertically and horizontally and extending to each level and to specific spots therein at ease of a building;
c) to claim the method; pattern; formation; configuration and usage of the aligned vertical column boxed-out spaces of a multi-level building permits the plumbing system running vertically and horizontally to extend to each level and specific spots therein at ease of a building;
d) to claim the method; formation; pattern; configuration and usage of the aligned vertical column boxed-out spaces of a multi-level building associated with outward and inward ducting systems facilitating at least one in-wall active thermal forced air path which travels horizontally in the lower and upper parts of a wall panel by way of openings, passages, cavities and channels created in studs and wall panels in wall “to and from” the climate control unit;
e) to claim the method; the formation; the pattern the configuration and the usage of the aligned vertical column boxed-out spaces of multi-level building associate with the active thermal forced air paths which travel horizontally through created openings; passages; cavities and channels underneath the claimed void spaces of the sub-floor surface in and between floor joists “to and from” the climate control unit;
f) to claim the method; formation; pattern; configuration and usage of the aligned vertical column boxed-out spaces of a multi-level building associated with the active thermal forced air path that travels horizontally through openings; passages; cavities and channels created in and between ceiling joists within a ceiling “to and from” the climate control unit;
g) to claim the method; formation; pattern; configuration and usage of the aligned vertical column boxed-out spaces of a multi-level building associated with the active thermal forced air paths that travel horizontally through channels; openings; cavities; passages and singular or plural piping systems created within a concrete slab floor to provide in-slab heating without utilizing any form of liquid “to and from” the climate control unit;
h) to claim the method; formation; configuration and usage of the horizontal boxed-out spaces aligned horizontally at 90 degrees along with floor joists functioning, hosting and directing pipes or tubes, water lines and electrical wiring to appropriate positions via and underneath the claimed void spaces cited in claim 10 and which are underneath the sub-floor and between floor joists, the said horizontal elongated boxed-out spaces run in opposite directions on the exterior walls connected at 90 degrees with the aligned vertical column boxed-out spaces at each floor level;
i) to claim the method; formation; configuration and usage of the horizontal boxed-out spaces cited in claim “46 h” that have an insulated hollow body and in which comprises at least one of: passage; channel or cavity for running the active thermal forced air through and not limited to and connecting with other openings; channels or passages for extending and connecting the active thermal forced air system;
j) to claim the combination of the method; formation, configuration and usage of: the boxed-out spaces in the basement; the vertical column boxed-out spaces; the horizontal boxed-out spaces; the climate control unit; the outward and inward ducting system; the active thermal forced air system and associated passages; cavities; and channels in walls, ceilings, and void spaces underneath the sub-floor and concrete in-slab floor; the horizontal flow pattern of the active thermal forced air in the lower and upper parts of wall panels, which are divided by a form strip not limited by other means to form the forced air circulation flow;
k) to claim the combination of the method, formation, configuration and usage of the active thermal forced air system in this present invention which is to be used to circulate forced air in cavities; passages; channels; openings; piping; and tubing; and is not limited to types of materials to be used and the function(s) to be utilized for any purpose of regulating hot or cold climate control in ceilings, walls, all types of floor for in-floor heating, and forced air window insulation and forced air window defrosting;
l) to claim the combination of the method; pattern; formation; configuration and usage of the active thermal forced air system in this present invention and which is not limited to a single cavity and applies to plural cavities of multiple forced air flow; and is not limited by specific or certain temperature degree settings within walls; ceilings or floors; whether positioned in single or in plural form & configuration close to the interior or exterior side of walls of residential or commercial/industrial buildings for the purpose of regulating temperatures and/or climate controls and the formation; creation; configuration and pattern of the space of the cavity or cavities with the materials being used are not to be limited with rigid foam; and such width of cavity spaces are not to be limited depending on application;
m) to claim the combination of the method; pattern; formation; configuration and usage of the in-active cavities system in this present invention and which is not limited to a single cavity and applies to plural cavities between walls; ceilings & floors; whether positioned in single or in plural form or configuration close to the interior or exterior side of walls of residential or commercial/industrial buildings for the purpose of regulating temperatures and/or climate controls with the materials being used are not to be limited with rigid foam; and such width of cavity spaces are not to be limited depending on application;
n) to claim the combination of the method; pattern; formation; configuration and usage of the active thermal forced air system in this present invention therein not to be limited the pattern of the air path movements either in the pattern of horizontal and vertical or in the combined patterns of horizontal and vertical within walls & ceilings & floors;
o) to claim the combination of the method, pattern, formation, configuration and usage of the active thermal forced air system in direct conjunction with the corrugated metal components to be used in ceiling & wall structures of which the “void” spaces on one side or on both sides of the corrugated configuration to be utilized as the active thermal forced air path and not to be limited on any wall & floor corrugated structures for commercial and or industrial buildings.

47. the configuration & the formation & the methodology & the utilization of the double pane un-obscured all glass VIP incorporated with a programmable mechanical apparatus utilizing a heat exchanger able to facilitate the “repeat at will” pressurized vacuum process performing filling and retrieval functionality of active forced thermal “coloured” fluids to achieve “on & off” vacuum insulation generating a two stage insulation value and automated/manual temperature regulating process and create a combined vacuum & active forced thermal fluids window treatment system.

48. the configuration & the formation & the methodology & the utilization of the triple pane un-obscured all glass VIP panels having a dual body with dual cavity incorporated with a programmable mechanical apparatus utilizing a heat exchanger able to facilitate the “repeat at will” pressurized vacuum process performing filling and retrieval functionality of the active thermal forced coloured fluid to achieve vacuum effects generating a three stage insulation value with automated/manual temperature regulating process and creates a simultaneously functioning “permanent” & “repeat at will” vacuum conditions along with the active forced thermal fluids window treatment system;
a) the functionality of any double and/or triple pane un-obscure or obscure all glass VIP utilizing “coloured” fluid or fluids as customizable window treatment and/or for window insulation with or without vacuum process or condition;
b) any glass VIP filled with active forced thermal “coloured” fluids being used to block Ultra Violet light and being used as window insulation;
c) the functionality of active forced thermal fluid used in glass panels within any window structures for insulation and regulating temperatures is in either vacuum condition or non-vacuum condition;
d) any active forced thermal fluid being used in panels within wall structures for insulation and regulating temperatures is either in vacuum condition or in non-vacuum condition;
e) the un-obscure & obscure glass VIP to be utilized as insert-member within door structure for improving insulation;
f) the methodology of utilizing the active forced thermal fluid to achieve “repeat at will” vacuum condition and/or to regulating temperature for insulation purposes in large wall structures not limited to the type of materials to be used.

49. the composite insulated building components and assembly equipments (recited in claims 1, 31, 33, 36, & 38) in the parent application in conjunction with the active thermal forced air system to claim the combination and the interaction of the configuration & the formation & the methodology & the utilization of the vertical and horizontal boxed-out space system able to accommodate and relocate the climate control unit and the electrical panel and wiring and the water/plumbing system all are to be housed and consolidated within the insulated space of the boxed-out system created and raised from the foundation in the basement facilitated to yield more desirable development space to reduce and or to eliminate obstructions associated with the conventional cumbersome heating & ducting system and to simplify the plumbing routes and to facilitate at least one active thermal forced air to travel more effectively in the active thermal forced air system in and around the multi-level structure of buildings;
a) the outward and inward active forced air circulation insulated ducting systems facilitating for at least one in-wall active thermal forced air cavity which extends its way and connects vertically and or horizontally to all composite wall panels and in floors and ceilings by way of traveling through created openings or passages or cavities and or channels “to and from” the climate control unit particularly in the boxed-out space;
b) the active thermal forced air paths that travel vertically and horizontally through channels or openings or cavities or passages or piping systems created within a concrete slab floor to provide in-slab heating without utilizing any form of liquid “to and from” the climate control unit particularly in the boxed-out space;
c) the combination and the interaction of the method and formation and configuration and usage of the active thermal forced air system in this present invention which is to be used to circulate active thermal forced air in cavities; passages; channels; openings; piping; and tubing; and is not limited to the types of materials to be used and the function(s) to be utilized for any purpose of regulating hot or cold climate control in ceilings and walls; activating thermal forced air for all in-floor heating and forced air window insulation and forced air window curtain for defrosting;
d) the active thermal forced air system combines with the in-active cavity system in the parent application and this present invention and which is not limited to a single cavity and applies to plural cavities of multiple forced air flows; and is not limited by specific or certain temperature degree settings within walls; ceilings or floors whether positioned in single or in plural form & configured close to the interior or exterior side of walls of residential or commercial/industrial buildings for the purpose of regulating temperatures and/or climate controls and the formation; creation; configuration and pattern of the space of the cavity or cavities with the materials being used are not to be limited with rigid foam; and such width of cavity spaces are not to be limited to specific depending on application;
e) the active thermal forced air system in this present invention therein not to be limited the pattern of the active thermal forced air path movements either in the pattern of horizontal and vertical or in the combined patterns of horizontal and vertical within walls & in ceilings & in all types of floors;
f) the method; formation; configuration and usage of the vertical & horizontal boxed-out spaces aligned horizontally at 90 degrees against along with floor joists facilitates the effective arrangement of laying & installing & directing pipes or tubes; water lines and electrical wiring to appropriate positions via between floor joists and facilitates the active thermal forced air travel through the claimed void spaces (cited in claim 10. in the parent application) which are underneath the sub-floor and between floor joists.

50. the combination and the interaction of the configuration & the formation & the methodology & the utilization of the active thermal forced air circulation system in direct conjunction with the corrugated metal components to be used in ceilings, & floors & wall structures of which the “void” spaces on one side or on both sides of the corrugated configuration to be utilized as the active thermal forced air path transforming into a 3 stages composite insulation structure comprises a dual corrugated forced air path sandwiched the corrugated metal member to be utilized as a “heat sink” and not to be limited on any walls & floors corrugated structures for commercial and or industrial buildings for the purposes of regulating temperature and or for climate controls.

51. the combination and the interaction of the configuration & the formation & the methodology & the utilization of the active thermal forced air system applies directly to the roof line underneath the roof sheathing wherein composite insulated rigid foam panels created in between the foam members having at least one active forced air cavity/passage at one end connected 90 degree against with the openings on the side of an elongated central channel gathering and allowing all forced airs channeled from said multiple composite insulated rigid foam panels flow into the cavity of said openings of the elongated central channel to be dissipated and be redirected for the purposes of regulating the temperature and or for climate controls.
